(19) United States
(12) Patent Application Publication
(10) Pub. No.: US 2025/0310053 A1
(43) Pub. Date: Oct. 2, 2025

(54) METHOD AND APPARATUS FOR TRANSMITTING AND RECEIVING UPLINK REFERENCE SIGNAL IN WIRELESS COMMUNICATION SYSTEM

(71) Applicant: Samsung Electronics Co., Ltd., Gyeonggi-do (KR)

(72) Inventors: Youngrok JANG, Gyeonggi-do (KR); Taekhoon KIM, Gyeonggi-do (KR); Ameha Tsegaye ABEBE, Gyeonggi-do (KR); Hyoungju JI, Gyeonggi-do (KR)

(21) Appl. No.: 19/097,192

(22) Filed: Apr. 1, 2025

(30) Foreign Application Priority Data
Apr. 1, 2024 (KR) 10-2024-0044376
May 9, 2024 (KR) 10-2024-0061339

(51) Int. Cl. H04L 5/00; H04W 72/21

(52) U.S. Cl. CPC H04L 5/0048; H04W 72/21

(57) ABSTRACT

The disclosure relates to a 5^{th}-generation (5G) or 6^{th}-generation (6G) communication system for supporting a higher data transmission rate. Provided is a method performed by a user equipment (UE), that includes transmitting, to a base station (BS), capability information regarding codebook-based 8Tx physical uplink shared channel (PUSCH), receiving, from the BS, sounding reference signal (SRS) configuration information including information of a SRS resource set, in case that a usage of the SRS resource set is identified as a codebook, based on the information of the SRS resource set, identifying that a value of nrofSRS-Ports-n8 is applied to all of a plurality of SRS resources in the SRS resource set and transmitting at least one SRS based on the value of nrofSRS-Ports-n8.

### CROSS-REFERENCE TO RELATED APPLICATIONS

This application is based on and claims priority under 35 U.S.C. § 119 to Korean Patent Application Nos. 10-2024-0044376 and 10-2024-0061339, which were filed in the Korean Intellectual Property Office on Apr. 1, 2024, and May 9, 2024, respectively, the disclosures of which are incorporated herein by reference in their entireties.

### BACKGROUND

### 1. Field

The disclosure relates generally to a user equipment (UE) and a base station (BS) in a wireless communication system, and more particularly, to a method of transmitting and receiving an uplink (UL) reference signal (RS) in a wireless communication system and an apparatus for performing the method.

### 2. Description of Related Art

Fifth generation (5G) mobile communication technologies define wide frequency bands to enable high transmission rates and new services and may also be implemented in a sub-6 gigahertz (GHz) band, e.g., 3.5 GHz, and in an ultrahigh frequency band above 6 GHz referred to as millimeter wave (mmWave) bands such as 28 GHz and 39 GHz bands. In sixth generation (6G) mobile communication technologies referred to as a beyond 5G system, it is considered to be implemented in terahertz (THz) bands from 95 GHz to 3 THz to attain transmission rates 50 times higher than an ultra-low delay reduced to a tenth of the 5G mobile communication technology.

Since the early stages of the 5G mobile communication technology, there have been developed beamforming and massive multiple input multiple output (MIMO) to mitigate a radio path loss and increase the radio propagation distance in the ultra-high frequency band, support for various numerologies (operation of multiple subcarrier spacing) and dynamic slot format operation for efficient use of ultra-high frequency resources, initial access technologies for supporting multiple-beam transmission and widebands, definition and operation of bandwidth parts (BWPs), new channel coding schemes such as polar codes for highly reliable transmission of control information and low density parity check (LDPC) codes for high-volume data transmission, L2 preprocessing, network slicing for providing a dedicated network specialized for a particular service, etc., were standardized to support services and satisfy performance requirements for enhanced mobile broadband (eMBB), ultra-reliable low-latency communications (URLLC), and massive machine-type communications (mMTC).

Improvement and performance enhancement of the early 5G mobile communication technology are currently being discussed with consideration for the services that the 5G mobile communication technology has intended to support, and physical layer standardization for technologies such as vehicle-to-everything (V2X) to help driving decisions of autonomous vehicles and increase user convenience based on locations and status information of the vehicles transmitted by the vehicles, new radio unlicensed (NR-U) to aim at system operations conforming to various regulatory requirements in an unlicensed band, an NR terminal low-power consumption technology (UE power saving), non-terrestrial network (NTN), which is a direct terminal-satellite communication for securing coverage in a region where communication with a terrestrial network is unavailable, positioning, etc., is ongoing.

In addition, standardization of wireless interface architecture/protocol areas for technologies such as industrial Internet of things (IIoT) for supporting new services through connection and convergence with other industries, integrated access and backhaul (IAB) that provides a node to integrally support the wireless backhaul link and the access link to extend the network service area, mobility enhancement including conditional handover and dual active protocol stack (DAPS) handover, 2-step random access channel (RACH) for new radio (NR) to simplify the random access procedure, etc., and standardization of system architectures/service areas such as 5G baseline architectures (e.g., service based architectures or service based interfaces) for combination of network functions virtualization (NFV) and software-defined networking (SDN), mobile edge computing (MEC) to receive services based on a location of the terminal, etc., is also underway.

When such 5G mobile communication systems are commercialized, an ever-increasing number of devices may be connected to the communication network, so that it is expected that enhancement of functions and performance of the 5G mobile communication system and integrated operation of the connected devices are required. For this, new research will be on the way for 5G performance enhancement and complexity reduction, artificial intelligence (AI) service support, metaverse service support, drone communication, etc., using AI, machine learning (ML) and extended reality (XR) to efficiently support augmented reality (AR), virtual reality (VR), mixed reality (MR), etc.

Advancement of the 5G mobile communication system may also be fundamental to developing not only a multiple antenna transmission technology such as large-scale antennas, array antennas, full dimensional multi-input multi-output (FD-MIMO) and new waveforms for guaranteeing coverage in THz bands of the 6G mobile communication technology, a high-dimensional spatial multiplexing technology using orbital angular momentum (OAM) and metamaterial based lens and antennas to enhance coverage of THz band signals, and a reconfigurable intelligent surface (RIS) technology, but also a full-duplex technology for frequency efficiency improvement and system network enhancement of the 6G mobile communication technology, an AI based communication technology to materialize system optimization by using a satellite and AI from a design stage and internalizing an end-to-end AI support function, a next generation distributed computing technology to materialize sophisticated services beyond the limit of terminal computation capacity by using ultra-high performance communication and computing resources, etc.

Given the advancements in wireless communication, there is a need in the art for a method and apparatus to effectively provide the growing number of services in wireless communication.

### SUMMARY

Embodiments of the disclosure provide an apparatus and method for effectively providing services in a mobile communication system.

Additional aspects will be set forth in part in the description which follows and, in part, will be apparent from the description, or may be learned by practice of the presented embodiments of the disclosure.

A method performed by a user equipment (UE) in a wireless communication system may include transmitting, to a base station (BS), capability information regarding codebook-based 8Tx physical uplink shared channel (PUSCH), receiving, from the BS, sounding reference signal (SRS) configuration information including information of a SRS resource set; in case that a usage of the SRS resource set is identified as a codebook, based on the information of the SRS resource set, identifying that a value of nrofSRS-Ports-n8 is applied to all of a plurality of SRS resources in the SRS resource set; and transmitting at least one SRS based on the value of nrofSRS-Ports-n8, wherein the value of nrofSRS-Ports-n8 is set as: ports8 indicating that the UE is configured with 8 antenna ports or ports8tdm indicating that the UE is configured with 8 antenna ports which are partitioned into 2 subsets with each subset having 4 antenna ports.

In case that the UE supports codebook1, the capability information may include: a first component indicating a combination of N1 and N2 supported at the UE, and a second component indicating no time division multiplexing (TDM) or both of TDM or no TDM, and wherein N1 is a number of antenna ports in first dimension and N2 is a number of antenna ports in second dimension.

The combination of N1 and N2 may be at least one of (4, 1), (2, 2) or both of (4, 1) and (2, 2).

The capability information may include a value of SRS-8TxPorts and the value indicating no time division multiplexing (TDM) or both of TDM or no TDM may be applied, in case that the UE supports at least one of codebook2, codebook3 or codebook4.

A method performed by a base station (BS) in a wireless communication system may include receiving, from a user equipment (UE), capability information regarding codebook-based 8Tx physical uplink shared channel (PUSCH); transmitting, to the UE, sounding reference signal (SRS) configuration information including information of a SRS resource set, wherein in case that a usage in the information of the SRS resource set is set as a codebook, a value of nrofSRS-Ports-n8 is applied to all of a plurality of SRS resources in the SRS resource set; and receiving, from the UE, at least one SRS based on the value of nrofSRS-Ports-n8, wherein the value of nrofSRS-Ports-n8 is set as: ports8 indicating that the UE is configured with 8 antenna ports or ports8tdm indicating that the UE is configured with 8 antenna ports which are partitioned into 2 subsets with each subset having 4 antenna ports.

A user equipment (UE) in a wireless communication system may include a transceiver; and at least one processor coupled with the transceiver and configured to: transmit, to a base station (BS), capability information regarding codebook-based 8Tx physical uplink shared channel (PUSCH), receive, from the BS, sounding reference signal (SRS) configuration information including information of a SRS resource set, in case that a usage of the SRS resource set is identified as a codebook, based on the information of the SRS resource set, identify that a value of nrofSRS-Ports-n8 is applied to all of a plurality of SRS resources in the SRS resource set, and transmit at least one SRS based on the value of nrofSRS-Ports-n8, wherein the value of nrofSRS-Ports-n8 is set as: ports8 indicating that the UE is configured with 8 antenna ports or ports8tdm indicating that the UE is configured with 8 antenna ports which are partitioned into 2 subsets with each subset having 4 antenna ports.

A base station (BS) in a wireless communication system may include a transceiver; and at least one processor coupled with the transceiver and configured to: receive, from a user equipment (UE), capability information regarding codebook-based 8Tx physical uplink shared channel (PUSCH), transmit, to the UE, sounding reference signal (SRS) configuration information including information of a SRS resource set, wherein in case that a usage in the information of the SRS resource set is set as a codebook, a value of nrofSRS-Ports-n8 is applied to all of a plurality of SRS resources in the SRS resource set, and receive, from the UE, at least one SRS based on the value of nrofSRS-Ports-n8, wherein the value of nrofSRS-Ports-n8 is set as: ports8 indicating that the UE is configured with 8 antenna ports or ports8tdm indicating that the UE is configured with 8 antenna ports which are partitioned into 2 subsets with each subset having 4 antenna ports.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain in a wireless communication system, according to an embodiment;

FIG. 2 illustrates a frame, subframe, and slot structure in a wireless communication system, according to an embodiment;

FIG. 3 illustrates an example of configuration of BWPs in a wireless communication system, according to an embodiment;

FIG. 4 illustrates a radio protocol architecture of a BS and a UE with conditions of a single cell, carrier aggregation (CA) and dual connectivity (DC) in a wireless communication system, according to an embodiment;

FIG. 5 illustrates a beam application time (BAT) that may be considered when a joint transmission configuration indicator (TCI) framework is used in a wireless communication system, according to an embodiment;

FIG. 6 illustrates another medium access control (MAC) control element (CE) structure for joint TCI state or separate downlink (DL) or UL TCI state activation and indication in a wireless communication system, according to an embodiment;

FIG. 7 illustrates an example of configuration of control resource set (CORESETs) of a DL control channel in a wireless communication system, according to an embodiment;

FIG. 8 illustrates a structure of a DL control channel in a wireless communication system, according to an embodiment;

FIG. 9 illustrates a procedure for beam configuration and activation for a physical data shared channel (PDSCH) according to an embodiment;

FIG. 10 illustrates a comb offset and cyclic shift allocation method in SRS transmission, according to an embodiment;

FIG. 11 illustrates antenna port configurations and resource allocations for cooperative communication in a wireless communication system, according to an embodiment;

FIG. 12 illustrates a configuration of DL control information (DCI) for cooperative communication in a wireless communication system, according to an embodiment;

FIG. 13 illustrates an enhanced PDSCH TCI state activation/deactivation MAC-CE structure according to an embodiment;

FIG. 14 illustrates operations of a UE in a wireless communication system, according to an embodiment;

FIG. 15 illustrates operations of a BS in a wireless communication system, according to an embodiment;

FIG. 16 is a block diagram of a UE in a wireless communication system, according to an embodiment; and

FIG. 17 is a block diagram of a BS in a wireless communication system, according to an embodiment.

### DETAILED DESCRIPTION

Embodiments of the disclosure will be described in detail with reference to accompanying drawings.

Technological content well-known in the art or not directly related to the disclosure is omitted in the following description. Through the omission of the content that might otherwise obscure the subject matter of the disclosure, the subject matter will be understood more clearly.

For the same reason, some parts in the accompanying drawings are exaggerated, omitted or schematically illustrated. The size of the respective elements may not fully reflect their actual size. In the drawings, the same or corresponding components are given the same reference numerals.

Advantages and features of the disclosure, and methods for achieving them will be understood more clearly when the following embodiments are read with reference to the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

The terms, as disclosed herein, are defined by taking functionalities in the disclosure into account but may vary depending on practices or intentions of users or operators. Accordingly, the terms should be defined based on descriptions throughout this specification.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

In the following description, a BS is an entity for performing resource allocation for a terminal, and may be at least one of a gNB, an eNB, a Node B, a BS, a radio access unit, a BS controller, or a network node. The terminal may include a UE, a mobile station (MS), a cellular phone, a smart phone, a computer, or a multimedia system capable of performing a communication function. Herein, DL refers to a radio transmission path for a signal transmitted from a BS to a UE, and UL refers to a radio transmission path for a signal transmitted from a UE to a BS. Although the following embodiments will focus on the long term evolution (LTE) or LTE-advanced (LTE-A) system as an example, they may be applied to other communication systems with similar technical backgrounds or channel types. For example, the 5G mobile communication technologies developed since the LTE-A, such as the 5G new radio (NR) may be included in the systems to which the embodiments of the disclosure will be applied, and the term ‘5G’ as herein used may be a concept including the existing LTE, LTE-A, or other similar services. Furthermore, embodiments of the disclosure will also be applied to different communication systems with some modifications to such an extent that does not significantly deviate the scope of the disclosure when judged by skilled people in the art.

Wireless communication systems are evolving from early systems that provide voice-oriented services to broadband wireless communication systems that provide high data rate and high quality packet data services such as third generation partnership project (3GPP) high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and institute of electrical and electronics engineers (IEEE) 802.16e communication standards.

As an example of such a broadband wireless communication system, an LTE system adopts orthogonal frequency division multiplexing (OFDM) for DL and single carrier frequency division multiple access (SC-FDMA) for UL. The UL refers to a radio link for a UE or MS to transmit data or a control signal to an eNode B or BS, and the DL refers to a radio link for a BS to transmit data or a control signal to a UE or MS. Such a multiple access scheme allocates and operates time-frequency resources for carrying data or control information for respective users not to overlap each other, i.e., to maintain orthogonality, thereby differentiating each user's data or control information.

As a future communication system after the LTE, the 5G communication system needs to freely reflect various demands from users and service providers and thus support services that simultaneously meet the various demands. The services considered for the 5G communication system may include eMBB, mMTC, URLLC, etc.

The eMBB is aimed at providing more enhanced data rates than the LTE, LTE-A or LTE-Pro may support. For example, in the 5G communication system, the eMBB is required to provide 20 Gbps peak data rate in DL and 10 Gbps peak data rate in UL in terms of a single BS. The 5G communication system needs to provide increasing user perceived data rate while providing the peak data rate. To satisfy these requirements, various technologies for transmission or reception including multiple-input multiple-output (MIMO) transmission technologies are required to be more enhanced. While the LTE uses up to 20 MHz transmission bandwidth in the 2 GHz band for signal transmission, the 5G communication system may use frequency bandwidth wider than 20 MHz in the 3 to 6 GHz band or in the 6 GHz or higher band, thereby satisfying the data rate required by the 5G communication system.

In the 5G communication system, mMTC is considered to support an application service such as an Internet of Things (IoT) application service. In order for the mMTC to provide the IoT efficiently, support for access from massive number of terminals in a cell, enhanced coverage of the terminal, extended battery time, reduction in terminal price, etc., are required. Because the IoT is equipped in various sensors and devices to provide communication functions, it may be supposed to support a large number of UEs in a cell (e.g., 1,000,000 terminals/km²). Furthermore, a terminal supporting mMTC is more likely to be located in a shadow area, such as underground of a building, which might not be covered by a cell by the nature of the service, so mMTC may require an even larger coverage than expected for other services provided by the 5G communication system. The UE supporting mMTC needs to be a low-cost terminal, and may require quite a long battery life time such as 10 to 15 years because it is difficult to frequently change the battery of the UE.

The URLLC is a mission critical cellular-based wireless communication service. For example, the URLLC may provide services used for remote control over robots or machinery, industrial automation, unmanned aerial vehicle, remote health care, emergency alert, etc. Accordingly, communication offered by the URLLC requires very low latency and very high reliability. For example, URLLC services need to satisfy sub-millisecond (less than 0.5 millisecond) air interface latency and simultaneously require a packet error rate equal to or lower than 10⁻⁵. Hence, for the URLLC services, the 5G system needs to provide a smaller transmit time interval (TTI) than for other services, and simultaneously requires a design that allocates a wide range of resources for a frequency band to secure reliability of the communication link.

Those three services in 5G, eMBB, URLLC, and mMTC may be multiplexed in a single system for transmission. In this case, to meet different requirements for the three services, different transmission or reception schemes and parameters may be used between the services. 5G, however, the disclosure not limited to the three services.

Hereinafter, ‘a/b’ may be understood as at least one of ‘a’ or ‘b’. In addition, higher layer signaling herein refers to a method of transferring a signal to the UE from the BS on a DL data channel of the physical layer or to the BS from the UE on a UL data channel of the physical layer, and may also be referred to as RRC signaling, PDCP signaling, or a MAC CE.

### Nr Time-Frequency Resource

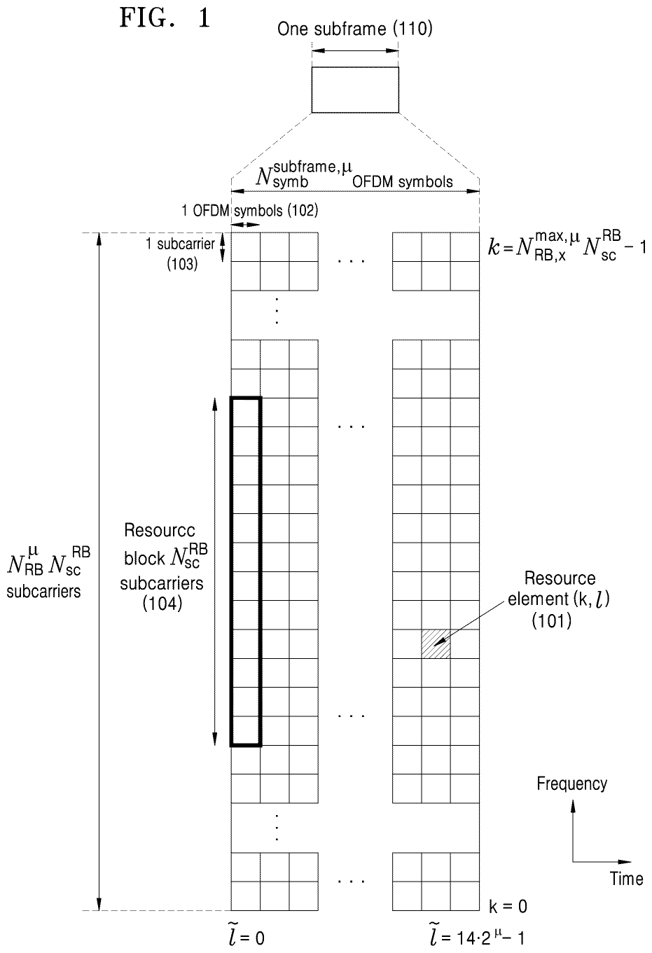

FIG. 1 illustrates a basic structure of a time-frequency domain, which is a radio resource domain in which data or a control channel is transmitted in a 5G system.

Referring to FIG. 1, the horizontal axis represents the time domain, and the vertical axis represents the frequency domain. A basic resource unit in the time and frequency domain is a resource element (RE) 101, which may be defined as an OFDM symbol 102 on the time axis and a subcarrier 103 on the frequency axis. In the frequency domain, N_{sc}^{RB} (e.g., 12) successive REs may constitute a single resource block (RB) 104. One subframe 110 on the time axis may include a plurality of OFDM symbols 102. For example, the one subframe may be 1 ms long.

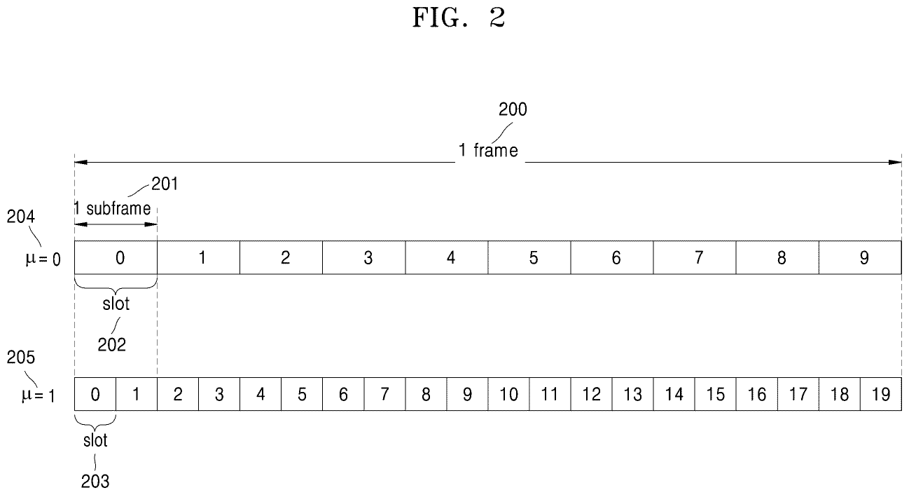

FIG. 2 illustrates a frame, subframe, and slot structure in a wireless communication system, according to an embodiment.

Referring to FIG. 2, shown is an example of a structures of a frame 200, a subframe 201 and a slot 202. The one frame 200 may be defined to be 10 milliseconds (ms) long. The one subframe 201 may be defined to be 1 ms, and thus, a total of 10 subframes 201 may constitute the one frame 200. One slot 202 or 203 may be defined to have 14 OFDM symbols (i.e., the number of symbols per 1 slot N_{symb}^{slot}=14). The one subframe 201 may include one or more slots, and the number of slots 202 or 203 per 1 subframe may vary depending on subcarrier spacing configuration value p (204 or 205). In the example of FIG. 2, the subcarrier spacing configuration values are 0 and 1, i.e., μ=0 (204) and μ=1 (205). In μ=0 (204), the one subframe 201 includes one slot 202, and in μ=1 (205), one subframe 201 includes two slots 203. That is, depending on the subcarrier spacing configuration value μ, the number of slots per a subframe (Nₛₗₒₜ^{subframe,μ}) may vary and the number of slots per a frame (Nₛₗₒₜ^{frame,μ}) may vary accordingly. Nₛₗₒₜ^{subframe,μ} and Nₛₗₒₜ^{frame,μ} depending on the subcarrier spacing configuration value p may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

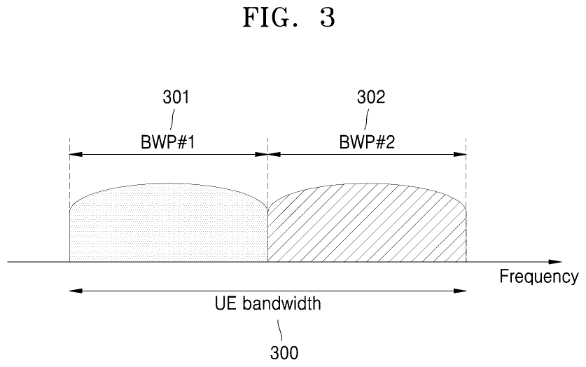

FIG. 3 illustrates an example of configuration of BWPs in a wireless communication system, according to an embodiment.

Referring to FIG. 3, UE bandwidth 300 is configured into two BWPs, BWP #1 301 and BWP #2 302. The BS may configure the UE with one or more BWPs, and configure information of Table 2 below for each BWP.

TABLE 2

| BWP ::= | SEQUENCE { |
|---|---|
| bwp-Id | BWP-Id, |
| locationAndBandwidth | INTEGER (1..65536), |
| subcarrierSpacing | ENUMERATED {n0, n1, n2, |
| n3, n4, n5}, | |
| cyclicPrefix | ENUMERATED { extended } |

}

The disclosure is not limited thereto, and apart from the configuration information, various parameters related to the BWP may also be configured for the UE. The information may be transmitted by the BS to the UE through higher layer signaling, e.g., radio resource control (RRC) signaling. At least one of the configured one or more BWPs may be activated. Whether to activate a configured BWP may be notified by the BS to the UE semi-statically through RRC signaling or dynamically through the DCI.

The UE may be configured with an initial BWP for initial access through a master information block (MIB) from the BS before the UE is RRC connected. Specifically, the UE may receive configuration information for a CORESET and search space (SS) in which a physical DL control channel (PDCCH) may be transmitted for receiving system information (SI) (corresponding to remaining SI (RMSI) or SIB1) required for initial access through the MIB in an initial access process. The CORESET and SS configured in the MIB may each be regarded with identity (ID) 0. The BS may notify the UE of configuration information, such as frequency allocation information, time allocation information, numerology, etc., for CORESET #0, in the MIB. The BS may also notify the UE of configuration information about monitoring periodicity and a monitoring occasion for the CORESET #0, i.e., configuration information about SS #0, in an MIB. The UE may regard a frequency area set to the CORESET #0 obtained from the MIB as the initial BWP for initial access. In this case, the ID of the initial BWP may be regarded as 0.

Such configuration of the BWP supported by the 5G may be used for various purposes.

An occasion when the bandwidth supported by the UE is less than the system bandwidth may be addressed by the BWP configuration. For example, the BS may configure the UE with frequency location of the BWP (configuration information 2), thereby allowing the UE to transmit or receive data in the particular frequency location in the system bandwidth.

To support different numerologies, the BS may configure a plurality of BWPs for the UE. For example, to support data transmission and reception using both 15 KHz subcarrier spacing and 30 KHz subcarrier spacing for a UE, two BWPs may be configured with 15 KHz and 30 KHz subcarrier spacing, respectively. The different BWPs may be frequency division multiplexed (FDMed), and for data transmission and reception with particular subcarrier spacing, a BWP configured with the subcarrier spacing may be activated.

To reduce power consumption of the UE, the BS may configure BWPs with different bandwidth sizes for the UE. For example, when a UE supports a large bandwidth, e.g., 100 MHz bandwidth, and always transmits or receives data in the bandwidth, the UE may consume very large power. In a situation where there is no traffic in particular, monitoring unnecessary DL control channel in the large 100 MHz bandwidth may be very inefficient in terms of power consumption. To reduce the power consumption of the UE, the BS may configure a BWP with relatively small bandwidth, e.g., a 20 MHz BWP, for the UE. In the situation that there is no traffic, the UE may perform monitoring in the 20 MHz BWP, and when data occurs, the UE may transmit or receive the data in the 100 MHz BWP under instructions from the BS.

When configuring a BWP, UEs may receive configuration information for the initial BWP in the MIB in an initial access process before being RRC connected. Specifically, the UE may be configured with a CORESET for a DL control channel on which DCI may be transmitted to schedule a SIB in the MIB of a physical broadcast channel (PBCH). Bandwidth of the CORESET configured in the MIB may be regarded as the initial BWP, and the UE may receive a PDSCH on which the SIB is transmitted in the initial BWP. The initial BWP may also be used for other SI (OSI), paging, or random access apart from reception of the SIB.

### BWP Switching

When one or more BWPs are configured for the UE, the BS may indicate switching or transition of BWP by using a BWP indicator field in DCI to the UE. For example, when a BWP of the UE currently activated is BWP #1 301 in FIG. 3, the BS may indicate BWP #2 302 with a bandwidth indicator in DCI to the UE, and the UE may perform BWP switching to the BWP #2 302 indicated with the BWP indicator in the received DCI.

As the DCI based BWP switching may be indicated by DCI that schedules a PDSCH or PUSCH as described above, the UE may be able to transmit or receive the PDSCH or the PUSCH scheduled by the DCI in the switched BWP without difficulty when receiving the BWP switching request. For this, a standard defines a requirement for a delay time T_{BWP} required for BWP switching, which may be defined, for example, as in Table 3 below:

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirement for BWP switching delay time supports type 1 or type 2 depending on a capability of the UE. The UE may report a supportable BWP delay time type to the BS.

According to the requirement for the BWP switching delay time, the UE may complete switching to a new BWP indicated by the BWP switching indicator no later than slot n+T_{BWP} when receiving DCI including the BWP switching indicator in slot n, and transmit or receive a data channel scheduled by the DCI in the new BWP. The BS may determine to allocate a time domain resource for the data channel by considering the BWP switching delay time T_{BWP} of the UE to schedule the data channel with the new BWP. For example, as for a method of determining time domain resource allocation for a data channel, the BS may schedule the data channel after the BWP switching delay time in scheduling the data channel with the new BWP. Hence, the UE may not expect for the DCI that indicates BWP switching to indicate a slot offset value (K0 or K2) less than the BWP switching delay time T_{BWP}.

When the UE receives DCI (e.g., DCI format 1_1 or 0_1) that indicates BWP switching, the UE may not perform transmission or reception during a time interval from a third symbol of the slot in which a PDCCH including the DCI is received to a starting point of a slot indicated by the slot offset value (K0 or K2) indicated in a time domain resource allocation indicator field in the DCI. For example, when the UE has received DCI that indicates BWP switching in slot n and the slot offset value indicated by the DCI is K, the UE may not perform any transmission or reception from the third symbol of the slot n to a symbol before slot n+K, i.e., the last symbol of slot n+K−1.

### Unified TCI State

The unified TCI framework is to manage transmission and reception beam management schemes distinguished into a TCI state framework used in DL reception of the UE and a spatial relation info scheme used in UL transmission in the existing Rel-15 and 16 by integrating them into the TCI state. Hence, when receiving an indication from the BS based on the unified TCI framework, the UE may perform beam management by using the TCI state even for the UL transmission. In a case that the UE is configured by the BS with a TCI-State, which is higher layer signaling having higher layer signaling tci-stateId-r17, the UE may perform an operation based on the unified TCI framework by using the TCI-State. The TCI-State may exist in two types: joint TCI state or separate TCI state.

The first type is the joint TCI state, in which case the UE may receive an indication of all the TCI states to be applied to UL transmission and DL reception through the one TCI-State from the BS. When the UE receives an indication of a joint TCI state based TCI-State, the UE may receive an indication of a parameter to be used in DL channel estimation using an RS corresponding to qcl-Type1 in the joint TCI state based TCI-state, and a parameter to be used as a DL receive beam or reception filter using an RS corresponding to qcl-Type2. When the UE receives an indication of a joint TCI state based TCI-State, the UE may receive an indication of a parameter to be used as a UL transmit beam or transmission filter using an RS corresponding to qcl-Type2 in the joint DL/UL TCI state based TCI-State. In this case, when the UE receives an indication of the joint TCI state, the UE may apply the same beam both to UL transmission and DL reception.

The second type is the separate TCI state, in which case the UE may separately receive, from the BS, indications of a UL TCI state to be applied in UL transmission and a DL TCI state to be applied in DL reception. When the UE receives an indication of the UL TCI state, the UE may receive an indication of a parameter to be used as a UL transmit beam or transmission filter using a reference RS or source RS set in the UL TCI state. When the UE receives an indication of the DL TCI state, the UE may receive an indication of a parameter to be used in DL channel estimation using an RS corresponding to qcl-Type1 set in the DL TCI state, and a parameter to be used as a DL receive beam or reception filter using an RS corresponding to qcl-Type2.

When the UE receives an indication of both the DL TCI state and the UL TCI state, the UE may receive an indication of a parameter to be used as a UL transmit beam or transmission filter using a reference RS or source RS set in the UL TCI state, and receive an indication of a parameter to be used in DL channel estimation using an RS corresponding to qcl-Type1 set in the DL TCI state and a parameter to be used as a DL receive beam or reception filter using an RS corresponding to qcl-Type2. In this case, when reference RSs or source RSs set in the DL TCI state and UL TCI state indicated to the UE are different, the UE may apply beams for UL transmission and DL reception separately based on the indicated UL TCI state and DL TCI state.

The UE may be configured with up to 128 joint TCI states for each particular BWP in a particular cell in higher layer signaling from the BS, and configured with up to 64 or 128 DL TCI states of the separate TCI states for each particular BWP in the particular cell based on a UE capability report in higher layer signaling, and the joint TCI state and the DL TCI state of the separate TCI state may employ the same higher layer signaling structure. For example, when 128 joint TCI states are configured and 64 DL TCI states of the separate TCI state are configured, the 64 DL TCI states may be included in the 128 joint TCI states.

Up to 32 or 64 UL TCI states of the separate TCI states may be configured for each particular BWP in the particular cell in higher layer signaling based on the UE capability report, and like the relationship between the joint TCI state and the DL TCI state of the separate TCI states, the joint TCI state and the UL TCI state of the separate TCI may also employ the same higher layer signaling structure, or the UL TCI state of the separate TCI may use a different higher layer signaling structure from those of the joint TCI state and the DL TCI state of the separate TCI state.

Using different or the same higher layer signaling structure may be defined in a standard or may be distinguished through another higher layer signaling configured by the BS based on a UE capability report that contains information about which one of the two may be supported by the UE.

The UE may use one of the joint and the separate TCI states configured by the BS to receive an indication related to transmit and receive beams in a unified TCI framework. The UE may be configured by the BS with whether to use one of the joint and the separate TCI states through higher layer signaling.

The UE may use one of the joint TCI state and the separate TCI state selected through higher layer signaling to receive the indication related to transmit and receive beams, in which case the indication of transmit and receive beams from the BS may have two methods: an MAC-CE based indication method and an MAC-CE based activation and DCI based indication method.

When the UE receives the indication related to transmit and receive beams by using the joint TCI state framework through higher layer signaling, the UE may perform a transmit and receive beam application operation by receiving, from the BS, an MAC-CE that indicates the joint TCI state. The BS may schedule reception of a PDSCH including the MAC-CE for the UE through PDCCH. When there is one joint TCI state included in the MAC-CE, the UE may determine a UL transmit beam or transmission filter and a DL receive beam or reception filter by using a joint TCI state indicated 3 ms after transmission of a PUCCH that includes hybrid automatic repeat request acknowledgement (HARQ-ACK) information referring to whether the reception of a PDSCH including the MAC-CE is successful. When there are two or more joint TCI states included in the MAC-CE, the UE may confirm that the plurality of joint TCI states indicated in the MAC-CE 3 ms after transmission of a PUCCH including HARQ-ACK information that refers to whether reception of a PDSCH including the MAC-CE is successful correspond to respective code points in a TCI state field of DCI format 1_1 or 1_2, and activate the indicated joint TCI state. After this, the UE may receive the DCI format 1_1 or 1_2 and apply a joint TCI state indicated in the TCI state filed in the DCI to UL transmit and DL receive beams. In this case, the DCI format 1_1 or 1_2 may include DL data channel scheduling information (with DL assignment) or may not include the DL data channel scheduling information (without DL assignment).

When the UE receives an indication related to transmit and receive beams in higher layer signaling by using the separate TCI state framework, the UE may receive an MAC-CE that indicates a separate TCI state from the BS and perform transmit and receive beam application operations, and the BS may schedule reception of a PDSCH including the MAC-CE for the UE in a PDCCH. When there is a separate TCI state set included in the MAC-CE, the UE may determine a UL transmit beam or transmission filter and a DL receive beam or reception filter by using separate TCI states included in the separate TCI state set indicated 3 ms after transmission of a PUCCH that includes HARQ-ACK information referring to whether the reception of the PDSCH is successful. In this case, the separate TCI state set may refer to one or more separate TCI states that a code point of a TCI state field in DCI format 1_1 or 1_2 may have, and the one separate TCI state set may include one DL TCI state, one UL TCI state, or one DL TCI state and one UL TCI state.

When there are two separate TCI state sets included in the MAC-CE, the UE may confirm that the plurality of separate TCI state sets indicated in the MAC-CE 3 ms after transmission of a PUCCH including HARQ-ACK information that refers to whether reception of the PDSCH is successful correspond to each code point in a TCI state field of DCI format 1_1 or 1_2, and activate the indicated separate TCI state set. In this case, each code point of the TCI state field of DCI format 1_1 or 1_2 may indicate one DL TCI state, one UL TCI state, or one DL TCI state and one UL TCI state. The UE may receive the DCI format 1_1 or 1_2 and apply the separate TCI state set indicated in the TCI state filed in the DCI to UL transmit and DL receive beams. In this case, the DCI format 1_1 or 1_2 may include DL data channel scheduling information (with DL assignment) or may not include the DL data channel scheduling information (without DL assignment).

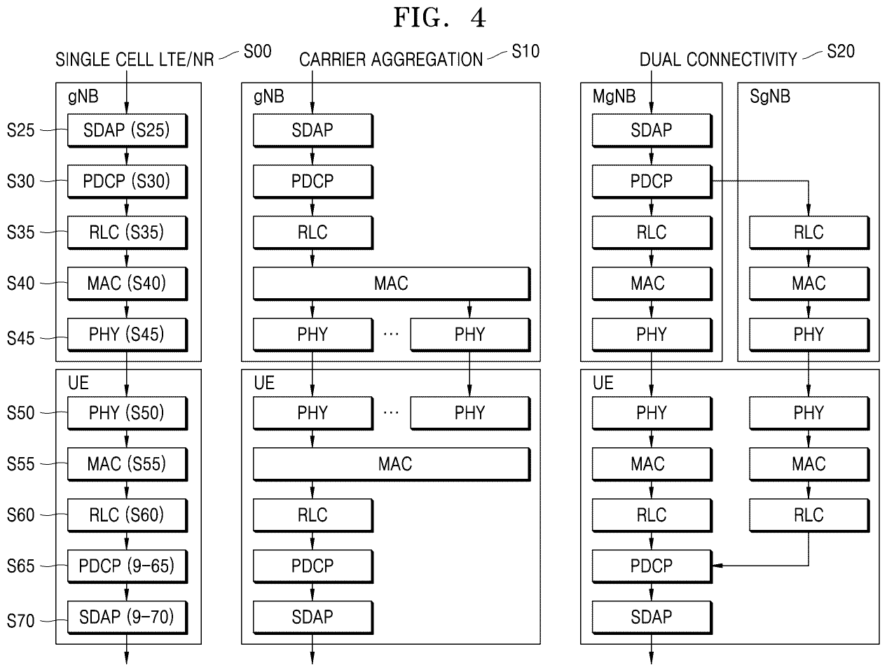

FIG. 4 illustrates a radio protocol architecture of a BS and a UE with conditions of a single cell S00, CA S10 and DC S20 in a wireless communication system, according to an embodiment.

Referring to FIG. 4, S00 is a radio protocol architecture that constitutes single cell LTE/NR, where the gNB and the UE may each include a service data adaptation protocol (SDAP) layer S25 or S70, a packet data convergence protocol (PDCP) layer S30 or S65, a radio link control (RLC) layer S35 or S60, a MAC layer S40 or S55 and a physical (PHY) layer S45 or S50.

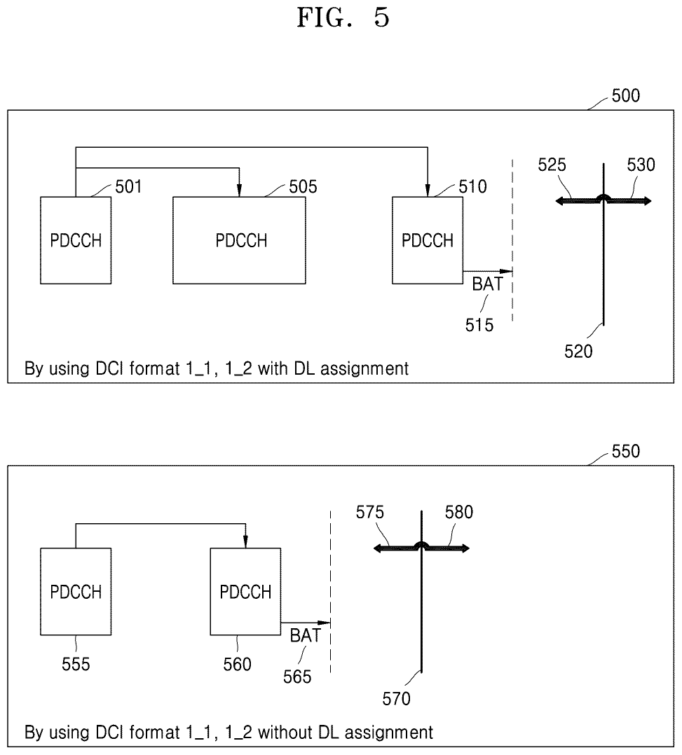

FIG. 5 illustrates a BAT that may be considered when a unified TCI framework is used in a wireless communication system, according to an embodiment. As described above, the UE may receive the DCI format 1_1 or 1_2 that includes the DL data channel scheduling information (with DL assignment) or that does not include the DL data channel scheduling information (without DL assignment), and apply one joint TCI state or separate TCI state set indicated in the TCI state field in the DCI to UL transmit and DL receive beams.

Referring to FIG. 5, for DCI format 1_1 or 1_2 with DL assignment in 500, when the UE receives DCI format 1_1 or 1_2 including DL data channel scheduling information from the BS in 501, and indicates a separate TCI state set or one joint TCI state based on the unified TCI framework, the UE may receive a PDSCH scheduled based on the received DCI in 505, and transmit a PUCCH including HARQ-ACK that refers to whether reception of the DCI and PDSCH is successful in 510. In this case, the HARQ-ACK may include meanings of whether reception of the DCI and the PDSCH is successful, and when at least one of the DCI or the PDSCH is not received, the UE may transmit NACK, and when both the two are successfully received, the UE may transmit ACK.

For DCI format 1_1 or 1_2 without DL assignment in 550, when the UE receives DCI format 1_1 or 1_2 that does not include DL data channel scheduling information from the BS in 555, and indicates a separate TCI state set or one joint TCI state based on the unified TCI framework, the UE may assume at least one combination of the following occasions for the DCI:

Including cyclic redundancy check (CRC) scrambled using a configured scheduling (CS) radio network temporary identifier (RNTI)

All bits allocated to all fields used as a redundancy version (RV) field have a value of 1

All bits allocated to all fields used as a modulation and coding scheme (MCS) field have a value of 1

All bits allocated to all fields used as a new data indication (NDI) field have a value of 0

For a frequency domain resource allocation (FDRA) type 0, all bits allocated to an FDRA field have a value of 0; for an FDRA type 1, all bits allocated to the FDRA field have a value of 1; when the FDRA type is dynamicSwitch, all bits allocated to the FDRA field has a value of 0.

The UE may transmit a PUCCH including HARQ-ACK that refers to whether reception of the DCI format 1_1 or 1_2 with the aforementioned assumption is successful in 560.

For both the DCI format 1_ or 1_2 with DL assignment in 500 and without DL assignment in 550, when a new TCI state indicated through the DCI 501 and 555 is equal to the TCI state that has already been indicated and applied to UL transmit and DL receive beams, the UE may maintain the TCI state that has already been applied. When the new TCI state is different from the TCI state that has already been indicated, the UE may determine an application time of the joint TCI state or separate TCI state set that may be indicated in a TCI state field included in the DCI to be after (530 or 580) the first slot (520 or 570) after a BAT (515 or 565) passes after transmission of the PUCCH, and may use the TCI state that has already been indicated until before (525 or 575) the slot (520 or 570).

For both the DCI format 1_1 or 1_2 with DL assignment 500 and without DL assignment 550, the BAT may be a certain number of OFDM symbols and set in higher layer signaling based on UE capability report information, and the numerology for the BAT and the first slot after the BAT may be determined based on the smallest numerology of all cells to which the joint TCI state or separate TCI state set indicated in the DCI is applied.

The UE may apply the one joint TCI state indicated in the MAC-CE or DCI to reception of CORESETs connected to all UE-specific SSs, transmission of a PUSCH and reception of a PDSCH scheduled in a PDCCH transmitted in the corresponding CORESET, and transmission of all PUCCH resources.

When the one separate TCI state set indicated in the MAC-CE or DCI includes one DL TCI state, the UE may apply the one separate TCI state set to reception of CORESETs connected to all UE-specific SSs and reception of a PDSCH scheduled in a PDCCH transmitted in the corresponding CORESET, and apply the UL TCI state that has been indicated to all PUSCH and PUCCH resources.

When the one separate TCI state set indicated in the MAC-CE or DCI includes one UL TCI state, the UE may apply the one separate TCI state set to all PUSCH and PUCCH resources, and apply the DL TCI state that has been indicated to reception of control resources sets connected to all UE-specific SSs and reception of a PDSCH scheduled in a PDCCH transmitted in the corresponding CORESET.

When the one separate TCI state set indicated in the MAC-CE or DCI includes one DL TCI state and one UL TCI state, the UE may apply the DL TCI state to reception of CORESETs connected to all UE-specific SSs and reception of a PDSCH scheduled in a PDCCH transmitted in the corresponding CORESET, and apply the UL TCI state to all PUSCH and PUCCH resources.

### Unified TCI State MAC-CE

The UE may be scheduled by the BS for a PDSCH that includes the following MAC-CE, and 3 slots after transmitting HARQ-ACK for the PDSCH, the UE may interpret each code point of a TCI state field in the DCI format 1_1 or 1_2 based on information in the MAC-CE received from the BS. In other words, the UE may activate each entry of the MAC-CE received from the BS at each code point of the TCI state field in the DCI format 1_1 or 1_2.

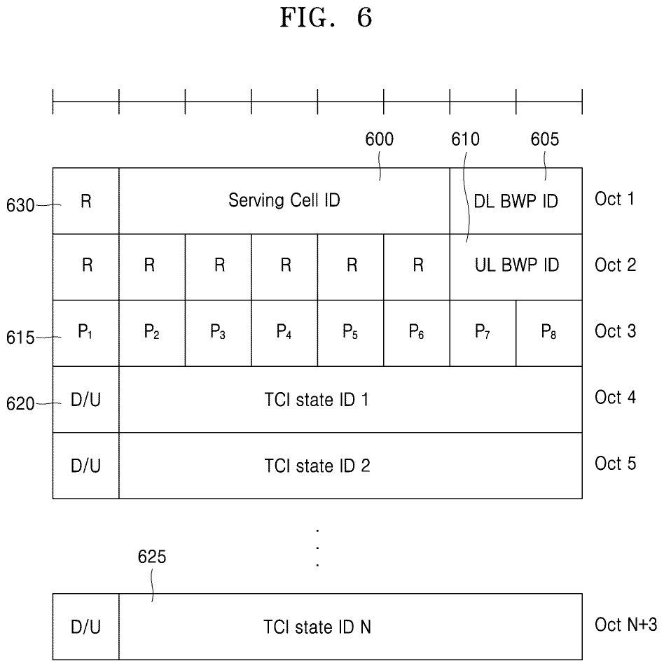

FIG. 6 illustrates another MAC-CE structure for joint TCI state or separate DL or UL TCI state activation and indication in a wireless communication system, according to an embodiment.

Referring to FIG. 6, the serving cell ID (600) field may indicate which serving cell it is that the MAC-CE is to be applied. The field may be 5-bit long. When a serving cell indicated by the field is included in one or more of higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in a list of one or more of simultaneousU-TCI-UpdateList1, simultaneousU-TCI-UpdateList2, simultaneousU-TCI-UpdateList3, simultaneousU-TCI-UpdateList4, including the serving cell indicated by the field.

The DL BWP ID (605) field may indicate which DL BWP it is that the MAC-CE is to be applied, and the meaning of each code point of the field may correspond to each code point of a BWP indicator in the DCI. The field may be 2-bit long.

The UL BWP ID (610) field may indicate which UL BWP it is that the MAC-CE is to be applied, and the meaning of each code point of the field may correspond to each code point of a BWP indicator in the DCI. The field may be 2-bit long.

The Pᵢ (615) field may indicate whether each code point of the TCI state field in the DCI format 1_1 or 1_2 has a plurality of TCI states or one TCI state. When Pᵢ has a value of 1, this indicates that the i-th code point has a plurality of TCI states, which may mean that the code point may include the separate DL TCI state and the separate UL TCI state. When Pᵢ has a value of 0, this indicates that the i-th code point has a single TCI state, which may mean that the code point may include one of the joint TCI state or the separate DCI TCI state, or the separate UL TCI state.

The D/U (620) field may indicate whether a TCI state ID field in the same octet corresponds to the joint TCI state or the separate DL TCI state, or the separate UL TCI state. When the field is 1, the TCI state ID field in the same octet may correspond to the joint TCI state or the separate DL TCI state, and when the field is 0, the TCI state ID field in the same octet may correspond to the separate UL TCI state.

The TCI state ID (625) field may indicate a TCI state that may be identified by higher layer signaling TCI-StateId. When the D/U field is set to 1, the field may be used to represent TCI-StateId that may be represented in 7 bits. When the D/U field is set to 0, a most significant bit (MSB) of the field may be regarded as a reserved bit and the remaining six bits may be used to represent higher layer signaling UL-TCIState-ld. The maximum number of TCI states that may be activated may be eight for the joint TCI state, and sixteen for the separate DL or UL TCI state.

The R (630) field indicates a reserved bit, which may be set to 0.

As for the MAC-CE structure of FIG. 6, the UE may include the third octet including P₁, P₂, . . . , and P₈ fields in the MAC-CE structure in FIG. 6, regardless of whether unifiedTCI-StateType-r17 in MIMOparam-r17 in higher layer signaling ServingCellConfig is set to ‘joint’ or ‘separate’. In this case, the UE may perform TCI state activation by using the MAC-CE structure that is stationary regardless of higher layer signaling configured by the BS. In another embodiment, as for the MAC-CE structure of FIG. 6, the UE may omit the third octet including P₁, P₂, . . . , and P₈ fields in FIG. 6, when unifiedTCI-StateType-r17 in MIMOparam-r17 in higher layer signaling ServingCellConfig is set to ‘joint’. In this case, the UE may save up to 8 bits of the payload of the MAC-CE depending on the higher layer signaling configured by the BS. Furthermore, D/U fields placed in the first bit from the fourth octet in FIG. 6 may all be regarded as field R, which may be set to bit 0.

### PDCCH: DCI

In the 5G system, scheduling information for UL data (or PUSCH) or DL data (or PDSCH) is transmitted from the BS to the UE in DCI. The UE may monitor a fallback DCI format and a non-fallback DCI format for PUSCH or PDSCH. The fallback DCI format may include a fixed field predefined between the BS and the UE, and the non-fallback DCI format may include a configurable field.

The DCI may be transmitted on the PDCCH after going through channel coding and modulation processes. A CRC may be appended to a DCI message payload, and the CRC may be scrambled by an RNTI that corresponds to an ID of the UE. Depending on the use of the DCI message, e.g., UE-specific data transmission, power control instruction, random access response, or the like, different RNTIs may be used. In other words, the RNTI is transmitted not explicitly but in a CRC calculation process. On reception of a DCI message transmitted on the PDCCH, the UE may check CRC using an allocated RNTI, and determine that the DCI message is transmitted to the UE when the CRC check result is correct.

For example, DCI that schedules a PDSCH for SI may be scrambled by SI-RNTI. DCI that schedules a PDSCH for a random access response (RAR) message may be scrambled by an RA-RNTI. DCI that schedules a PDSCH for a paging message may be scrambled by a P-RNTI. DCI that notifies a slot format indicator (SFI) may be scrambled by an SFI-RNTI. DCI that notifies a transmit power control (TPC) may be scrambled by a TPC-RNTI. DCI that schedules UE-specific PDSCH or PUSCH may be scrambled by a Cell RNTI (C-RNTI).

DCI format 0_0 may be used for the fallback DCI that schedules a PUSCH, in which case the CRC may be scrambled by a C-RNTI. The DCI format 0_0 with the CRC scrambled by a C-RNTI may include information e.g., in Table 4 below.

TABLE 4

| | |
|---|---|
| - | Identifier for DCI formats - [1] bit |
| - | Frequency domain resource assignment-[┌log₂( |

N_{RB}^{UL,BWP}(N_{RB}^{UL,BWP} + 1)/2)┐ ] bits

| | |
|---|---|
| - | Time domain resource assignment- X bits |
| - | Frequency hopping flag- 1 bit. |
| - | Modulation and coding scheme- 5 bits |
| - | New data indicator- 1 bit |
| - | Redundancy version- 2 bits |
| - | HARQ process number- 4 bits |
| - | TPC command for scheduled PUSCH (transmit power control) - [2] |
| | bits |
| - | UL/SUL indicator- 0 or 1 bit |

DCI format 0_1 may be used for the non-fallback DCI that schedules a PUSCH, in which case the CRC may be scrambled by a C-RNTI. The DCI format 0_1 with the CRC scrambled by a C-RNTI may include information e.g., in Table 5 below.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
  • For resource allocation type 0, ┌N_{RB}^{UL,BWP}/P┐] bits
  • For resource allocation type 1, ┌log₂ (N_{RB}^{UL,BWP} (N_{RB}^{UL,BWP} + 1)/2┐ bits
- Time domain resource assignment -1, 2, 3, or 4 bits
- VRB-to-PRB mapping ((virtual resource block)-to- (physical resource block)) -
0 or 1 bit, only for resource allocation type 1.
  • 0 bit if only resource allocation type 0 is configured;
  • 1 bit otherwise.
- Frequency hopping flag - 0 or 1 bit, only for resource allocation type 1.
  • 0 bit if only resource allocation type 0 is configured;
  • 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
  • 1 bit for semi-static HARQ-ACK codebook;
  • 2 bits for dynamic HARQ-ACK codebook with single HARQ-ACK codebook.
- 2nd downlink assignment index - 0 or 2 bits
  • 2 bits for dynamic HARQ-ACK codebook with two HARQ-ACK sub-codebooks
  • 0 bit otherwise.
- TPC command for scheduled PUSCH - 2 bits
SRS resource indicator - log2 (Ekmax2 (NSRS))] or [log2 (NSRS)] bits
$- SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$
$\cdot ⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$
transmission;
  • [log₂ (N_{SRS})] bits for codebook based PUSCH transmission.
- Precoding information and number of layers -up to 6 bits
- Antenna ports - up to 5 bits
- SRS request - 2 bits
- CSI request - 0, 1, 2, 3, 4, 5, or 6 bits
- CBG transmission information- 0, 2, 4, 6, or 8 bits
- PTRS-DMRS association- 0 or 2 bits.
- beta_offset indicator- 0 or 2 bits
- DMRS sequence initialization- 0 or 1 bit
```

DCI format 1_0 may be used for the fallback DCI that schedules a PDSCH, in which case the CRC may be scrambled by a C-RNTI. The DCI format 1_0 with the CRC scrambled by a C-RNTI may include information e.g., in Table 6 below.

TABLE 6

| | |
|---|---|
| - | Identifier for DCI formats - [1] bit |
| - | Frequency domain resource assignment - [┌log₂( |

N_{RB}^{DL,BWP}(N_{RB}^{DL,BWP} + 1)/2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator- [3] bits |

DCI format 1_1 may be used for the non-fallback DCI that schedules a PDSCH, in which case the CRC may be scrambled by a C-RNTI. The DCI format 1_1 with the CRC scrambled by a C-RNTI may include information e.g., in Table 7 below.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

| | |
|---|---|
| • | For resource allocation type 0, |
| | ┌N_{RB}^{DL,BWP}/P┐ bits |
| • | For resource allocation type 1, ┌log₂( |
| | N_{RB}^{DL,BWP}(N_{RB}^{DL,BWP} + 1)/2)┐ bits |

| | |
|---|---|
| - | Time domain resource assignment -1, 2, 3, or 4 bits |
| - | VRB-to-PRB mapping - 0 or 1 bit, only for resource allocation |
| | type 1. |

| | |
|---|---|
| • | 0 bit if only resource allocation type 0 |
| | is configured; |
| • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger- 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### PDCCH: CORESET, REG, CCE, SS

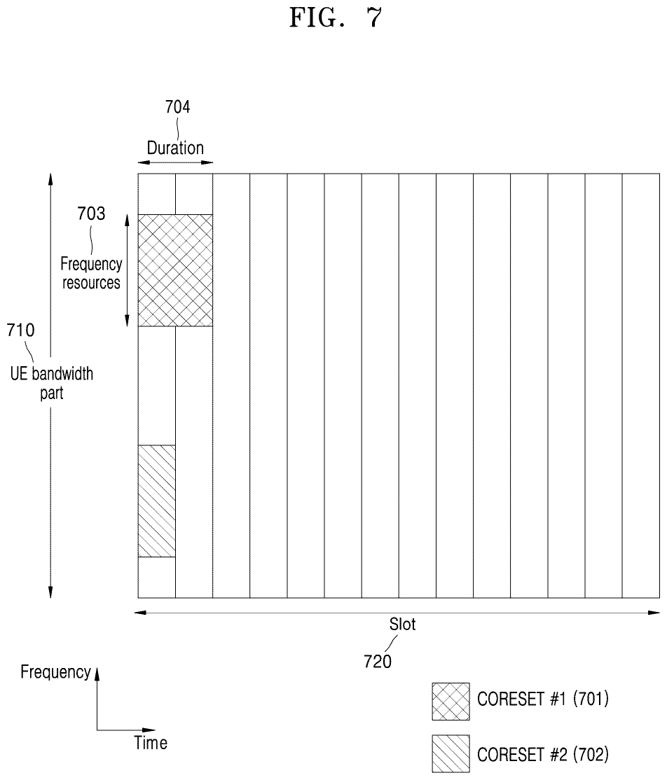

FIG. 7 illustrates an example of CORESETs in which a DL control channel is transmitted in the 5G wireless communication system according to an embodiment. Referring to FIG. 7, UE BWP 710 is configured on the frequency axis, and two CORESETs, CORESET #1 701 and CORESET #2 702, are configured on the time axis in a slot 720. The CORESETs 701 and 702 may be configured in a particular frequency resource 703 in the entire UE BWP 710 on the frequency axis. One or more OFDM symbols may be configured on the time axis, and defined as CORESET duration 704. The CORESET #1 701 is configured to have the CORESET duration of two symbols, and the CORESET #2 702 is configured to have the CORESET duration of one symbol.

As described above, in 5G, the CORESET may be configured by the BS for the UE through higher layer signaling, e.g., SI, MIB, or RRC signaling. Configuring the UE with a CORESET indicates providing the UE with information such as a CORESET ID, a frequency location of the CORESET, length of symbols of the CORESET, etc. For example, information in Table 8 below may be included.

TABLE 8

| | |
|---|---|
| ControlResourceSet ::= | SEQUENCE { |

-- Corresponds to L1 parameter ‘CORESET-ID’
controlResourceSetId
ControlResourceSetId,
frequencyDomainResources

BIT STRING (SIZE

(45)),

| | |
|---|---|
| duration | INTEGER |

(1..maxCoReSetDuration),

| | |
|---|---|
| cce-REG-MappingType | CHOICE |

{

interleaved
SEQUENCE {

reg-BundleSize

ENUMERATED {n2, n3, n6},

precoderGranularity

ENUMERATED {sameAsREG-bundle, allContiguousRBs},

interleaverSize

ENUMERATED {n2, n3, n6}

shiftIndex

INTEGER(0..maxNrofPhysicalResourceBlocks-1)

OPTIONAL

},

| | |
|---|---|
| nonInterleaved | NULL |

},
tci-StatesPDCCH
SEQUENCE(SIZE (1..maxNrofTCI-StatesPDCCH)) OF TCI-StateId

OPTIONAL,

| | |
|---|---|
| tci-PresentInDCI | ENUMERATED |

{enabled}

OPTIONAL, -- Need S

}

In Table 8, tci-StatesPDCCH (or TCI state) configuration information may include information about one or more synchronization signal/PBCH block (SSB) indexes having a QCL relation with a demodulation RS (DMRS) transmitted in the corresponding CORESET or channel state information RS (CSI-RS) indexes.

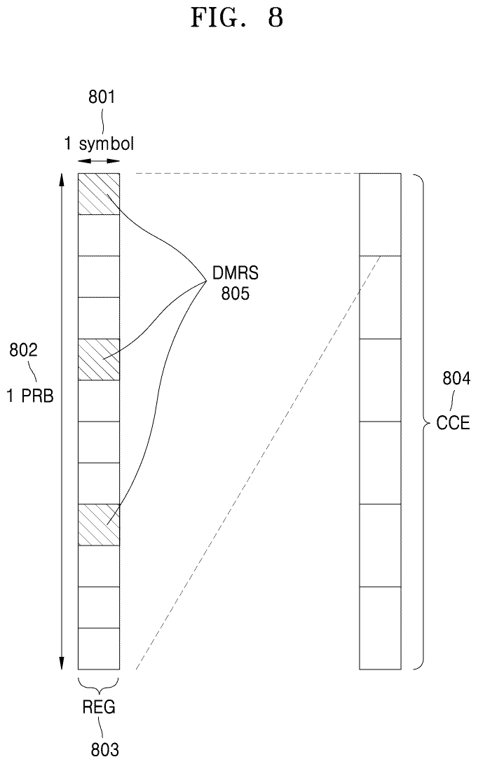

FIG. 8 illustrates an example of a basic unit of time and frequency resource that forms a DL control channel to be used in 5G according to an embodiment. Referring to FIG. 8, a basic unit of time and frequency resource that forms a control channel is referred to as a resource element group (REG) 803. The REG 803 may be defined by one OFDM symbol 801 on the time axis and one physical resource block (PRB) 802, i.e., 12 subcarriers on the frequency axis. The BS may configure a DL control channel allocation unit by connecting REGs 803.

In FIG. 8, when the DL control channel allocation unit is called a control channel element (CCE) 804 in 5G, one CCE 804 may include a plurality of REGs 803. For example, as shown in FIG. 8, the REG 803 may include 12 REs, and when one CCE 804 includes 6 REGs 803, the one CCE 804 may include 72 REs. When the DL CORESET is configured, it may include a plurality of CCEs 804, and a particular DL control channel may be transmitted by being mapped to one or more CCEs 804 based on an aggregation level (AL) in the CORESET. The CCEs 804 in the CORESET may be distinguished by numbers, which may be allocated to the CCEs 804 in a logical mapping method.

The basic unit of the DL control channel shown in FIG. 8, i.e., the REG 803, may include both REs to which DCI is mapped and an area to which DMRS 805 that is an RS to decode them is mapped. As shown in FIG. 8, three DMRSs 805 may be transmitted in one REG 803. The number of CCEs required to transmit the PDCCH may be 1, 2, 4, 8, or 16 depending on the AL, and different numbers of CCEs may be used to implement link adaptation of the DL control channel. For example, when AL=L, a single DL control channel may be transmitted in L CCEs. The UE needs to detect a signal without knowing information about the DL control channel, and SS representing a set of CCEs is defined for the blind decoding. The SS is a set of DL control channel candidates that include CCEs on which the UE needs to try decoding at a given AL, and the UE may have a plurality of SSs because there are various ALs each making a bundle with 1, 2, 4, 8, or 16 CCEs. A SS set may be defined as a set of SSs at all the set ALs.

The SSs may be classified into common SSs and UE-specific SSs. A certain group of UEs or all the UEs may check into a common SS of the PDCCH to dynamically schedule the SI or receive cell-common control information, such as a paging message. For example, PDSCH scheduling allocation information for transmitting an SIB including cell operator information or the like may be received by checking into the common SS of the PDCCH. For the common SS, a certain group of UEs or all the UEs need to receive the PDCCH, so the common SS may be defined as a set of pre-appointed CCEs. UE-specific PDSCH or PUSCH scheduling allocation information may be received by checking into the UE-specific SS of the PDCCH. The UE-specific SS may be UE-specifically defined as a function of various system parameters and an ID of the UE.

In 5G, parameters of the SS of the PDCCH may be set by the BS for the UE in upper layer signaling (e.g., SIB, MIB, or RRC signaling). For example, the BS may configure the number of PDCCH candidates at each AL, monitoring periodicity for the SS, monitoring occasion in symbols in the slot for the SS, a type of the SS (common SS or UE-specific SS), a combination of a DCI format to be monitored in the SS and an RNTI, a CORESET index to monitor the SS, etc., for the UE. For example, higher layer signaling may include information in Table 9 below.

TABLE 9

| | |
|---|---|
| SearchSpace ::= | SEQUENCE { |

```
      -- Identity of the search space. SearchSpaceId = 0 identifies the SearchSpace
configured via PBCH (MIB) or ServingCellConfigCommon.
      searchSpaceId
      SearchSpaceId,
      controlResourceSetId
      ControlResourceSetId,
```

| | |
|---|---|
| monitoringSlotPeriodicityAndOffset | CHOICE { |

sl1

NULL,

sl2

INTEGER (0..1),

sl4

INTEGER (0..3),

sl5

INTEGER (0..4),

sl8

INTEGER (0..7),

sl10

INTEGER (0..9),

sl16

INTEGER (0..15),

sl20

```
      INTEGER (0..19)
      }
```

OPTIONAL,

| | |
|---|---|
| duration | INTEGER (2..2559) |

| | |
|---|---|
| monitoringSymbolsWithinSlot | BIT STRING |

(SIZE (14))

OPTIONAL,

| | |
|---|---|
| nrofCandidates | SEQUENCE { |

| | |
|---|---|
| aggregationLevel1 | ENUMERATED {n0, n1, n2, n3, n4, |

n5, n6, n8},

| | | |
|---|---|---|
| | aggregationLevel2 | ENUMERATED {n0, n1, n2, n3, n4, |
| n5, n6, n8}, | aggregationLevel4 | ENUMERATED {n0, |

n1, n2, n3, n4, n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

n5, n6, n8}
},

| | |
|---|---|
| searchSpaceType | CHOICE { |

-- Configures this search space as common search space (CSS) and

DCI formats to monitor.

common

```
      SEQUENCE {
    }
```

ue-Specific

SEQUENCE {

-- Indicates whether the UE monitors in this USS for DCI formats

0-0 and 1-0 or for formats 0-1 and 1-1.

formats

ENUMERATED {formats0-0-And-1-0, formats0-1-And-1-1},

...
}

Based on the configuration information, the BS may configure the UE with one or more SS sets. The BS may configure the UE with SS set 1 and SS set 2, configure the UE to monitor DCI format A scrambled by X-RNTI in the SS set 1 in the common SS and monitor DCI format B scrambled by Y-RNTI in the SS set 2 in the UE-specific SS.

The configuration information may indicate that there is one or more SS sets in the common or UE-specific SS. For example, SS set #1 and SS set #2 may be configured as the common SS, and SS set #3 and SS set #4 may be configured as the UE-specific SS.

In the common SS, the following combinations of DCI formats and RNTIs may be monitored. The disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific SS, the following combinations of DCI formats and RNTIs may be monitored. The disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The enumerated RNTIs may follow the following definitions and uses.
C-RNTI (Cell RNTI) is used for UE-specific PDSCH scheduling
TC-RNTI (Temporary Cell RNTI) is used for UE-specific PDSCH scheduling
CS-RNTI (Configured Scheduling RNTI) is used for semi-statically configured UE-specific PDSCH scheduling
RA-RNTI (Random Access RNTI) is used for PDSCH scheduling in a random access process
P-RNTI (Paging RNTI) is used for scheduling a PDSCH on which paging is transmitted
SI-RNTI is used for scheduling a PDSCH on which system information is transmitted
INT-RNTI (Interruption RNTI) is used for indicating whether to puncture the PDSCH
TPC-PUSCH-RNTI (Transmit Power Control for PUSCH RNTI) is used for indicating power control command for a PUSCH
TPC-PUCCH-RNTI (Transmit Power Control for PUCCH RNTI) is used for indicating power control command for a PUCCH
TPC-SRS-RNTI (Transmit Power Control for SRS RNTI) is used for indicating power control command for a SRS

The aforementioned DCI formats may conform to definitions in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, with CORESET p and SS set s, a SS at aggregation level L may be expressed as in Equation 1 below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

In Equation (1):
L: aggregation level (AL)
n_{CI}: carrier index
N_{CCE,p}: a total number of CCEs present in the CORESET p
n_{s,f}^{μ}: slot Index
M_{s,max}^{(L)}: a number of PDCCH candidate at aggregation level L
   m_{s,n}_{_{CI}}=0, . . . , M_{s,max}^{(L)}−1: Indexes of PDCCH candidates at aggregation level L
   i=0, . . . , L−1
   Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for p mod 3=0, Aₚ=39829 for p mod 3=1, Aₚ=39839 for p mod 3=2, D=65537
   n_{RNTI}: UE identifier

A value of Y_{p,n}_{_{s,f}}_{^{μ}} may correspond to 0 for common SS.

The value of Y_{p,n}_{_{s,f}}_{^{μ}} may correspond to a value that changes by a UE Identity (C-RNTI or ID configured by the BS for the UE) and time index for the UE-specific SS.

As it is possible to configure a plurality of SS sets with different parameters as in Table 9 in 5G, the UE may monitor a different SS set every time. For example, when the SS set #1 is configured with X-slot periodicity and the SS set #2 is configured with Y-slot periodicity, where X and Y are different, the UE may monitor both the SS set #1 and the SS set #2 in a particular slot, and monitor one of the SS set #1 and the SS set #2 in another particular slot.

### PUSCH: Transmission Scheme

PUSCH transmission may be dynamically scheduled by UL grant in DCI, or operated by configured grant Type 1 or Type 2. Dynamic scheduling indication for PUSCH transmission may be indicated by DCI format 0_0 or 0_1.

Configured grant Type 1 PUSCH transmission may be quasi-statically configured not by receiving UL grant in DCI but by receiving configuredGrantConfig including rrc-ConfiguredUplinkGrant of Table 11 below through higher layer signaling. Configured grant Type 2 PUSCH transmission may be semi-persistently scheduled by UL grant in DCI after reception of configuredGrantConfig that does not include rrc-ConfiguredUplinkGrant of Table 11 through higher layer signaling. When the PUSCH transmission is operated by configured grant, parameters applied to the PUSCH transmission are applied through higher layer signaling configuredGrantConfig of Table 11 except dataScramblingIdentityPUSCH, txConfig, codebookSubset, maxRank, scaling of UCI-OnPUSCH provided by higher layer signaling, pusch-Config of Table 12 below. When the UE receives transformPrecoder in higher layer signaling configuredGrantConfig of Table 11, the UE applies tp-pi2BPSK in pusch-Config of Table 12 for the PUSCH transmission operated by the configured grant.

TABLE 11

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

PathlossReferenceRSs-1),
...

| | |
|---|---|
| } | OPTIONAL, -- |

Need R
...
}

A DMRS antenna port for PUSCH transmission is identical to an antenna port for SRS transmission. PUSCH transmission may follow a codebook based transmission method or a non-codebook based transmission method depending on whether a value of txConfig in higher layer signaling pusch-Config of Table 12 is ‘codebook’ or ‘nonCodebook’.

As described above, PUSCH transmission may be dynamically scheduled by DCI format 0_0 or 0_1, or quasi-statically configured by the configured grant. When the UE receives an indication of scheduling of PUSCH transmission by DCI format 0_0, the UE performs beam configuration for PUSCH transmission by using pucch-spatialRelationInfoID corresponding to a UE-specific PUCCH resource corresponding to a smallest ID in an activated UL BWP in the serving cell, in which case the PUSCH transmission is based on a single antenna port. The UE does not expect scheduling for the PUSCH transmission by DCI format 0_0 in a BWP in which a PUCCH resource including pucch-spatialRelationInfo is not configured. When the UE is not configured with txConfig in the pusch-Config of Table 12, the UE does not expect to be scheduled in DCI format 0_1.

TABLE 12

| | |
|---|---|
| PUSCH-Config ::= | SEQUENCE { |
| dataScramblingIdentityPUSCH | INTEGER (0..1023) |

| | |
|---|---|
| OPTIONAL, | -- Need S |

| | |
|---|---|
| txConfig | ENUMERATED {codebook, nonCodebook} |

| | |
|---|---|
| OPTIONAL, | -- Need S |

| | |
|---|---|
| dmrs-UplinkForPUSCH-MappingTypeA | SetupRelease { DMRS-UplinkConfig } |

| | |
|---|---|
| OPTIONAL, | -- Need M |

| | |
|---|---|
| dmrs-UplinkForPUSCH-MappingTypeB | SetupRelease { DMRS-UplinkConfig } |

| | |
|---|---|
| OPTIONAL, | -- Need M |

| | |
|---|---|
| pusch-PowerControl | PUSCH-PowerControl |

| | |
|---|---|
| OPTIONAL, | -- Need M |

| | |
|---|---|
| frequencyHopping | ENUMERATED {intraSlot, interSlot} |

| | |
|---|---|
| OPTIONAL, | -- Need S |

| | |
|---|---|
| frequencyHoppingOffsetLists | SEQUENCE (SIZE (1..4)) OF INTEGER (1.. |

maxNrofPhysicalResourceBlocks-1)

OPTIONAL, -

- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

| | |
|---|---|
| OPTIONAL, | -- Need S |

| | |
|---|---|
| mcs-Table | ENUMERATED {qam256, qam64LowSE} |

| | |
|---|---|
| OPTIONAL, | -- Need S |

| | |
|---|---|
| mcs-TableTransformPrecoder | ENUMERATED {qam256, qam64LowSE} |

| | |
|---|---|
| OPTIONAL, | -- Need S |

| | |
|---|---|
| transformPrecoder | ENUMERATED {enabled, disabled} |

| | |
|---|---|
| OPTIONAL, | -- Need S |

| | |
|---|---|
| codebookSubset | ENUMERATED |

{fullyAndPartialAndNonCoherent, partialAndNonCoherent,nonCoherent}

OPTIONAL, -- Cond

codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Codebook based PUSCH transmission may be dynamically scheduled by DCI format 0_0 or 0_1, or quasi-statically operated by the configured grant. When the codebook based PUSCH transmission is dynamically scheduled by DCI format 0_1 or quasi-statically configured by the configured grant, the UE determines a precoder for PUSCH transmission based on an SRS resource indicator (SRI), a transmission precoding matrix indicator (TPMI), and a transmission rank (the number of PUSCH transmission layers).

The SRI may be given by a field in DCI, SRS resource indicator, or configured by higher layer signaling srs-ResourceIndicator. The UE may be configured with at least one and up to two SRS resources for codebook based PUSCH transmission. When the UE receives the SRI in DCI, an SRS resource indicated by the SRI refers to an SRS resource corresponding to the SRI among SRS resources transmitted before the PDCCH including the SRI. The TPMI and the transmission rank may be given by a field in the DCI, ‘precoding information and number of layers’, or configured by higher layer signaling precodingAndNumberOfLayers. The TPMI is used to indicate a precoder to be applied for PUSCH transmission. When the UE is configured with one SRS resource, the TPMI is used to indicate a precoder to be applied in the configured one SRS resource. When the UE is configured with a plurality of SRS resources, the TPMI is used to indicate a precoder to be applied in the SRS resource indicated by the SRI.

The precoder to be used for PUSCH transmission is selected from a UL codebook having the same number of antenna ports as a value of nrofSRS-Ports in higher layer signaling SRS-Config. In the codebook based PUSCH transmission, the UE determines a codebook subset based on the TPMI and codebookSubset in higher layer signaling pusch-Config. The codebookSubset in the higher layer signaling pusch-Config may be configured as one of ‘fullyAndPartialAndNonCoherent’, ‘partialAndNonCoherent’, and ‘nonCoherent’ based on the UE capability reported by the UE to the BS. When the UE reports ‘partialAndNonCoherent’ in the UE capability, the UE does not expect that higher layer signaling, codebookSubset is configured to have a value of ‘fullyAndPartialAndNonCoherent’. When the UE reports ‘nonCoherent’ in the UE capability, the UE does not expect that higher layer signaling codebookSubset is configured to have a value of ‘fullyAndPartialAndNonCoherent’ or ‘partialAndNonCoherent’. When nrofSRS-Ports in higher layer signaling SRS-ResourceSet indicates two SRS antenna ports, the UE does not expect that higher layer signaling codebookSubset is configured to have a value of ‘partialAndNonCoherent’.

The UE may be configured with one SRS resource set with a value of the usage in higher layer signaling SRS-ResourceSet set to ‘codebook’, and one SRS resource in the SRS resource set may be indicated by the SRI. When several SRS resources in the SRS resource set with a value of the usage in higher layer signaling SRS-ResourceSet set to ‘codebook’ are configured, the UE expects that nrofSRS-Ports in higher layer signaling SRS-Resource is configured to have the same value for all SRS resources.

The UE transmits, to the BS, one or multiple SRS resources included in the SRS resource set with a value of the usage set to ‘codebook’ by higher layer signaling, and the BS selects one of the SRS resources transmitted from the UE and indicates that the UE is allowed to perform PUSCH transmission using transmit beam information of the SRS resource. In this case, for the codebook based PUSCH transmission, the SRI is used as information for selecting an index of the one SRS resource and included in DCI. Additionally, the BS may add information indicating a TPMI and a rank to be used by the UE for PUSCH transmission to the DCI. The UE uses the SRS resource indicated by the SRI to perform PUSCH transmission by applying the precoder indicated by the rank and the TPMI indicated based on the transmit beam of the SRS resource.

Non-codebook based PUSCH transmission may be dynamically scheduled by DCI format 0_0 or 0_1, or quasi-statically operated by the configured grant. When at least one SRS resource in an SRS resource set with a value of the usage in higher layer signaling SRS-ResourceSet set to ‘nonCodebook’ is configured, the UE may be scheduled for non-codebook based PUSCH transmission by DCI format 0_1.

For the SRS resource set with a value of the usage in higher layer signaling SRS-ResourceSet set to ‘nonCodebook’, the UE may be configured with one associated non-zero power CSI-RS (NZP CSI-RS) resource. The UE may perform calculation on a precoder for SRS transmission by measuring the NZP CSI-RS resource associated with the SRS resource set. When a gap between the last reception symbol of an aperiodic NZP CSI-RS resource associated with the SRS resource set and the first symbol of aperiodic SRS transmission from the UE is less than 42 symbols, the UE does not expect updating of information about the precoder for SRS transmission.

When a value of resourceType in higher layer signaling SRS-ResourceSet is set to ‘aperiodic’, an associated NZP CSI-RS is indicated in the field SRS request in DCI format 0_1 or 1_1. In this case, when the associated NZP CSI-RS resource is an aperiodic NZP CSI-RS resource, it indicates that there is an NZP CSI-RS associated for an occasion when the value of the field SRS request in DCI format 0_1 or 1_1 is not ‘00’. In this case, the DCI is prevented from indicating cross carrier or cross BWP scheduling. Furthermore, when the value of the SRS request indicates the presence of an NZP CSI-RS, the NZP CSI-RS is located in a slot in which a PDCCH including the SRS request field is transmitted. In this case, TCI states configured for a scheduled subcarrier are not set to QCL-TypeD.

When a periodic or semi-persistent SRS resource set is configured, an associated NZP CSI-RS may be indicated by associatedCSI-RS in higher layer signaling SRS-ResourceSet. For non-codebook based transmission, the UE does not expect both the higher layer signaling spatialRelationInfo for an SRS resource and associatedCSI-RS in the higher layer signaling SRS-ResourceSet to be configured.

When configured with a plurality of SRS resources, the UE may determine a precoder and a transmission rank to be applied for PUSCH transmission based on the SRI indicated by the BS. In this case, the SRI may be indicated by a field in DCI, SRS resource indicator, or configured by higher layer signaling srs-ResourceIndicator. Similar to the aforementioned codebook based PUSCH transmission, when the UE receives the SRI in DCI, an SRS resource indicated by the SRI refers to an SRS resource corresponding to the SRI among SRS resources transmitted before the PDCCH including the SRI. The UE may use one or more SRS resources for SRS transmission, and the maximum number of SRS resources available for simultaneous transmission in the same symbol in one SRS resource set and the maximum number of SRS resources are determined by UE capability reported by the UE to the BS. In this case, the SRS resources transmitted simultaneously by the UE occupy the same RB. The UE configures one SRS port for each SRS resource. Only one SRS resource set with a value of the usage in the higher layer signaling SRS-ResourceSet set to ‘nonCodebook’ may be configured, and it is possible to configure up to four SRS resources for non-codebook based PUSCH transmission.

The BS transmits one NZP-CSI-RS associated with the SRS resource set to the UE, and the UE calculates a precoder to be used for transmission of one or more SRS resources in the SRS resource set based on a result of measurement during the NZP_CSI-RS reception. The UE may apply the precoder calculated to transmit one or more SRS resources in the SRS resource set with the usage set to ‘nonCodebook’ to the BS, and the BS selects one or more of the received SRS resources. In this case, for the non-codebook based PUSCH transmission, the SRI indicates an index that may represent a combination of one or more SRS resources, and the SRI is included in DCI. The number of SRS resources indicated by the SRI transmitted from the BS may be the number of transmission layers of the PUSCH, and the UE transmits the PUSCH by applying the precoder applied for SRS resource transmission for each layer.

### [PUSCH: Transmission Power]

In an embodiment of the disclosure, when UL data is transmitted on a UL data channel (e.g., PUSCH) in response to a power control command received from the BS, a method by which the UE sets and transmits transmission power of the UL data channel will be described. The UL data channel transmission power of the UE may be determined as in Equation (2) below expressed in the unit of dBm along with a PUSCH power control adjustment state corresponding to i-th transmission unit, parameter set configuration index j and closed-loop index l. In Equation (2), when the UE supports a plurality of carrier frequencies in a plurality of cells, each parameter may be configured for each cell c, carrier frequency f, and BWP b, and may be classified into indexes b, f, and c.

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad ( 2 )$$

In Equation (2):
P_{CMAX,f,c}(i): maximum transmission power available to UE in the i-th transmission unit, which is determined by a power class of the UE, parameters activated by the BS and various parameters built in the UE.
P_{0_PUSCH,b,f,c}(j): is made up of the sum of P_{0_NOMINAL_PUSCH,f,c}(j) and P_{0_UE_PUSCH,b,f,c}(j). P_{0_NOMINAL_PUSCH,f,c}(j) is configured for the UE by cell-specific higher layer signaling, and P_{0_UE_PUSCH,b,f,c}(j) is a value configured by UE-specific higher layer signaling. It refers to a PUSCH for transmitting msg3 when j=0, a configured grant PUSCH when j=1, and a grant PUSCH when j is one of {2, . . . , J−1}.
μ: a subcarrier spacing configuration value
   M_{RB,b,f,c}^{PUSCH}(i): it may refer to an amount of the resource used in the i-th PUSCH transmission unit, i.e., the number of RBs used for PUSCH transmission on the frequency axis.
α_{b,f,c}(j): a value for compensating for a path loss, which refers to a value that may be determined by higher layer configuration and an SRS resource indicator (SRI) (in a case of dynamic grant PUSCH).
PL_{b,f,c}(q_{d}): pathloss representing a path loss between the BS and the UE, and the UE calculates pathloss from a difference between transmission power of an RS resource q_{d} signaled by the BS and a UE reception signal level of the RS. PL_{b,f,c}(q_{d}) refers to a DL path loss estimate that is estimated by the UE through an RS with the RS index q_{d}, and the RS index q_{d} may be determined by the UE through higher layer configuration and an SRI (in a case of ConfiguredGrantConfig based configured grant PUSCH (type 2 configured grant PUSCH) that does not include higher layer configuration rrc-ConfiguredUplinkGrant or a dynamic grant PUSCH) or through higher layer configuration.
   Δ_{TF,b,f,c}(i): refers to a value determined according to a modulation coding scheme (MCS) and a format of information transmitted on the PUSCH (transport format (TF), e.g., whether UL-SCH is included or whether CSI is included)
   f_{b,f,c}(i, l): a closed-loop power control adjustment value, which refers to a value of a closed-loop index l that may be determined by higher layer configuration and an SRI for the PUSCH. The closed-loop power adjustment for PUSCH transmission may be supported by an accumulation method that applies an accumulation of values indicated by the TPC command or an absolute method that applies a value indicated by the TPC command right away, which may be determined depending on whether a higher layer parameter tpc-Accumulation is configured. When the higher layer parameter tpc-Accumulation is set to ‘disabled’, the closed-loop power adjustment for PUSCH transmission is performed in the absolute method, and when tpc-Accumulation is not set, the closed-loop power adjustment for PUSCH transmission is performed in the accumulation method.

The PUSCH power control adjustment state f_{b,f,c}(i, l) may be determined with BWP b, carrier frequency f, cell c, i-th transmission unit or closed-loop index l.
δ_{PUSCH,b,f,c}(i, l): a value indicated in a TPC command field included in DCI format 0_0, 0_1 or 0_2 that schedules the i-th PUSCH transmission unit corresponding to the closed-loop index l, in BWP b, carrier frequency f, and cell c, or a value indicated in a TPC command field included in DCI format 2_2 transmitted along with CRC scrambled by a TPC-PUSCH-RNTI.
   When the UE is configured with higher layer signaling twoPUSCH-PC-AdjustmentStates, the closed-loop index l may have a value of 0 or 1.
   When the UE is not configured with the higher layer signaling twoPUSCH-PC-AdjustmentStates or scheduled for RAR UL grant based PUSCH transmission, the closed-loop index l may have a value of 0.
   When the UE is configured with higher layer signaling ConfiguredGrantConfig and performs associated PUSCH transmission or retransmission, the closed-loop index l may conform to a value of higher layer signaling powerControlLoopToUse.
   When the UE is configured with higher layer signaling SRI-PUSCH-PowerControl, the UE may obtain a connection relationship between a value indicated in the SRS resource indicator (SRI) field in the DCI format scheduled for PUSCH transmission and the closed-loop index l set through higher layer signaling sri-PUSCH-ClosedLoopIndex, and determine the closed-loop index l based on the value indicated in the SRI field in the DCI format based on the connection relationship.
   When the UE is scheduled for PUSCH transmission based on a DCI format that does not include an SRI field or is not configured with the higher layer signaling SRI-PUSCH-PowerControl, the UE may regard the closed-loop index l as 0.
   When the UE receives an indication of a TPC command value through the TPC command field included in the DCI format 2_2 transmitted along with the CRC scrambled by TPC-PUSCH-RNTI, the closed-loop index l may be indicated through a closed-loop index field included in the DCI format 2_2.
when the UE is not configured with higher layer signaling tpc-Accumulation, i.e., when the TPC command accumulation operation is available to the UE, the PUSCH power control adjustment state f_{b,f,c}(i, l) for the i-th PUSCH transmission unit corresponding to the closed-loop index f_{b,f,c}(i, l) for the i-th PUSCH transmission unit corresponding to the closed-loop index l in BWP b, carrier frequency f, and cell c may be calculated as in Equation (3) below:

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad ( 3 )$$

In Equation (3):
δ_{PUSCH,b,f,c}(m, l) is, as described above, in BWP b, carrier frequency f, and cell c, a value indicated in a TPC command field included in DCI format 0_0, 0_1 or 0_2 that schedules the m-th PUSCH transmission unit corresponding to the closed-loop index l, or a value indicated in a TPC command field included in DCI format 2_2 transmitted along with CRC scrambled by a TPC-PUSCH-RNTI. When the TPC command accumulation operation is available, the value of δ_{PUSCH,b,f,c} may have a value in the unit of dB, corresponding to a value indicated by the TPC command field included in DCI format 0_0, 0_1, 0_2 or 2_2 as sin the following Table 13: For example, when the value of the TPC command field is 0, δ_{PUSCH,b,f,c} may have a value of −1 dB.
Σₘ₌₀^{c(D}^{ₗ}⁾⁻¹δ_{PUSCH,b,f,c}(m, l) may refer to a sum of δ_{PUSCH,b,f,c} for all corresponding transmission units in a particular set Dᵢ of the TPC command value. In this case, c(Dᵢ) may refer to the number of all elements belonging to the set Dᵢ. Dᵢ may refer to a set of DCIs that include all TPC command values for performing the TPC command accumulation operation for the i-th PUSCH transmission unit. A start point and an end point in the time domain may be defined to determine Dᵢ, and DCIs received by the UE within the two points may all be included as elements of Dᵢ.

The end point for determining Dᵢ may be K_{PUSCH}(i) symbols before the start symbol of the i-th PUSCH transmission unit.

The start point for determining Dᵢ may be K_{PUSCH}(i-i₀)−1 symbols before the start symbol of the i-i₀-th PUSCH transmission unit. In this case, a positive integer i₀ may be determined to be the smallest value that satisfies a time point K_{PUSCH}(i-i₀) symbols before the start symbol of the i-i₀-th PUSCH transmission unit being earlier than the end point (K_{PUSCH}(i) symbols before the start symbol of the i-th PUSCH transmission unit) to determine Dᵢ.

For example, when the end point to determine Dᵢ may be defined as sym(i), and a point in time K_{PUSCH}(i-i₀) symbols before the start symbol of the i-i₀-th PUSCH transmission unit may be defined as sym(i-i₀), and when sym(i)=sym(i−1)>sym(i−2)>sym(i−3), i₀ may be determined to be 2.

when the UE is configured with higher layer signaling tpc-Accumulation, i.e., when the TPC command accumulation operation is unavailable to the UE, the PUSCH power control adjustment state f_{b,f,c}(i, l) for the i-th PUSCH transmission unit corresponding to the closed-loop index l for the i-th PUSCH transmission unit corresponding to the closed-loop index l in BWP b, carrier frequency f, and cell c may be calculated as in Equation (4) below:

$${f}_{b , f , c} ( i , l ) = {δ}_{PUSCH , b , f , c} ( i , l ) \qquad ( 4 )$$

In Equation (4):
δ_{PUSCH,b,f,c}(i, l) is, as described above, in BWP b, carrier frequency f, and cell c, a value indicated in a TPC command field included in DCI format 0_0, 0_1 or 0_2 that schedules the i-th PUSCH transmission unit corresponding to the closed-loop index l, or a value indicated in a TPC command field included in DCI format 2_2 transmitted along with CRC scrambled by a TPC-PUSCH-RNTI. When the TPC command accumulation operation is unavailable, the value of δ_{PUSCH,b,f,c} may have a value in the unit of dB, which corresponds to a value indicated by the TPC command field included in DCI format 0_0, 0_1, 0_2 or 2_2 as in Table 13 below. For example, when the value of the TPC command field is 0, δ_{PUSCH,b,f,c} may have a value of −4 dB.

TABLE 13

| TPC command | Accumulated δ_{PUSCH, b, f, c} | |
|---|---|---|
| field | [dB] | Absolute δ_{PUSCH, b, f, c}[dB] |
| 0 | −1 | −4 |
| 1 | 0 | −1 |
| 2 | 1 | 1 |
| 3 | 3 | 4 |

### PUSCH: TPMI

When the UE is configured through DCI or higher layer signaling from the BS and scheduled for 1-layer transmission using a single PUSCH antenna port, the TPMI may be defined as W=1, and otherwise, i.e., when the UE is configured through DCI or higher layer signaling from the BS and scheduled for PUSCH of one or more layers using a plurality of PUSCH antenna ports, the TPMI, W may be defined in Tables 14 to 20 below.

TABLE 14

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 14 above represents a 1-layer TPMI when the UE has two PUSCH antenna ports. In Table 14, when the UE has a non-coherent antenna structure and has reported the corresponding UE capability to the BS, the BS may select and indicate one of TPMI indexes 0 and 1 to the UE, and when the UE has a full-coherent antenna structure and has reported the corresponding UE capability to the BS, the BS may select and indicate one of TPMI indexes 0 to 5 to the UE.

TABLE 15

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

Table 15 above represents a 1-layer TPMI when the UE has four PUSCH antenna ports and uses transform precoding (i.e., uses DFTS-OFDM waveforms). In Table 15, when the UE has a non-coherent antenna structure and has reported the corresponding UE capability to the BS, the BS may select and indicate one of TPMI indexes 0 to 3 to the UE; when the UE has a partial-coherent antenna structure and has reported the corresponding UE capability to the BS, the BS may select and indicate one of TPMI indexes 0 to 11 to the UE; when the UE has a full-coherent antenna structure and has reported the corresponding UE capability to the BS, the BS may select and indicate one of TPMI indexes 0 to 27 to the UE.

TABLE 16

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

Table 16 above represents a 1-layer TPMI when the UE has four PUSCH antenna ports and does not use transform precoding (i.e., uses CP-OFDM waveforms). In Table 16, when the UE has a non-coherent antenna structure and has reported the corresponding UE capability to the BS, the BS may select and indicate one of TPMI indexes 0 to 3 to the UE; when the UE has a partial-coherent antenna structure and has reported the corresponding UE capability to the BS, the BS may select and indicate one of TPMI indexes 0 to 11 to the UE; when the UE has a full-coherent antenna structure and has reported the corresponding UE capability to the BS, the BS may select and indicate one of TPMI indexes 0 to 27 to the UE.

TABLE 17

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

Table 17 above represents a 2-layer TPMI when the UE has two PUSCH antenna ports and does not use transform precoding (i.e., uses CP-OFDM waveforms). In Table 17, when the UE has a non-coherent antenna structure and has reported the corresponding UE capability to the BS, the BS may select and indicate TPMI index 0 to the UE, and when the UE has a full-coherent antenna structure and has reported the corresponding UE capability to the BS, the BS may select and indicate one of TPMI indexes 0 to 2 to the UE.

TABLE 18

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

Table 18 above represents a 2-layer TPMI when the UE has four PUSCH antenna ports and does not use transform precoding (i.e., uses CP-OFDM waveforms). In Table 18, when the UE has a non-coherent antenna structure and has reported the corresponding UE capability to the BS, the BS may select and indicate one of TPMI indexes 0 to 5 to the UE; when the UE has a partial-coherent antenna structure and has reported the corresponding UE capability to the BS, the BS may select and indicate one of TPMI indexes 0 to 13 to the UE; when the UE has a full-coherent antenna structure and has reported the corresponding UE capability to the BS, the BS may select and indicate one of TPMI indexes 0 to 21 to the UE

TABLE 19

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Table 19 above represents a 3-layer TPMI when the UE has four PUSCH antenna ports and does not use transform precoding (i.e., uses CP-OFDM waveforms). In Table 19, when the UE has a non-coherent antenna structure and has reported the corresponding UE capability to the BS, the BS may select and indicate TPMI index 0 to the UE; when the UE has a partial-coherent antenna structure and has reported the corresponding UE capability to the BS, the BS may select and indicate one of TPMI indexes 0 to 2 to the UE; when the UE has a full-coherent antenna structure and has reported the corresponding UE capability to the BS, the BS may select and indicate one of TPMI indexes 0 to 6 to the UE.

TABLE 20

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - \text{?}\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - \text{?}\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

$\text{?} \text{indicates text missing or illegible when filed}$

Table 20 above represents a 4-layer TPMI when the UE has four PUSCH antenna ports and does not use transform precoding (i.e., uses CP-OFDM waveforms). In Table 20, when the UE has a non-coherent antenna structure and has reported the corresponding UE capability to the BS, the BS may select and indicate TPMI index 0 to the UE; when the UE has a partial-coherent antenna structure and has reported the corresponding UE capability to the BS, the BS may select and indicate one of TPMI indexes 0 to 2 to the UE; when the UE has a full-coherent antenna structure and has reported the corresponding UE capability to the BS, the BS may select and indicate one of TPMI indexes 0 to 4 to the UE.

### SRS

The BS may configure the UE with at least one SRS configuration for each UL BWP to send configuration information for SRS transmission, and at least one SRS resource set for each SRS configuration. For example, the BS and the UE may exchange the following higher layer signaling information to send information about the SRS resource set.

srs-ResourceSetId: SRS resource set index

srs-ResourceIdList: a set of SRS resource indexes referred to from the SRS resource set

resourceType: time domain transmission configuration of an SRS resource referred to from the SRS resource set, which may be set to one of ‘periodic’, ‘semi-persistent’, and ‘aperiodic’. When it is configured to be ‘periodic’ or ‘semi-persistent’, associated CSI-RS information may be provided depending on the usage of the SRS resource set. When it is configured to be ‘aperiodic’, an aperiodic SRS resource trigger list and slot offset information may be provided and associated CSI-RS information may be provided depending on the usage of the SRS resource set.

usage: a configuration of usage of an SRS resource referred to from the SRS resource set, which may be set to one of ‘beamManagement’, ‘codebook’, ‘nonCodebook’, and ‘antennaSwitching’.

alpha, p0, pathlossReferenceRS, srs-PowerControlAdjustmentStates: provides a parameter configuration for transmission power control of an SRS resource referred to from the SRS resource set.

The UE may interpret that an SRS resource included in a set of SRS resource indexes referred to from the SRS resource set follows information configured for the SRS resource set.

The BS and the UE may transmit or receive higher layer signaling information for delivering individual configuration information for an SRS resource. For example, the individual configuration information for the SRS resource may include time-frequency domain mapping information in a slot of the SRS resource, which may include information about intra-slot or inter-slot frequency hopping of the SRS resource. The individual configuration information for the SRS resource may include a time domain transmission configuration of the SRS resource, which may be set to one of ‘periodic’, ‘semi-persistent’, and ‘aperiodic’. This may be limited to having the same time domain transmission configuration as the SRS resource set to which the SRS resource belongs. When the time domain transmission configuration of the SRS resource is set to ‘periodic’ or ‘semi-persistent’, additional SRS resource transmission periodicity and slot offset (e.g., periodicityAndOffset) may be included in the time domain transmission configuration.

The BS may activate or deactivate or trigger SRS transmission to the UE through higher layer signaling including RRC signaling or MAC-CE signaling, or L1 signaling (e.g., DCI). For example, the BS may activate or deactivate periodic SRS transmission to the UE through higher layer signaling. The BS may indicate activation of an SRS resource set with resourceType set to ‘periodic’ through higher layer signaling, and the UE may transmit an SRS resource referred to from the activated SRS resource set. Time-frequency domain resource mapping of the SRS resource to be transmitted in a slot follows resource mapping information configured for the SRS resource, and slot mapping including transmission periodicity and slot offset follows periodicityAndOffset configured for the SRS resource. Furthermore, a spatial domain transmission filter applied to the SRS resource for transmission may refer to spatial relation info configured for the SRS resource or associated CSI-RS information configured for the SRS resource set to which the SRS resource belongs. The UE may transmit the SRS resource in a UL BWP activated for the periodic SRS resource activated by higher layer signaling.

For example, the BS may activate or deactivate semi-persistent SRS transmission to the UE through higher layer signaling. The BS may indicate activation of an SRS resource set through MAC-CE signaling, and the UE may transmit an SRS resource referred to from the activated SRS resource set. The SRS resource set activated through MAC-CE signaling may be limited to an SRS resource set with the resourceType set to ‘semi-persistent’. Intra-slot time-frequency domain resource mapping of the SRS resource for transmission follows resource mapping information configured for the SRS resource, and slot mapping including transmission periodicity and slot offset follows periodicityAndOffset configured for the SRS resource. Furthermore, a spatial domain transmission filter applied to the SRS resource for transmission may refer to spatial relation info configured for the SRS resource or associated CSI-RS information configured for the SRS resource set to which the SRS resource belongs. When spatial relation info is configured for the SRS resource, the spatial domain transmission filter may not follow the spatial relation info but may be determined by referring to configuration information about spatial relation info delivered through MAC-CE signaling that activates semi-persistent SRS transmission. The UE may transmit the SRS resource in a UL BWP activated for the semi-persistent SRS resource activated by higher layer signaling.

For example, the BS may trigger aperiodic SRS transmission to the UE through DCI. The BS may indicate one of aperiodic SRS resource triggers (aperiodicSRS-ResourceTrigger) in an SRS request field of the DCI. The UE may interpret that an SRS resource set including the aperiodic SRS resource triggers indicated by the DCI in the aperiodic SRS resource trigger list among configuration information of the SRS resource set has been triggered. The UE may transmit an SRS resource referred to from the triggered SRS resource set. Intra-slot time-frequency domain resource mapping of the SRS resource for transmission follows resource mapping information configured for the SRS resource. Furthermore, slot mapping of the SRS resource for transmission may be determined by a slot offset between a PDCCH including the DCI and the SRS resource, which may refer to a value (or values) included in a slot offset set configured for the SRS resource set. Specifically, for the slot offset between the PDCCH including the DCI and the SRS resource, a value indicated in a time domain resource assignment field of the DCI among offset value(s) included in the slot offset set configured for the SRS resource set may be applied. Furthermore, a spatial domain transmission filter applied to the SRS resource for transmission may refer to spatial relation info configured for the SRS resource or associated CSI-RS information configured for the SRS resource set to which the SRS resource belongs. The UE may transmit the SRS resource in a UL BWP activated for the aperiodic SRS resource triggered by the DCI.

When the BS triggers aperiodic SRS transmission for the UE by DCI, a minimum time interval between a PDCCH including the DCI that triggers the aperiodic SRS transmission and an SRS to be transmitted may be required for the UE to transmit the SRS by applying configuration information for the SRS resource. The time interval for SRS transmission of the UE may be defined with the number of symbols between the last symbol of the PDCCH including the DCI that triggers the aperiodic SRS transmission and the first symbol to which an SRS resource to be first transmitted among SRS resource(s) is mapped. The minimum time interval may be determined by referring to a PUSCH preparation procedure time required for the UE to prepare for PUSCH transmission. The minimum time interval may have a different value depending on the usage of the SRS resource set including the SRS resource to be transmitted. For example, the minimum time interval may be determined to be N2 symbols defined by referring to a PUSCH preparation procedure time and considering a UE processing capability based on the UE capability. Moreover, in consideration of the usage of the SRS resource set including the SRS resource to be transmitted, the minimum time interval may be determined to have N2 symbols when the usage of the SRS resource set is set to ‘codebook’ or ‘antennaSwitching’, and the minimum time interval may be determined to have N2+14 symbols when the usage of the SRS resource set is set to ‘nonCodebook’ or ‘beamManagement’. The UE may transmit an aperiodic SRS when the time interval for aperiodic SRS transmission is equal to or greater than the minimum time interval, and may ignore the DCI that triggers the aperiodic SRS when the time interval for aperiodic SRS transmission is less than the minimum time interval.

TABLE 21

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

Configuration information of spatialRelationInfo in Table 21 above refers to one RS and apply beam information of the RS to a beam used for the SRS transmission. For example, the configuration of spatialRelationInfo may include information as in Table 22 below.

TABLE 22

| SRS-SpatialRelationInfo ::= | SEQUENCE { | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SSB index, a CSI-RS index or an SRS index may be set as an index of an RS to be referred to so as to use beam information of a particular RS. Higher layer signaling referenceSignal is configuration information indicating whether to refer to beam information of an RS for the SRS transmission, ssb-index refers to an index of an SSB, csi-RS-index refers to an index of a CSI-RS, and srs refers to an index of an SRS. When a value of the higher layer signaling referenceSignal is set to ‘ssb-Index’, the UE may apply a receive beam that has been used to receive an SSB corresponding to the ssb-index for a transmit beam for corresponding SRS transmission. When a value of the higher layer signaling referenceSignal is set to ‘csi-RS-Index’, the UE may apply a receive beam that has been used to receive a CSI-RS corresponding to the csi-RS-index for a transmit beam for corresponding SRS transmission. When a value of the higher layer signaling referenceSignal is set to ‘srs’, the UE may apply a transmit beam that has been used to transmit an SRS corresponding to the srs for a transmit beam for corresponding SRS transmission.

### SRS: Antenna Switching

An SRS transmitted from the UE may be used to obtain DL channel state information (CSI) (e.g., for DL SCI acquisition) in the BS. Specifically, for example, in a time division duplex (TDD) based single cell or multi-cell (e.g., CA) situation, the BS may measure an SRS transmitted from the UE after scheduling the UE for SRS transmission. In this case, the BS may take UL channel information estimated based on the SRS transmitted from the UE as DL channel information on the assumption of reciprocity between DL/UL channels, and using this, perform DL signal/channel scheduling for the UE. In this case, the UE may be configured by the BS with antenna switching for the usage of an SRS for DL channel information acquisition.

For example, in conformity with a standard (e.g., 3gpp TS38.214), the usage of the SRS may be configured for the BS and/or the UE by using a higher layer parameter (e.g., the usage of RRC parameter SRS-ResourceSet). The usage of the SRS may be set to a beam management usage, a codebook transmission usage, a non-codebook transmission usage, an antenna switching usage, etc.

As described above, when the UE is configured by the BS with ‘antennaSwitching’ for the usage, a parameter in higher layer signaling SRS-ResourceSet, the UE may receive at least one higher layer signaling configuration from the BS according to the reported UE capability. In this case the UE may report ‘supportedSRS-TxPortSwitch’ in the UE capability, and the value may be as follows. ‘mTnR’ may refer to a UE capability that supports transmission through m antennas and reception through n antennas.
‘t1r2’: a UE capability report value meaning that 1T2R operation is enabled for the UE
‘t1r1-t1r2’: a UE capability report value meaning that 1T1R operation or 1T2R operation is enabled for the UE
‘t2r4’: a UE capability report value meaning that 2T4R operation is enabled for the UE
‘t1r4’: a UE capability report value meaning that 1T4R operation is enabled for the UE
‘t1r6’: a UE capability report value meaning that 1T6R operation is enabled for the UE
‘t1r8’: a UE capability report value meaning that 1T8R operation is enabled for the UE
‘t2r6’: a UE capability report value meaning that 2T6R operation is enabled for the UE
‘t2r8’: a UE capability report value meaning that 2T8R operation is enabled for the UE
‘t4r8’: a UE capability report value meaning that 4T8R operation is enabled for the UE
‘t1r1-t1r2-t1r4’: a UE capability report value meaning that 1T1R, 1T2R or 1T4R operation is enabled for the UE
‘t1r4-t2r4’: a UE capability report value meaning that 1T4R operation or 2T4R operation is enabled for the UE
‘t1 r1-t1 r2-t2r2-t2r4’: a UE capability report value meaning that 1T1 R, 1T2R, 2T2R or 2T4R operation is enabled for the UE
‘t1 r1-t1 r2-t2r2-t1 r4-t2r4’: a UE capability report value meaning that 1T1R, 1T2R, 2T2R, 1T4R or 2T4R operation is enabled for the UE
‘t1r1’: a UE capability report value meaning that 1T1R operation is enabled for the UE
‘t2r2’: a UE capability report value meaning that 2T2R operation is enabled for the UE
‘t1r1-t2r2’: a UE capability report value meaning that 1T1R operation or 2T2R operation is enabled for the UE
‘t4r4’: a UE capability report value meaning that 4T4R operation is enabled for the UE
‘t1r1-t2r2-t4r4’: a UE capability report value meaning that 1T1R, 2T2R or 4T4R operation is enabled for the UE

### [SRS Transmission Power]

In an embodiment of the disclosure, when transmitting is performed through a UL RS (e.g., SRS) in response to a power control command received from the BS, a method by which the UE sets and transmits transmission power of the UL RS will be described. The UL RS transmission power P_{SRS} of the UE may be determined as in Equation (5) below expressed in the unit of dBm along with an SRS power control adjustment state corresponding to i-th transmission unit and closed-loop index l. In Equation (5), when the UE supports a plurality of carrier frequencies in a plurality of cells, each parameter may be determined for each cell c, carrier frequency f, and BWP b, and may be classified into indexes b, f, and c.

$${P}_{SRS , b , f , c} ( i , {q}_{s} , l ) = min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ] \qquad ( 5 )$$

In Equation (5):
P_{CMAX,f,c}(i): maximum transmission power available to UE in the i-th transmission unit, which is determined by a power class of the UE, parameters activated by the BS and various parameters built in the UE.
P_{0_SRS,b,f,c}(q_{z}): set as higher layer signaling p0 for BWP b, carrier frequency f and cell c, and SRS resource set qₛ may be configured through higher layer signaling SRS-ResourceSet and SRS-ResourceSetId.
μ: a subcarrier spacing configuration value
M_{SRS,b,f,c}(i): it may refer to an amount of the resource used in the i-th SRS transmission unit, i.e., the number of RBs used for SRS transmission on the frequency axis.
α_{SRS,b,f,c}(j): set as higher layer signaling alpha for BWP b, carrier frequency f and cell c, and SRS resource set qₛ may be configured through higher layer signaling SRS-ResourceSet and SRS-ResourceSetId.
PL_{b,f,c}(q_{d}): pathloss representing a path loss between the BS and the UE, and the UE calculates pathloss from a difference between transmission power of an RS resource q_{d} signaled by the BS and a UE reception signal level of the RS.
h_{b,f,c}(i, l): it may refer to an SRS power control adjustment state value for the i-th SRS transmission unit corresponding to the closed-loop index l in BWP b, carrier frequency f and cell c.

The SRS power control adjustment state may be determined with BWP b, carrier frequency f, cell c, and i-th transmission unit.
when the UE is configured to have the same power control adjustment state value between SRS transmission and PUSCH transmission through higher layer signaling srs-PowerControlAdjustmentStates, the SRS power control adjustment state may be expressed as in Equation (6) below, and f_{b,f,c}(i,l) may refer to a current PUSCH power control adjustment state. In this case, f_{b,f,c}(i,l) may be calculated in various methods of the aforementioned embodiment 1, and the value may be used by being put into h_{b,f,c}(i, l).

$${h}_{b , f , c} ( i , l ) = {f}_{b , f , c} ( i , l ) \qquad ( 6 )$$

In Equation (6):
when the UE is not configured for PUSCH transmission in BWP b, carrier frequency f and cell c or is configured to have separate power control adjustment state values between SRS transmission and PUSCH transmission through higher layer signaling srs-PowerControlAdjustmentStates, and higher layer signaling tpc-Accumulation is not configured, the SRS power control adjustment state may be represented regardless of the closed-loop l as in Equation (7) below:

$${h}_{b , f , c} ( i ) = {h}_{b , f , c} ( i - {i}_{0} ) + {\sum }_{m = 0}^{c ( {S}_{i} ) - 1} {δ}_{S R S , b , f , c} ( m ) \qquad ( 7 )$$

In Equation (7):
δ_{SRS,b,f,c}(m): it may be a value indicated in a TPC command field included in DCI format 2_3, which may conform to Table 17.
   Σₘ₌₀^{c(S}^{ᵢ}⁾⁻¹δ_{SRS,b,f,c}(m) may refer to a sum of δ_{SRS,b,f,c} for all corresponding transmission units in a particular set Sᵢ of the TPC command value. In this case, c(Sᵢ), may refer to the number of all elements belonging to the set Sᵢ. Sᵢ may refer to a set of DCIs that include all TPC command values to perform the TPC command accumulation operation for the i-th PUSCH transmission unit. A start point and an end point in the time resource may be defined to determine Sᵢ, and DCIs received by the UE within the two points may all be included as elements of Sᵢ.
   The end point to determine Sᵢ may be K_{SRS}(i) symbols before the start symbol of the i-th SRS transmission unit.
   The start point for determining Sᵢ may be K_{SRS}(i-i₀)−1 symbols before the start symbol of the (i-i₀)-th SRS transmission unit. In this case, a positive integer i₀ may be determined to be the smallest value that satisfies a time point K_{SRS}(i-i₀) symbols before the start symbol of the (i-i₀)-th SRS transmission unit being earlier than the end point (K_{SRS}(i) symbols before the start symbol of the i-th SRS transmission unit) to determine Sᵢ.
   For example, when the end point to determine Sᵢ may be defined as sym(i), and the time point K_{SRS}(i-i₀) symbols before the start symbol of the (i-i₀)-th SRS transmission unit may be defined as sym(i-i₀), and when sym(i)=sym(i−1)>sym(i−2)>sym(i−3), i₀ may be determined to be 2.
   when the UE is not configured for PUSCH transmission in BWP b, carrier frequency f and cell c or is configured to have separate power control adjustment state values between SRS transmission and PUSCH transmission through higher layer signaling srs-PowerControlAdjustmentStates and higher layer signaling tpc-Accumulation is configured (i.e., when the TPC command accumulation operation is not performed but an absolute TPC command value may be applied), the SRS power control adjustment state may be represented regardless of the closed-loop l as in Equation (8) below:

$${h}_{b , f , c} ( i ) = {δ}_{S R S , b , f , c} ( i ) \qquad ( 8 )$$

In Equation (8):
δ_{SRS,b,f,c}(i) may be a value indicated in a TPC command field included in DCformat 2_3 in BWP b, carrier frequency f and cell c, which may follow Table 13. For example, when the value of the TPC command field is 0, δ_{SRS,b,f,c} may have a value of −4 dB.

### SRS Comb Offset/Cyclic Shift Configuration Method

The UE may be configured with an SRS resource through higher layer signaling SRS-Resource or SRS-PosResource from the BS, and may include the following items:
the UE may be configured with the number of antenna ports for each SRS resource in SRS-Resource, and the value may be defined to be Nₛₚ^{SRS}∈{1,2,4,8}, which may be configured through higher layer signaling nrofSRS-Ports or nrofSRS-Ports-n8. When higher layer signaling ‘usage’ in SRS-ResourceSet is set to a value other than nonCodebook, pᵢ=1000+i may refer to a number of i-th antenna port, and i may be an integer from 0 to Nₛₚ^{SRS}−1. When the higher layer signaling ‘usage’ in SRS-ResourceSet is set to nonCodebook, each SRS resource may be configured with Nₛₚ^{SRS}=1 antenna ports, and the antenna port of the (i+1)-th SRS resource in SRS-ResourceSet may be defined to be pᵢ=1000+i. In SRS-PosResource, it may be defined to be Nₛₚ^{SRS}=1.
the UE may be configured with the number of successive symbols in which the SRS is transmitted through nrofSymbols in higher layer signaling resourceMapping from the BS, and the value may be defined to be N_{symb}^{SRS}∈{1,2,4,8,10,12,14},
the UE may be configured with a position of the start symbol in which the SRS is transmitted in one slot through startPosition in the higher layer signaling resourceMapping from the BS, and the value may be defined to be l₀=N_{symb}^{slot}−1−l_{offset}. In this case, N_{symb}^{slot} may refer to the number of symbols in the slot, and the value may be 14 for normal cyclic prefix and 12 for extended cyclic refix. l_{offset}∈{0,1, . . . , 13} may refer to an offset value that counts the number of symbols backward from a symbol located at the end of the slot. This may satisfy l_{offset}≥N_{symb}^{SRS}−1.
k₀ may refer to a start position of the frequency resource in which the SRS is transmitted.

An SRS sequence that may be generated in an SRS resource defined based on the information may be defined as in Equation (9) below:

$${r}^{( {p}_{i} )} ( n , {l}^{′} ) = {w}_{T D M}^{( {p}_{i} )} ( {l}^{′} ) {r}_{u , v}^{( {a}_{i} , δ )} ( n ) \qquad ( 9 )$$

$$0 \leq n \leq {M}_{sc , b}^{S R S} - 1$$

$${l}^{′} ∈ \{ 0 , 1 , … , {N}_{s y m b}^{S R S} - 1 \}$$

In Equation (9),

$${M}_{sc , b}^{S R S} = \frac{{m}_{SRS , b} {N}_{sc}^{R B}}{{K}_{T C} {P}_{F}}$$

refers to the length of the SRS sequence. m_{SRS,b} may be determined through Table 24 below and may be determined through higher layer signaling b-SRS and c-SRS. In this case, when b-SRS is configured, it may be determined to be a value of B_{SRS}∈{0,1,2,3} in Table 24 below, the value of the subscript b of m_{SRS,b} may be determined with B_{SRS}, and B_{SRS}=0 when b-SRS is not configured. c-SRS may be determined to be a value of C_{SRS}∈{0,1, . . . , 63} in Table 24 below. P_{P}∈{2,4} may be determined through higher layer signaling FreqScalingFactor, and when the parameter is not configured, P_{P}=1. When the higher layer signaling FreqScalingFactor is configured, the length of the SRS sequence may be expected to be a multiple of six.

δ=log₂(K_{TC}) may be determined, and K_{TC}∈{2,4,8} may determine the size of the comb. In this case, the size of the comb may refer to a gap between REs in which the SRS is transmitted on the frequency domain, and for example, when the size of the comb is K_{TC}=2, it may indicate that the gap between REs in which the SRS is transmitted is 2 REs. The UE may be configured with the size of the comb through higher layer signaling transmissionComb. i′∈{0, 1, . . . , N_{symb}^{SRS}−1} may refer to a symbol index in symbols in which the SRS resource is transmitted. The UE may determine the largest cyclic shift value n_{SRS}^{cs,max} depending on the value of K_{TC} as in Table 23 below.

TABLE 23

| K_{TC} | n_{SRS}^{cs, max} |
|---|---|
| 2 | 8 |
| 4 | 12 |
| 8 | 6 |

r_{u,v}^{(α}^{ᵢ}^{,δ)}(n) may be defined as follows based on a that refers to the cyclic shift of the i-th antenna port and the basic sequence r̅_{u,v}(n).

$${r}_{u , v}^{( {α}_{i} , δ )} ( n ) = {e}^{j {a}_{i} n} {\overline{r}}_{u , v} ( n ) , 0 \leq n < {M}_{Z C}$$

In this case, M_{ZC}=mN_{sc}^{RB}/2^{δ} may refer to the length of the SRS sequence. A plurality of SRS sequences may be generated according to different values of αᵢ and δ for a basic sequence.

The plurality of basic sequences may be divided into groups, and the index of the group may be defined to be u∈{0, 1, . . . , 29}, and v may refer to an index of the basic sequence in the group. When ½≤m/2^{δ}≤5, each group may include one basic sequence, where v=0. When 6≤m/2^{δ}, each group may include two basic sequences, where v=0, 1. The definition of r̅_{u,v}(n) may be different depending on the value of M_{ZC}, which is the length of the sequence.

When the length of the basic sequence is 36 or more, i.e., M_{ZC}≥3N_{sc}^{RB}, the basic sequence r̅_{u,v}(n) may be defined as follows: In this case, N_{ZC} may be the largest prime number less than M_{ZC}.

$${\overline{r}}_{u , v} ( n ) = {x}_{q} ( n mod {N}_{Z C} )$$

$${x}_{q} ( m ) = {e}^{- j \frac{π q m ( m + 1 )}{{N}_{ZC}}}$$

$$q = ⌊ \overline{q} + 1 / 2 ⌋ + v \cdot {( - 1 )}^{⌊ 2 \overline{q} ⌋}$$

$$\overline{q} = {N}_{ZC} \cdot ( u + 1 ) / 31$$

When the length of the basic sequence is 6, 12, 18 or 24, i.e., M_{ZC}∈{6,12,18,24}, the basic sequence r̅_{u,v}(n) may be defined as follows:

$${\overline{r}}_{u , v} ( n ) = {e}^{j φ ( n ) π / 4} , 0 \leq n \leq {M}_{Z C} - 1$$

In this case, the value of φ(n) may be defined through Tables 25 to 28.

When the length of the basic sequence is 30, i.e., M_{ZC}=30, the basic sequence r̅_{u,v}(n) may be defined as follows:

$${\overline{r}}_{u , v} ( n ) = {e}^{- j \frac{π ( u + 1 ) ( n + 1 ) ( n + 2 )}{31}} , 0 \leq n \leq {M}_{Z C} - 1$$

When the UE is configured with higher layer signaling nrofSRS-Ports-n8 as ports8tdm, w_{TDM}^{(p}^{ᵢ}⁾(l′) may be defined as follows, and otherwise, defined to be w_{TDM}^{(p}^{ᵢ}⁾(l′)=1.
when l′∈{0, 2, . . . , N_{symb}^{SRS}−2} and pᵢ∈{1000,1001,1004,1005}, w_{TDM}^{(p}^{ᵢ}⁾(l′)=1 may be defined.
when l′∈{1, 3, . . . , N_{symb}^{SRS}−1} and pᵢ∈{1002,1003,1006,1007}, w_{TDM}^{(p}^{ᵢ}⁾(l′)=1 may be defined.
otherwise, w_{TDM}^{(p}^{ᵢ}⁾(l′)=0 may be defined.
αᵢ referring to cyclic shift corresponding to the antenna port pᵢ may be defined as follows:
αᵢ

$${α}_{i} = 2 π \frac{{n}_{S R S}^{cs , i}}{{n}_{S R S}^{cs , i}}$$

In this case, n_{SRS}^{cs,i} may be defined as follows:
when N̅ₐₚ^{SRS}=8 and n_{SRS}^{cs,max}=6,

$${n}_{S R S}^{cs , i} = ( {n}_{S R S}^{c s} + \frac{{n}_{S R S}^{cs , max} ⌊ ( {\overline{p}}_{i} - 10 \; 00 ) / 4 ⌋}{{\overline{N}}_{a p}^{S R S} / 4} )$$

mod n_{SRS}^{cs,max} may be defined.
when N̅ₐₚ^{SRS}=4 and n_{SRS}^{cs,max}=6, or N̅ₐₚ^{SRS}=8 and n_{SRS}^{cs,max}=12,

$${n}_{SRS}^{cs , i} = ( {n}_{SRS}^{cs} + \frac{{n}_{SRS}^{cs , max} ⌊ ( {\overline{p}}_{i} - 1000 ) / 2 ⌋}{{\overline{N}}_{ap}^{SRS} / 2} )$$

mod n_{SRS}^{cs,max} may be defined.
otherwise,

$${n}_{SRS}^{cs , i} = ( {n}_{SRS}^{cs} + \frac{{n}_{SRS}^{cs , max} ( {\overline{p}}_{i} - 1000 )}{{\overline{N}}_{ap}^{SRS}} )$$

mod n_{SRS}^{cs,max} may be defined.

In this case, n_{SRS}^{cs}∈{0, 1, . . . , n_{SRS}^{cs,max}−1} is a parameter to determine a cyclic shift value, which may be configured through cyclicShift-n2, cyclicShift-n4, or cyclicShift-n8 in higher layer signaling transmissionComb, and n_{SRS}^{cs,max} may be determined through Table 23.

N̅ₐₚ^{SRS} and p̅ᵢ may be determined as follows:
when higher layer signaling nrofSRS-Ports-n8 is configured as ports8tdm, N̅ₐₚ^{SRS}=4 may be defined, and as for p̅ᵢ, when pᵢ−1000<4, p̅ᵢ=1000+pᵢ mod 2 may be defined, and when pᵢ−1000≥4, p̅ᵢ=1000+pᵢ mod 2+2 may be defined. Specifically, when the UE transmits an SRS resource made up of eight antenna ports in the TDM scheme, for each of the antenna ports pᵢ=1000, 1001, 1004 and 1005 to be transmitted in the first symbol, p̅ᵢ=1000, 1001, 1002 and 1003 is defined and for each of the antenna ports pᵢ=1002, 1003, 1006 and 1007 to be transmitted in the second symbol, p̅ᵢ=1000, 1001, 1002 and 1003 is defined, so that the resource allocation scheme for the SRS resource made up of the four antenna ports may be applied as is to allocate a resource to four different antenna ports to be transmitted in each symbol.
otherwise, i.e., when the higher layer signaling nrofSRS-Ports-n8 is not configured as ports8tdm, N̅ₐₚ^{SRS}=Nₐₚ^{SRS} and p̅ᵢ=pᵢ may be defined.
↑k₀^{(p}^{ᵢ}⁾ referring to a start position in the frequency domain of the SRS corresponding to the i-th antenna port may be defined as follows:

$${k}_{0}^{( {p}_{i} )} = {\overline{k}}_{0}^{( {p}_{i} )} + {n}_{offset}^{FH} + {n}_{offset}^{RPFS}$$

In this case, k̅₀^{(p}^{ᵢ}⁾ may be defined as follows:

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} )$$

In this case, k_{TC}^{(p}^{ᵢ}⁾ may be defined as follows:
when N̅ₐₚ^{SRS}=8, p̅ᵢ∈{1003,1007} and n_{SRS}^{cs,max}=6, k_{TC}^{(p}^{ᵢ}⁾=(k̅_{TC}+3K_{TC}/4)mod K_{TC} may be defined.
when N̅ₐₚ^{SRS}=8, p̅ᵢ∈{1002,1006} and n_{SRS}^{cs,max}=6, k_{TC}^{(p}^{ᵢ}⁾=(k̅_{TC}+K_{TC}/2)mod K_{TC} may be defined.
when N̅ₐₚ^{SRS}=8, p̅ᵢ∈{1001,1005} and n_{SRS}^{cs,max}=6, k_{TC}^{(p}^{ᵢ}⁾=(k̅_{TC}+K_{TC}/4)mod K_{TC} may be defined.
when N̅ₐₚ^{SRS}=8, p̅ᵢ∈{1001,1003,1005,1007} and n_{SRS}^{cs,max}=12, k_{TC}^{(p}^{ᵢ}⁾=(k̅_{TC}+K_{TC}/2)mod K_{TC} may be defined.
when −N̅ₐₚ^{SRS}=8, p̅ᵢ∈{1001,1003,1005,1007}, n_{SRS}^{cs,max}=8 and n_{SRS}^{cs}≥n_{SRS}^{cs,max}/2, k_{TC}^{(p}^{ᵢ}⁾=(k̅_{TC}+K_{TC}/2)mod K_{TC} may be defined.
when N̅ₐₚ^{SRS}=4, p̅ᵢ∈{1001,1003} and n_{SRS}^{cs,max}=6,
   k_{TC}^{(p}^{ᵢ}⁾=(k̅_{TC}+K_{TC}/2)mod K_{TC} may be defined.
when −N̅ₐₚ^{SRS}=4, p̅ᵢ∈{1001,1003}, n_{SRS}^{cs,max}∈{8,12} and n_{SRS}^{cs}≥n_{SRS}^{cs,max}/2, k_{TC}^{(p}^{ᵢ}⁾=(k̅_{TC}+K_{TC}/2)mod K_{TC} may be defined.
otherwise, k_{TC}^{(p}^{ᵢ}⁾=k̅_{TC} may be defined.

In this case, n_{offset}^{FH} may be defined as follows:

$${n}_{offset}^{FH} = {\sum }_{b = 0}^{{B}_{SRS}} {m}_{SRS , b} {N}_{sc}^{RB} {n}_{b}$$

In this case, n_{offset}^{RPFS} may be defined as follows:

$${n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

k_{P}∈{0, 1, . . . , P_{P}−1} may be configured by higher layer signaling StartRBIndex, and when it is not configured, k_{F}=0 may be defined.

kₕₒₚ may be determined through Table 29 below based on the following k̅ₕₒₚ and N_{b}_{ₕₒₚ} values when higher layer signaling EnableStartRBHopping is configured, and otherwise, kₕₒₚ=0 may be defined.

$${\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F} , {N}_{{b}_{hop}} = 1$$

When SRS transmission is performed based on SRS-PosResource, k_{offset}^{l′} may be defined based on Table 30 below, and otherwise (i.e., when the SRS transmission is performed based on SRS-Resource), k_{offset}^{l′}=0 may be defined.

An offset value n_{shift} on the frequency domain is a value to determine how much the position is shifted from a reference position on the frequency domain to transmit the SRS, and may be configured through higher layer signaling freqDomainShift. k̅_{TC}∈{0, 1, . . . , K_{TC}−1} indicating a comb offset value may be configured through combOffset-n2, combOffset-n4, or combOffset-n8 in higher layer signaling transmissionComb.

As higher layer signaling related to frequency hopping of the SRS, b-hop in freqHoping may be configured, and defined to be bₕₒₚ∈{0,1,2,3}.

n_{b} is a value indicating an index of a frequency position, which may be defined as follows:
when bₕₒₚ≥B_{SRS}, frequency hopping of the SRS may not be supported, and n_{b} indicating an index of the frequency position may have a constant value during all n_{b} symbols, which may be defined as follows:

$${n}_{b} = ⌊ 4 {n}_{RRC} / {m}_{SRS , b} ⌋ mod {N}_{b}$$

In this case, n_{RRC} is a value configured through higher layer signaling freqDomainPosition, and when not configured, the value may be 0.
when bₕₒₚ<B_{SRS}, frequency hopping of the SRS is supported, and n_{b} may be defined as follows:
When b≤bₕₒₚ, n_{b}=└4n_{RRC}/m_{SRS,b}┘ mod N_{b} may be defined.

Otherwise,

$${n}_{b} = {F}_{b} ( {n}_{SRS} ) + ⌊ \frac{4 {n}_{RRC}}{{m}_{SRS , b}} ⌋$$

mod N_{b} may be defined. In this case, F_{b}(n_{SRS}) may be defined to be

$${F}_{b} ( {n}_{SRS} ) = ( \frac{{N}_{b}}{2} ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋$$

when N_{b} is an even number, and may be defined to be

$${F}_{b} ( {n}_{SRS} ) = ⌊ \frac{{N}_{b}}{2} ⌋ ⌊ \frac{{n}_{SRS}}{{\prod }_{{b}^{′} = {b}_{hop}}^{b - 1} {N}_{{b}^{′}}} ⌋$$

when N_{b} is an odd number. N_{b}_{ₕₒₚ} may be defined to be 1 regardless of the value of N_{b}.

n_{SRS} may be defined as a parameter to count the number of SRS transmission times. When the UE transmits aperiodic SRS resources, n_{SRS}=└l′/(sR)┘ may be defined in N_{symb}^{SRS} symbols in a certain slot. In this case, when the higher layer signaling nrofSRS-Ports-n8 is configured as ports8tdm, s may be defined to be s=2, and otherwise, defined to be s=1. In this case, R≤N_{symb}^{SRS}/2 may be a value configured with higher layer signaling repetitionFactor, or when not configured, defined to be R=N_{symb}^{SRS}.

When the UE transmits periodic or semi-persistent SRS resources, in slots that satisfy (Nₛₗₒₜ^{frame,μ}n_{f}+n_{s,f}^{μ}−T_{offset})mod T_{SRS}=0, n_{SRS} may be defined as follows:

$${n}_{SRS} = ( \frac{{N}_{slot}^{frame , μ} {n}_{f} + {n}_{s , f}^{μ} - {T}_{offset}}{{T}_{SRS}} ) ( \frac{{N}_{symb}^{SRS}}{sR} ) + ⌊ \frac{{l}^{′}}{s R} ⌋$$

In this case, T_{SRS} and T_{offset} may refer to periodicity of the periodic or semi-persistent SRS and the slot offset, respectively.

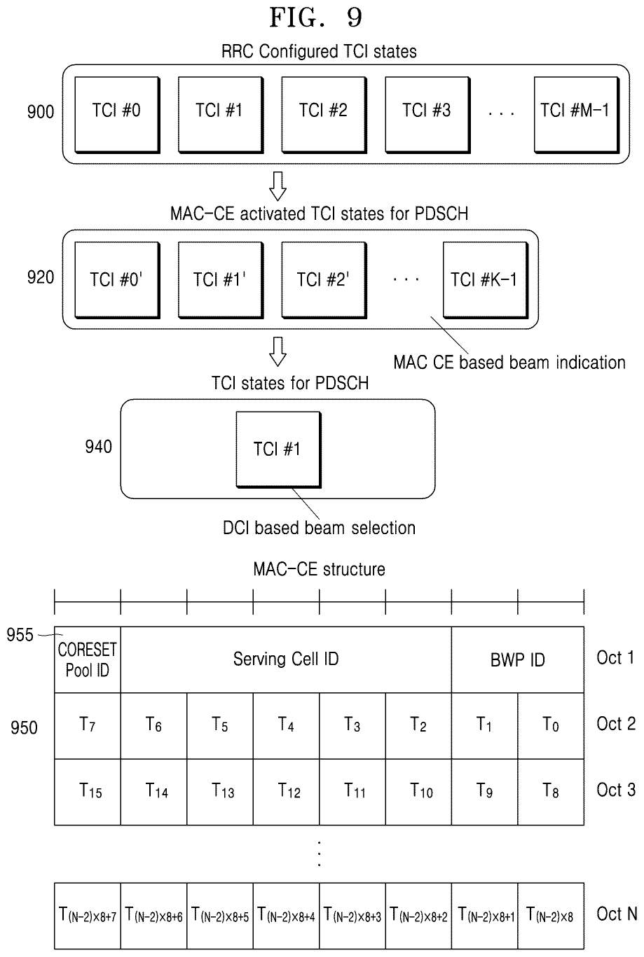

FIG. 9 illustrates a procedure for beam configuration and activation for a physical data shared channel (PDSCH) according to an embodiment.

Referring to FIG. 9, the UE may be configured with a plurality of (e.g., M) TCI states through RRC configuration in 900, and may be configured with K of the plurality of configured TCI states through an MAC-CE in 920. Furthermore, at least one of K TCI state(s) may be set in DCI in 940. As described above, a series of configuration processes from higher layer configuration to MAC-CE configuration may be applied to a beamforming indication or beamforming switching command for at least one PDSCH at one TRP. A PDSCH TCI state activation/deactivation MAC-CE that may be applied to the multi-DCI based multi-TRP transmission method may follow what is shown in FIG. 9. When the UE is not configured with CORESETPoolIndex for each of all CORESETs in higher layer signaling PDCCH-Config, the UE may ignore a CORESET Pool ID field 955 in a corresponding MAC-CE 950. When the UE may support the multi-DCI based multi-TRP transmission method, i.e., UE is configured with a different CORESETPoolIndex for each CORESET in higher layer signaling PDCCH-Config, the UE may activate a TCI state in DCI included in the PDCCH transmitted in the CORESETs having the same value of CORESETPoolIndex as the value of the CORESET pool ID field 955 in the MAC-CE 950. For example, when the CORESET Pool ID field 955 in the MAC-CE 950 has a value of ‘0’, a TCI state in DCI included in the PDCCH transmitted in CORESETs having CORESETPoolIndex of ‘0’ may follow activation information of the MAC-CE.

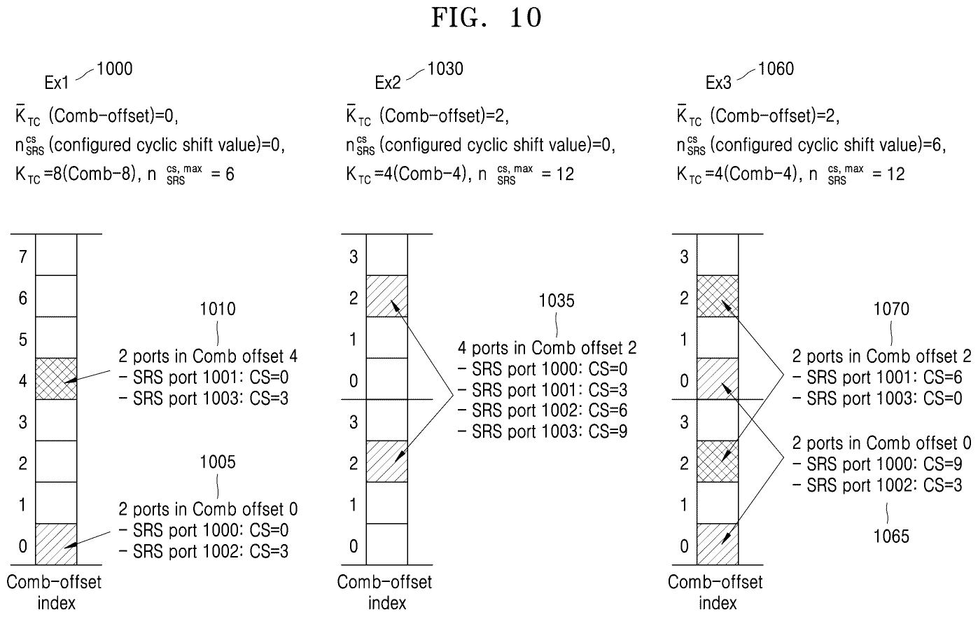

FIG. 10 illustrates a comb offset and cyclic shift allocation method in SRS transmission, according to an embodiment.

Referring to FIG. 10, in example 1 (1000), it may be assumed that the UE is configured with k̅_{TC}=0 (comb offset value), n_{SRS}^{cs}=0 (cyclic shift value), K_{TC}=8 (comb size value) and n_{SRS}^{cs,max}=6 (maximum cyclic shift value) for an SRS resource made up of four antenna ports. In this case, the UE may define cyclic shift values allocated for p̅ᵢ=1000 and 1002 to be n_{SRS}^{cs,0}=0 and n_{SRS}^{cs,2}=3, respectively, and define comb offset values for p̅ᵢ=1000 and 1002 to be k_{TC}^{(p}^{ᵢ}⁾=0, in 1005. The UE may define cyclic shift values allocated for p̅ᵢ=1001 and 1003 to be n_{SRS}^{cs,1}=0 and n_{SRS}^{cs,3}=3, respectively, and define comb offset values for p̅ᵢ=1001 and 1003 to be k_{TC}^{(p}^{ᵢ}⁾=4, in 1010. Hence, two of four antenna ports may be allocated to the same comb offset, and to separate the two antenna ports in the same comb offset, the gap between the cyclic shift values corresponding to the two antenna ports may be determined to be

$$\frac{{n}_{SRS}^{cs , max}}{2} = 3$$

to be maximum.

In example 2 (1030), it may be assumed that the UE is configured with k̅_{TC}=2 (comb offset value), n_{SRS}^{cs}=0 (cyclic shift value), K_{TC}=4 (comb size value) and n_{SRS}^{cs,max}=12 (maximum cyclic shift value) for an SRS resource made up of four antenna ports. In this case, the UE may define cyclic shift values allocated for p̅ᵢ=1000, 1001, 1002 and 1003 to be n_{SRS}^{cs,0}=0, n_{SRS}^{cs,1}=3, n_{SRS}^{cs,2}=6 and n_{SRS}^{cs,3}=9, respectively, and define comb offset values for p̅ᵢ=1000, 1001, 1002 and 1003 to be k_{TC}^{(p}^{ᵢ}⁾=2, in 1035. Hence, all the four antenna ports may be allocated to the same comb offset, and to separate the four antenna ports in the same comb offset, the gap between the cyclic shift values corresponding to the four antenna ports may be determined to be

$$\frac{{n}_{SRS}^{cs , max}}{4} = 3$$

to be maximum.

In example 3 (1060), it may be assumed that the UE is configured with k̅_{TC}=2 (comb offset value), n_{SRS}^{cs}=6 (cyclic shift value), K_{TC}=4 (comb size value) and n_{SRS}^{cs,max}=12 (maximum cyclic shift value) for an SRS resource made up of four antenna ports. In this case, the UE may define cyclic shift values allocated for p̅ᵢ=1000 and 1002 to be n_{SRS}^{cs,0}=9 and n_{SRS}^{cs,0}=3, respectively, and define comb offset values for p̅ᵢ=1000 and 1002 to be k_{TC}^{(p}^{ᵢ}⁾=0, in 1065. The UE may define cyclic shift values allocated for p̅ᵢ=1001 and 1003 to be n_{SRS}^{cs,i}=6 and n_{SRS}^{cs,3}=0, respectively, and define comb offset values for p̅ᵢ=1001 and 1003 to be k_{TC}^{(p}^{ᵢ}⁾=2, in 1070. Hence, two of four antenna ports may be allocated to the same comb offset, and to separate the two antenna ports in the same comb offset, the gap between the cyclic shift values corresponding to the two antenna ports may be determined to be

$$\frac{{n}_{SRS}^{cs , max}}{2} = 6$$

to be maximum.

TABLE 24

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

TABLE 25

| | |
|---|---|
| u | φ(0), . . . , φ(5) |

| | | | | | | |
|---|---|---|---|---|---|---|
| 0 | −3 | −1 | 3 | 3 | −1 | −3 |
| 1 | −3 | 3 | −1 | −1 | 3 | −3 |
| 2 | −3 | −3 | −3 | 3 | 1 | −3 |
| 3 | 1 | 1 | 1 | 3 | −1 | −3 |
| 4 | 1 | 1 | 1 | −3 | −1 | 3 |
| 5 | −3 | 1 | −1 | −3 | −3 | −3 |
| 6 | −3 | 1 | 3 | −3 | −3 | −3 |
| 7 | −3 | −1 | 1 | −3 | 1 | −1 |
| 8 | −3 | −1 | −3 | 1 | −3 | −3 |
| 9 | −3 | −3 | 1 | −3 | 3 | −3 |
| 10 | −3 | 1 | 3 | 1 | −3 | −3 |
| 11 | −3 | −1 | −3 | 1 | 1 | −3 |
| 12 | 1 | 1 | 3 | −1 | −3 | 3 |
| 13 | 1 | 1 | 3 | 3 | −1 | 3 |
| 14 | 1 | 1 | 1 | −3 | 3 | −1 |
| 15 | 1 | 1 | 1 | −1 | 3 | −3 |
| 16 | −3 | −1 | −1 | −1 | 3 | −1 |
| 17 | −3 | −3 | −1 | 1 | −1 | −3 |
| 18 | −3 | −3 | −3 | 1 | −3 | −1 |
| 19 | −3 | 1 | 1 | −3 | −1 | −3 |
| 20 | −3 | 3 | −3 | 1 | 1 | −3 |
| 21 | −3 | 1 | −3 | −3 | −3 | −1 |
| 22 | 1 | 1 | −3 | 3 | 1 | 3 |
| 23 | 1 | 1 | −3 | −3 | 1 | −3 |
| 24 | 1 | 1 | 3 | −1 | 3 | 3 |
| 25 | 1 | 1 | −3 | 1 | 3 | 3 |
| 26 | 1 | 1 | −1 | −1 | 3 | −1 |
| 27 | 1 | 1 | −1 | 3 | −1 | −1 |
| 28 | 1 | 1 | −1 | 3 | −3 | −1 |
| 29 | 1 | 1 | −3 | 1 | −1 | −1 |

TABLE 26

| u | φ(0), . . . , φ(11) | | | | | | | | | | | |
|---|---|---|---|---|---|---|---|---|---|---|---|---|
| 0 | −3 | 1 | −3 | −3 | −3 | 3 | −3 | −1 | 1 | 1 | 1 | −3 |
| 1 | −3 | 3 | 1 | −3 | 1 | 3 | −1 | −1 | 1 | 3 | 3 | 3 |
| 2 | −3 | 3 | 3 | 1 | −3 | 3 | −1 | 1 | 3 | −3 | 3 | −3 |
| 3 | −3 | −3 | −1 | 3 | 3 | 3 | −3 | 3 | −3 | 1 | −1 | −3 |
| 4 | −3 | −1 | −1 | 1 | 3 | 1 | 1 | −1 | 1 | −1 | −3 | 1 |
| 5 | −3 | −3 | 3 | 1 | −3 | −3 | −3 | −1 | 3 | −1 | 1 | 3 |
| 6 | 1 | −1 | 3 | −1 | −1 | −1 | −3 | −1 | 1 | 1 | 1 | −3 |
| 7 | −1 | −3 | 3 | −1 | −3 | −3 | −3 | −1 | 1 | −1 | 1 | −3 |
| 8 | −3 | −1 | 3 | 1 | −3 | −1 | −3 | 3 | 1 | 3 | 3 | 1 |
| 9 | −3 | −1 | −1 | −3 | −3 | −1 | −3 | 3 | 1 | 3 | −1 | −3 |
| 10 | −3 | 3 | −3 | 3 | 3 | −3 | −1 | −1 | 3 | 3 | 1 | −3 |
| 11 | −3 | −1 | −3 | −1 | −1 | −3 | 3 | 3 | −1 | −1 | 1 | −3 |
| 12 | −3 | −1 | 3 | −3 | −3 | −1 | −3 | 1 | −1 | −3 | 3 | 3 |
| 13 | −3 | 1 | −1 | −1 | 3 | 3 | −3 | −1 | −1 | −3 | −1 | −3 |
| 14 | 1 | 3 | −3 | 1 | 3 | 3 | 3 | 1 | −1 | 1 | −1 | 3 |
| 15 | −3 | 1 | 3 | −1 | −1 | −3 | −3 | −1 | −1 | 3 | 1 | −3 |
| 16 | −1 | −1 | −1 | −1 | 1 | −3 | −1 | 3 | 3 | −1 | −3 | 1 |
| 17 | −1 | 1 | 1 | −1 | 1 | 3 | 3 | −1 | −1 | −3 | 1 | −3 |
| 18 | −3 | 1 | 3 | 3 | −1 | −1 | −3 | 3 | 3 | −3 | 3 | −3 |
| 19 | −3 | −3 | 3 | −3 | −1 | 3 | 3 | 3 | −1 | −3 | 1 | −3 |
| 20 | 3 | 1 | 3 | 1 | 3 | −3 | −1 | 1 | 3 | 1 | −1 | −3 |
| 21 | −3 | 3 | 1 | 3 | −3 | 1 | 1 | 1 | 1 | 3 | −3 | 3 |
| 22 | −3 | 3 | 3 | 3 | −1 | −3 | −3 | −1 | −3 | 1 | 3 | −3 |
| 23 | 3 | −1 | −3 | 3 | −3 | −1 | 3 | 3 | 3 | −3 | −1 | −3 |
| 24 | −3 | −1 | 1 | −3 | 1 | 3 | 3 | 3 | −1 | −3 | 3 | 3 |
| 25 | −3 | 3 | 1 | −1 | 3 | 3 | −3 | 1 | −1 | 1 | −1 | 1 |
| 26 | −1 | 1 | 3 | −3 | 1 | −1 | 1 | −1 | −1 | −3 | 1 | −1 |
| 27 | −3 | −3 | 3 | 3 | 3 | −3 | −1 | 1 | −3 | 3 | 1 | −3 |
| 28 | 1 | −1 | 3 | 1 | 1 | −1 | −1 | −1 | 1 | 3 | −3 | 1 |
| 29 | −3 | 3 | −3 | 3 | −3 | −3 | 3 | −1 | −1 | 1 | 3 | −3 |

TABLE 27

| u | φ(0), . . . , φ(17) | | | | | | | | | | | | | | | | | |
|---|---|---|---|---|---|---|---|---|---|---|---|---|---|---|---|---|---|---|
| 0 | −1 | 3 | −1 | −3 | 3 | 1 | −3 | −1 | 3 | −3 | −1 | −1 | 1 | 1 | 1 | −1 | −1 | −1 |
| 1 | 3 | −3 | 3 | −1 | 1 | 3 | −3 | −1 | −3 | −3 | −1 | −3 | 3 | 1 | −1 | 3 | −3 | 3 |
| 2 | −3 | 3 | 1 | −1 | −1 | 3 | −3 | −1 | 1 | 1 | 1 | 1 | 1 | −1 | 3 | −1 | −3 | −1 |
| 3 | −3 | −3 | 3 | 3 | 3 | 1 | −3 | 1 | 3 | 3 | 1 | −3 | −3 | 3 | −1 | −3 | −1 | 1 |
| 4 | 1 | 1 | −1 | −1 | −3 | −1 | 1 | −3 | −3 | −3 | 1 | −3 | −1 | −1 | 1 | −1 | 3 | 1 |
| 5 | 3 | −3 | 1 | 1 | 3 | −1 | 1 | −1 | −1 | −3 | 1 | 1 | −1 | 3 | 3 | −3 | 3 | −1 |
| 6 | −3 | 3 | −1 | 1 | 3 | 1 | −3 | −1 | 1 | 1 | −3 | 1 | 3 | 3 | −1 | −3 | −3 | −3 |
| 7 | 1 | 1 | −3 | 3 | 3 | 1 | 3 | −3 | 3 | −1 | 1 | 1 | −1 | 1 | −3 | −3 | −1 | 3 |
| 8 | −3 | 1 | −3 | −3 | 1 | −3 | −3 | 3 | 1 | −3 | −1 | −3 | −3 | −3 | −1 | 1 | 1 | 3 |
| 9 | 3 | −1 | 3 | 1 | −3 | −3 | −1 | 1 | −3 | −3 | 3 | 3 | 3 | 1 | 3 | −3 | 3 | −3 |
| 10 | −3 | −3 | −3 | 1 | −3 | 3 | 1 | 1 | 3 | −3 | −3 | 1 | 3 | −1 | 3 | −3 | −3 | 3 |
| 11 | −3 | −3 | 3 | 3 | 3 | −1 | −1 | −3 | −1 | −1 | −1 | 3 | 1 | −3 | −3 | −1 | 3 | −1 |
| 12 | −3 | −1 | −3 | −3 | 1 | 1 | −1 | −3 | −1 | −3 | −1 | −1 | 3 | 3 | −1 | 3 | 1 | 3 |
| 13 | 1 | 1 | −3 | −3 | −3 | −3 | 1 | 3 | −3 | 3 | 3 | 1 | −3 | −1 | 3 | −1 | −3 | 1 |
| 14 | −3 | 3 | −1 | −3 | −1 | −3 | 1 | 1 | −3 | −3 | −1 | −1 | 3 | −3 | 1 | 3 | 1 | 1 |
| 15 | 3 | 1 | −3 | 1 | −3 | 3 | 3 | −1 | −3 | −3 | −1 | −3 | −3 | 3 | −3 | −1 | 1 | 3 |
| 16 | −3 | −1 | −3 | −1 | −3 | 1 | 3 | −3 | −1 | 3 | 3 | 3 | 1 | −1 | −3 | 3 | −1 | −3 |
| 17 | −3 | −1 | 3 | 3 | −1 | 3 | −1 | −3 | −1 | 1 | −1 | −3 | −1 | −1 | −1 | 3 | 3 | 1 |
| 18 | −3 | 1 | −3 | −1 | −1 | 3 | 1 | −3 | −3 | −3 | −1 | −3 | −3 | 1 | 1 | 1 | −1 | −1 |
| 19 | 3 | 3 | 3 | −3 | −1 | −3 | −1 | 3 | −1 | 1 | −1 | −3 | 1 | −3 | −3 | −1 | 3 | 3 |
| 20 | −3 | 1 | 1 | −3 | 1 | 1 | 3 | −3 | −1 | −3 | −1 | 3 | −3 | 3 | −1 | −1 | −1 | −3 |
| 21 | 1 | −3 | −1 | −3 | 3 | 3 | −1 | −3 | 1 | −3 | −3 | −1 | −3 | −1 | 1 | 3 | 3 | 3 |
| 22 | −3 | −3 | 1 | −1 | −1 | 1 | 1 | −3 | −1 | 3 | 3 | 3 | 3 | −1 | 3 | 1 | 3 | 1 |
| 23 | 3 | −1 | −3 | 1 | −3 | −3 | −3 | 3 | 3 | −1 | 1 | −3 | −1 | 3 | 1 | 1 | 3 | 3 |
| 24 | 3 | −1 | −1 | 1 | −3 | −1 | −3 | −1 | −3 | −3 | −1 | −3 | 1 | 1 | 1 | −3 | −3 | 3 |
| 25 | −3 | −3 | 1 | −3 | 3 | 3 | 3 | −1 | 3 | 1 | 1 | −3 | −3 | −3 | 3 | −3 | −1 | −1 |
| 26 | −3 | −1 | −1 | −3 | 1 | −3 | 3 | −1 | −1 | −3 | 3 | 3 | −3 | −1 | 3 | −1 | −1 | −1 |
| 27 | −3 | −3 | 3 | 3 | −3 | 1 | 3 | −1 | −3 | 1 | −1 | −3 | 3 | −3 | −1 | −1 | −1 | 3 |
| 28 | −1 | −3 | 1 | −3 | −3 | −3 | 1 | 1 | 3 | 3 | −3 | 3 | 3 | −3 | −1 | 3 | −3 | 1 |
| 29 | −3 | 3 | 1 | −1 | −1 | −1 | −1 | 1 | −1 | 3 | 3 | −3 | −1 | 1 | 3 | −1 | 3 | −1 |

TABLE 28

| u | φ(0), . . . , φ(23) | | | | | | | | | | | | | | | | | | | | | | | |
|---|---|---|---|---|---|---|---|---|---|---|---|---|---|---|---|---|---|---|---|---|---|---|---|---|
| 0 | −1 | −3 | 3 | −1 | 3 | 1 | 3 | −1 | 1 | −3 | −1 | −3 | −1 | 1 | 3 | −3 | −1 | −3 | 3 | 3 | 3 | −3 | −3 | −3 |
| 1 | −1 | −3 | 3 | 1 | 1 | −3 | 1 | −3 | −3 | 1 | −3 | −1 | −1 | 3 | −3 | 3 | 3 | 3 | −3 | 1 | 3 | 3 | −3 | −3 |
| 2 | −1 | −3 | −3 | 1 | −1 | −1 | −3 | 1 | 3 | −1 | −3 | −1 | −1 | −3 | 1 | 1 | 3 | 1 | −3 | −1 | −1 | 3 | −3 | −3 |
| 3 | 1 | −3 | 3 | −1 | −3 | −1 | 3 | 3 | 1 | −1 | 1 | 1 | 3 | −3 | −1 | −3 | −3 | −3 | −1 | 3 | −3 | −1 | −3 | −3 |
| 4 | −1 | 3 | −3 | −3 | −1 | 3 | −1 | −1 | 1 | 3 | 1 | 3 | −1 | −1 | −3 | 1 | 3 | 1 | −1 | −3 | 1 | −1 | −3 | −3 |
| 5 | −3 | −1 | 1 | −3 | −3 | 1 | 1 | −3 | 3 | −1 | −1 | −3 | 1 | 3 | 1 | −1 | −3 | −1 | −3 | 1 | −3 | −3 | −3 | −3 |
| 6 | −3 | 3 | 1 | 3 | −1 | 1 | −3 | 1 | −3 | 1 | −1 | −3 | −1 | −3 | −3 | −3 | −3 | −1 | −1 | −1 | 1 | 1 | −3 | −3 |
| 7 | −3 | 1 | 3 | −1 | 1 | −1 | 3 | −3 | 3 | −1 | −3 | −1 | −3 | 3 | −1 | −1 | −1 | −3 | −1 | −1 | −3 | 3 | 3 | −3 |
| 8 | −3 | 1 | −3 | 3 | −1 | −1 | −1 | −3 | 3 | 1 | −1 | −3 | −1 | 1 | 3 | −1 | 1 | −1 | 1 | −3 | −3 | −3 | −3 | −3 |
| 9 | 1 | 1 | −1 | −3 | −1 | 1 | 1 | −3 | 1 | −1 | 1 | −3 | 3 | −3 | −3 | 3 | −1 | −3 | 1 | 3 | −3 | 1 | −3 | −3 |
| 10 | −3 | −3 | −3 | −1 | 3 | −3 | 3 | 1 | 3 | 1 | −3 | −1 | −1 | −3 | 1 | 1 | 3 | 1 | −1 | −3 | 3 | 1 | 3 | −3 |
| 11 | −3 | 3 | −1 | 3 | 1 | −1 | −1 | −1 | 3 | 3 | 1 | 1 | 1 | 3 | 3 | 1 | −3 | −3 | −1 | 1 | −3 | 1 | 3 | −3 |
| 12 | 3 | −3 | 3 | −1 | −3 | 1 | 3 | 1 | −1 | −1 | −3 | −1 | 3 | −3 | 3 | −1 | −1 | 3 | 3 | −3 | −3 | 3 | −3 | −3 |
| 13 | −3 | 3 | −1 | 3 | −1 | 3 | 3 | 1 | 1 | −3 | 1 | 3 | −3 | 3 | −3 | −3 | −1 | 1 | 3 | −3 | −1 | −1 | −3 | −3 |
| 14 | −3 | 1 | −3 | −1 | −1 | 3 | 1 | 3 | −3 | 1 | −1 | 3 | 3 | −1 | −3 | 3 | −3 | −1 | −1 | −3 | −3 | −3 | 3 | −3 |
| 15 | −3 | −1 | −1 | −3 | 1 | −3 | −3 | −1 | −1 | 3 | −1 | 1 | −1 | 3 | 1 | −3 | −1 | 3 | 1 | 1 | −1 | −1 | −3 | −3 |
| 16 | −3 | −3 | 1 | −1 | 3 | 3 | −3 | −1 | 1 | −1 | −1 | 1 | 1 | −1 | −1 | 3 | −3 | 1 | −3 | 1 | −1 | −1 | −1 | −3 |
| 17 | 3 | −1 | 3 | −1 | 1 | −3 | 1 | 1 | −3 | −3 | 3 | −3 | −1 | −1 | −1 | −1 | −1 | −3 | −3 | −1 | 1 | 1 | −3 | −3 |
| 18 | −3 | 1 | −3 | 1 | −3 | −3 | 1 | −3 | 1 | −3 | −3 | −3 | −3 | −3 | 1 | −3 | −3 | 1 | 1 | −3 | 1 | 1 | −3 | −3 |
| 19 | −3 | −3 | 3 | 3 | 1 | −1 | −1 | −1 | 1 | −3 | −1 | 1 | −1 | 3 | −3 | −1 | −3 | −1 | −1 | 1 | −3 | 3 | −1 | −3 |
| 20 | −3 | −3 | −1 | −1 | −1 | −3 | 1 | −1 | −3 | −1 | 3 | −3 | 1 | −3 | 3 | −3 | 3 | 3 | 1 | −1 | 1 | −1 | −3 | −3 |
| 21 | 3 | −1 | 1 | −1 | 3 | −3 | 1 | 1 | 3 | −1 | −3 | 3 | 1 | −3 | 3 | −1 | −1 | −1 | −1 | 1 | −3 | −3 | −3 | −3 |
| 22 | −3 | 1 | −3 | 3 | −3 | 1 | −3 | 3 | 1 | −1 | −3 | −1 | −3 | −3 | −3 | −3 | 1 | 3 | −1 | 1 | 3 | 3 | 3 | −3 |
| 23 | −3 | −1 | 1 | −3 | −1 | −1 | 1 | 1 | 1 | 3 | 3 | −1 | 1 | −1 | 1 | −1 | −1 | −3 | −3 | −3 | 3 | 1 | −1 | −3 |
| 24 | −3 | 3 | −1 | −3 | −1 | −1 | −1 | 3 | −1 | −1 | 3 | −3 | −1 | 3 | −3 | 3 | −3 | −1 | 3 | 1 | 1 | −1 | −3 | −3 |
| 25 | −3 | 1 | −1 | −3 | −3 | −1 | 1 | −3 | −1 | −3 | 1 | 1 | −1 | 1 | 1 | 3 | 3 | 3 | −1 | 1 | −1 | 1 | −1 | −3 |
| 26 | −1 | 3 | −1 | −1 | 3 | 3 | −1 | −1 | −1 | 3 | −1 | −3 | 1 | 3 | 1 | 1 | −3 | −3 | −3 | −1 | −3 | −1 | −3 | −3 |
| 27 | 3 | −3 | −3 | −1 | 3 | 3 | −3 | −1 | 3 | 1 | 1 | 1 | 3 | −1 | 3 | 3 | −1 | 3 | −1 | 3 | 1 | −1 | −3 | −3 |
| 28 | −3 | 1 | −3 | 1 | −3 | 1 | 1 | 3 | 1 | −3 | −3 | −1 | 1 | 3 | −1 | −3 | 3 | 1 | −1 | −3 | −3 | −3 | −3 | −3 |
| 29 | 3 | −3 | −1 | 1 | 3 | −1 | −1 | −3 | −1 | 3 | −1 | −3 | −1 | −3 | 3 | −1 | 3 | 1 | 1 | −3 | 3 | −3 | −3 | −3 |

TABLE 29

| | kₕₒₚ | | |
|---|---|---|---|
| k̅ₕₒₚ | P_{F} = 1 | P_{F} = 2 | P_{F} = 4 |
| 0 | 0 | 0 | 0 |
| 1 | | 1 | 2 |
| 2 | | | 1 |
| 3 | | | 3 |

TABLE 30

| K_{TC} | ${k}_{offset}^{0} , ... , {k}_{offset}^{{N}_{symb}^{SRS} - 1}$ | | | | |
|---|---|---|---|---|---|
| | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | | |
| 4 | | 0, 2 | 0, 2, 1, 3 | 0, 2, 1, 3, 0, 2, 1, 3 | 0, 2 ,1, 3, 0, 2, 1, 3, 0, 2, 1, 3 |
| 8 | | | 0, 4, 2, 6 | 0, 4, 2, 6, 1, 5, 3, 7 | 0, 4, 2, 6, 1, 5, 3, 7, 0, 4, 2, 6 |

### UE Capability Report

In LTE and NR, the UE may perform a procedure for reporting a capability supported by the UE to a serving BS while connected to the serving BS. This will now be called UE capability report.

The BS may send the UE connected to the BS a UE capability inquiry message requesting a capability report. The message may include a UE capability request for each radio access technology (RAT) type of the BS. The request for each RAT type may include e.g., supported frequency band combination information. In the UE capability inquiry message, UE capability for each of the plurality of RAT types may be requested through an RRC message container transmitted by the BS, or the BS may send the UE capability inquiry message including UE capability request for each RAT type several times. In other words, the UE capability inquiry is repeated several times in a message, and the UE may form a corresponding UE capability information message and report it several times. In the next generation mobile communication system, a UE capability request for multi-RAT DC (MR-DC) as well as NR, LTE, E-UTRA-NR DC (EN-DC) may be made. It is common to initially transmit the UE capability inquiry message after the UE is connected to the BS, but the UE capability inquiry may be requested whenever needed by the BS in any condition.

Upon receiving a request to report the UE capability from the BS in the previous operation, the UE configures a UE capability according to an RAT type and band information requested from the BS. How the UE configures a UE capability in an NR system is summarized as follows:
1. When the UE receives an LTE and/or NR band list in the request for UE capability from the BS, the UE may configure a band combination (BC) for EN-DC and NR stand-alone (SA). Specifically, a candidate BC list for the EN-DC and NR SA based on the frequency bands requested from the BS in FreqBandList is compiled. Priorities of the bands may be set as listed in FreqBandList.
2. When the BS requests a UE capability report by setting a flag “eutra-nr-only” or “eutra”, the UE completely removes what are related to NR SA BCs from the configured candidate BC list. This may happen when an LTE eNB requests an “eutra” capability.
3. Subsequently, the UE discards fallback BCs from the candidate BC list compiled in the above operation. The fallback BC refers to a BC that may be obtained by removing a band corresponding to at least one SCell from an arbitrary BC, and may be omitted because the BC before removing the band corresponding to the at least one SCell may already cover the fallback BC. This operation is also applied in MR-DC, i.e., even to LTE bands. BCs left after this operation is a final “candidate BC list”.
4. The UE selects BCs to be reported by selecting BCs that suit a requested RAT type from among the final “candidate BC list”. In this operation, the UE configures supportedBandCombinationList in a set order. Specifically, the UE may configure BCs and UE capability to be reported in order of preset RAT types. (nr->eutra-nr->eutra). The UE may configure featureSetCombination for the configured supportedBandCombinationList and configure a “candidate feature set combination” list from the candidate BC list from which a list of the fallback BCs (including equal or low-level capability) is removed. The “candidate feature set combinations” include all feature set combinations for NR and EUTRA-NR BCs and may be obtained from feature set combinations of UE-NR-Capabilities and UE-MRDC-Capabilities containers.
5. When the requested RAT type is eutra-nr and has an influence, featureSetCombinations are all be included in both the UE-MRDC-Capabilities and UE-NR-Capabilities containers. However, NR feature sets are included in UE-NR-Capabilities only.

After the UE capability is configured, the UE sends a UE capability information message including the UE capability to the BS. The BS then performs scheduling and transmission/reception management suitable for the UE based on the UE capability received from the UE.

### Non-Coherent Joint Transmission (NC-JT)

NC-JT may be used for the UE to receive a PDSCH from multiple transmission and reception points (TRPs).

Unlike the existing communication system, 5G wireless communication systems may support not only services requiring higher transmission speed but also both services having very short latency and services requiring a higher connection density. In a wireless communication network including multiple cells, TRPs, or beams, cooperative communication between the respective cells, TRPs and/or beams may satisfy various service requirements by increasing intensity of a signal received by the UE or efficiently performing interference control between the respective cells, TRPs and/or beams.

Joint transmission (JT) is a representative transmission technology for the aforementioned cooperative communication, which transmits a signal to one UE through many different cells, TRPs or/and beams to increase strength or throughput of the signal received by the UE. In this case, the respective channels between the cells, TRPs and/or beams and the UE may differ significantly, and especially for NC JT that supports non-coherent precoding between the cells, the TRPs and/or the beams, individual precoding, MCS, resource allocation, TCI indication, etc., may be required according to a channel property for each link between the cells, the TRPs and/or the beams.

The NC-JT transmission may be applied to at least one of the PDSCH, the PDCCH, the PUSCH or the PUCCH. Transmission information in PDSCH transmission, such as precoding, an MCS, resource allocation, TCI, etc., is indicated by DL DCI, and for NC-JT transmission, the transmission information needs to be separately indicated for each cell, TRP and/or beam. This may mainly cause an increase in payload required for DL DCI transmission, which may lead to having an adverse effect on reception performance for a PDCCH that transmits the DCI. Hence, to support JT of the PDSCH, a tradeoff between an amount of DCI information and control information reception performance needs to be carefully designed.

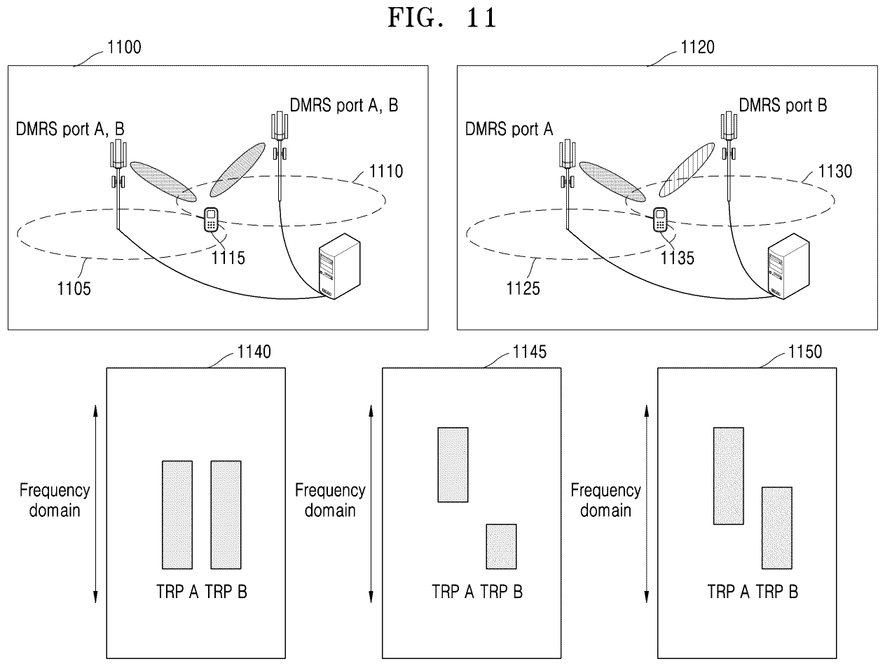

FIG. 11 illustrates antenna port configuration and resource allocation for PDSCH transmission using cooperative communication in a wireless communication system, according to an embodiment.

Referring to FIG. 11, an illustration of PDSCH transmission in each JT scheme will be described and examples for allocating radio resources for each TRP are shown.

Coherent JT (C-JT) that supports coherent precoding between respective cells, TRPs and/or beams is illustrated in 1100.

For C-JT, TRP A 1105 and TRP B 1110 transmit a single PDSCH to a UE 1115, and joint precoding may be performed in the multiple TRPs. This indicates that a DMRS is transmitted through the same DMRS ports for TRP A 1105 and TRP B 1110 to transmit the same PDSCH. For example, TRP A 1105 and TRP B 1110 may transmit a DMRS to the UE 1115 through DMRS port A and DMRS B, respectively. In this case, the UE 1115 may receive a piece of DCI information to receive a PDSCH demodulated based on the DMRS transmitted through the DMRS port A and DMRS B.

In FIG. 11, NC-JT that supports non-coherent precoding between the respective cells, TRPs and/or beams for PDSCH transmission is illustrated in 1120.

In NC-JT, a PDSCH may be transmitted to a UE 1135 for each cell, TRP 1125, 1130 and/or beam, and individual precoding may be applied to each PDSCH. Each cell, TRP 1125, 1130 and/or beam transmits a different PDSCH or a different PDSCH layer to the UE, thereby increasing throughput as compared to singe cell, TRP and/or beam transmission. Furthermore, each cell, TRP 1125, 1130 and/or beam repetitively transmits the same PDSCH to the UE, thereby increasing reliability as compared to singe cell, TRP and/or beam transmission. For convenience of explanation, a cell, TRP and/or beam will be referred to as a TRP.

In this case, various radio resource allocations such as an occasion when frequency and time resources used at the multiple TRPs for PDSCH transmission are the same in 1140, an occasion when frequency and time resources used at the multiple TRPs do not overlap each other at all in 1145, and an occasion when some of the frequency and time resources used at the multiple TRPs overlap each other in 1150 may be considered.

To simultaneously allocate multiple PDSCHs to a UE to support NC-JT, various forms, structures and relations of DCIs may be considered.

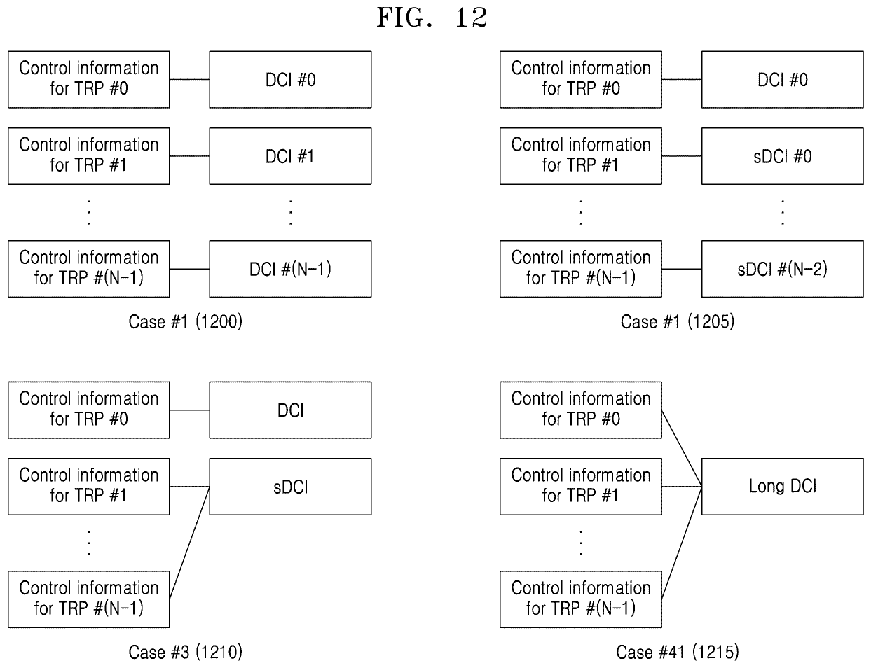

FIG. 12 illustrates an example of a configuration of DCI for NC-JT where each TRP transmits a different PDSCH or a different PDSCH layer to the UE in a wireless communication system, according to an embodiment.

Referring to FIG. 12, case #1 1200 shows when N−1 different PDSCHs are transmitted from additional N−1 TRPs, TRP #1 to TRP #(N−1) in addition to a serving TRP, TRP #0, used in single PDSCH transmission, in which case control information for the PDSCHs transmitted from the additional N−1 TRPs is transmitted separately from control information for the PDSCH transmitted from the serving TRP. Specifically, the UE may obtain the control information for the PDSCHs transmitted from different TRPs, TRP #0 to TRP #(N−1), through separate DCIs, DCI #0 to DCI #(N−1). Formats of the separate DCIs may be the same or different, and payloads of the DCIs may also be the same or different. In case #1, degrees of freedom of each PDSCH control or allocation may be fully ensured, but when each DCI is transmitted from a different TRP, the reception performance may be deteriorated due to a coverage difference for each DCI.

Case #2 1205 shows when N−1 different PDSCHs are transmitted from additional N−1 TRPs, TRP #1 to TRP #(N−1), in addition to a serving TRP, TRP #0, used in single PDSCH transmission, in which case DCIs for the PDSCHs of the additional N−1 TRPs are transmitted separately and each of the DCIs is dependent on the control information for the PDSCH transmitted from the serving TRP.

For example, DCI #0, control information for the PDSCH transmitted from the serving TRP, TRP #0, may include all information elements of DCI format 1_0, DCI format 1_1, and DCI format 1_2, but shortened DCI (hereinafter sDCI), sDCI #0 to sDCI #(N−2), control information for the PDSCHs transmitted from the cooperative TRPs, TRP #1 to TRP #(N−1), may include only some of the information elements of DCI format 1_0, DCI format 1_1, and DCI format 1_2. Accordingly, the sDCI carrying the control information for the PDSCHs transmitted from the cooperative TRPs has a small payload as compared to normal DCI (nDCI) carrying control information relating to the PDSCH transmitted from the serving TRP, and may thus include reserved bits as compared to the nDCI.

In case #2, the degree of freedom of each PDSCH control or allocation may be limited depending on content of the information element included in the sDCI, but a probability of having coverage difference for each DCI may be reduced because reception performance for the sDCI is better than that of the nDCI.

Case #3 1210 shows when N−1 different PDSCHs are transmitted from additional N−1 TRPs, TRP #1 to TRP #(N−1), in addition to a serving TRP, TRP #0, used in single PDSCH transmission, in which case a piece of DCI for the PDSCHs of the additional N−1 TRPs is transmitted and the DCI is dependent on the control information for the PDSCH transmitted from the serving TRP.

For example, DCI #0, control information for the PDSCH transmitted from the serving TRP, TRP #0, may include all information elements of DCI format 1_0, DCI format 1_1, and DCI format 1_2, and control information for the PDSCHs transmitted from the cooperative TRPs, TRP #1 to TRP #(N−1), may collect some of the information elements of DCI format 1_0, DCI format 1_1, and DCI format 1_2 into ‘secondary’ DCI (sDCI) for transmission. For example, the sDCI may include at least one piece of HARQ-related information such as frequency domain resource allocation, time domain resource allocation, an MCS or the like, for the cooperative TRPs. Information that is not included in the sDCI, such as a BWP indicator or a carrier indicator, may follow the DCI of the serving TRP, i.e., DCI #0, normal DCI, nDCI.

Case #3 1210 may have a limited degree of freedom of each PDSCH control or allocation depending on content of the information element included in sDCI, but may control sDCI reception performance and have reduced complexity of DCI blind decoding of the UE as compared to case #1 1200 or case #2 1205.

Case #4 1215 shows when N−1 different PDSCHs are transmitted from additional N−1 TRPs, TRP #1 to TRP #(N−1), in addition to a serving TRP, TRP #0, used for single PDSCH transmission, in which case control information for the PDSCHs transmitted from the additional N−1 TRPs is transmitted in the same DCI (long DCI) as the control information for the PDSCH transmitted from the serving TRP. That is, the UE may obtain the control information for the PDSCHs transmitted from the different TRPs, TRP #0 to TRP #(N−1) in single DCI. In case #4 1215, DCI blind decoding complexity of the UE may not increase, but a degree of freedom of PDSCH control or allocation may be reduced such as the number of cooperative TRPs being limited due to limitations on the long DCI payload.

In the following description and embodiments of the disclosure, sDCI may refer to various types of auxiliary DCIs such as shortened DCI, secondary DCI, or normal DCI (having the aforementioned DCI formats 1_0 to 1_1) carrying control information of a PDSCH transmitted from a cooperative TRP, the description of which may be similarly applied to the various types of auxiliary DCI unless otherwise specified.

Cases #1 1200, #2 1205, and #3 1210 in which one or more PDCCHs are used to support NC-JT may be classified as multiple-PDCCH-based NC-JT, and the case #4 1215 in which a PDCCH is used to support NC-JT may be classified as single-PDCCH-based NC-JT. In the multiple-PDCCH based PDSCH transmission, a CORESET scheduling the DCI of the serving TRP, TRP #0, may be distinguished from CORESETs scheduling the DCI of the cooperative TRPs, TRP #1 to TRP #(N−1). As a method of distinguishing between CORESETs, there may be a method of distinguishing between CORESETS by a higher layer indicator for each CORESET, a method of distinguishing between CORESETs through beam configuration for each CORESET, etc. In the single-PDCCH based NC-JT, single DCI schedules a single PDSCH having a plurality of layers instead of scheduling a plurality of PDSCHs, and the plurality of layers may be transmitted from multiple TRPs. In this case, a connection relation between a layer and a TRP to transmit the layer may be indicated by a TCI for the layer.

Herein, the term “cooperative TRP” may be replaced with various terms including a “cooperative panel” or a “cooperative beam” when actually used.

Herein, the expression that ‘NC-JT is applied’ is used herein for convenience of explanation, but it may be variously interpreted to fit the context, such as ‘the UE simultaneously receives one or more PDSCHs in one BWP’, ‘the UE simultaneously receives PDSCHs based on two or more TCI indication in one BWP’, ‘a PDSCH received by the UE is associated with one or more DMRS port group’, etc.

A radio protocol architecture for NC-JT, in light of FIG. 4 described above, may be variously used depending on TRP development scenarios. For example, when there is no or little backhaul latency between cooperative TRPs, a structure based on MAC layer multiplexing similar to what is shown in S10 (CA) of FIG. 4 may be used (CA-like method). On the other hand, when there is backhaul latency big enough not to be ignored between cooperative TRPs (e.g., when 2 ms or more time is required to exchange information such as CSI, scheduling, HARQ-ACK, etc., between the cooperative TRPs), as in S20 (DC) of FIG. 4, a separate structure for each TRP from the RLC layer may be used to secure robustness in the latency (DC-like method).

A UE that supports C-JT/NC-JT may receive C-JT and/or NC-JT related parameters or setting values from a higher layer configuration, and based on this, RRC parameters of the UE may be set. For higher layer configuration, the UE may use a UE capability parameter, e.g., tci-StatePDSCH. In this case, the UE capability parameter, e.g., tci-StatePDSCH, may define TCI states for PDSCH transmission; the number of TCI states may be set to 4, 8, 16, 32, 64, or 128 at FR1 and 64 or 128 at FR2; and among the set numbers, up to 8 states that may be indicated in 3 bits of a TCI field of DCI may be configured in an MAC-CE message. The maximum value 128 refers to a value indicated by maxNumberConfiguredTCIstatesPerCC in parameter tci-StatePDSCH included in capability signaling of the UE.

### Multi-DCI Based Multi-TRP

The multi-DCI based multi-TRP transmission method may include configuring a DL control channel for multi-PDCCH based NC-JT transmission.

The multi-PDCCH based NC-JT may have a CORESET or a SS distinguished for each TRP in DCI transmission for PDSCH scheduling of each TRP. The CORESET or SS for each TRP may be configured as at least one of the following:

Higher layer index configuration for each CORESET: CORESET configuration information configured by a higher layer may include an index value, and a TRP for transmitting the PDCCH in the configured CORESET may be distinguished by the index value for the configured CORESET. In other words, for a set of CORESETS having the same higher layer index value, it may be considered that the same TRP transmits the PDCCH or that the PDCCH scheduling the PDSCH of the same TRP is transmitted. The index for each CORESET may be called CORESETPoolIndex, and the PDCCH is transmitted from the same TRP for CORESETs configured to have the same CORESETPoolIndex value. For a CORESET for which no CORESETPoolIndex value is set, it may be regarded that a basic value of CORESETPoolIndex is set, and the default value may be ‘0’.

When each of a plurality of CORESETs included in higher layer signaling PDCCH-Config has more than one type of CORESETPoolIndex, i.e., when each CORESET has different CORESETPoolIndex, the UE may regard that the BS may use the multi-DCI based multi-TRP transmission method.

However, when each of a plurality of CORESETs included in higher layer signaling PDCCH-Config has one type of CORESETPoolIndex, i.e., when all the CORESETs have the same CORESETPoolIndex of ‘0’ or ‘1’, the UE may regard that the BS may use single TRP for transmission instead of using the multi-DCI based multi-TRP transmission method.

Multiple PDCCH-Config configuration: multiple PDCCH-Configs are configured in one BWP, and each PDCCH-Config may include PDCCH configuration for each TRP. Specifically, one PDCCH-Config may be configured with a list of CORESETs for each TRP and/or a list of SSs for each TRP, and one or more CORESETs and one or more SSs included in one PDCCH-Config may be regarded to correspond to a particular TRP.

CORESET beam/beam group configuration: with a beam or beam group configured for each CORESET, a TRP corresponding to the CORESET may be distinguished. For example, when the same TCI state is configured for multiple CORESETs, it may be considered that the CORESETs are transmitted through the same TRP or that a PDCCH scheduling a PDSCH of the same TRP is transmitted in the CORESET.

SS beam/beam group configuration: A beam or beam group is configured for each SS, making it possible to distinguish a TRP for each SS. For example, when a same beam/beam group or TCI state is configured for multiple SSs, it may be regarded that the same TRP transmits a PDCCH in the SS or a PDCCH scheduling a PDSCH of the same TRP is transmitted in the SS.

Distinguishing the CORESET or SS for each TRP enables classification of PDSCH and HARQ-ACK information for each TRP, which in turn enables generation of a separate HARQ-ACK codebook and use of a separate PUCCH resource for each TRP.

The above configuration may be independent for each cell or BWP. For example, two different CORESETPoolIndex values may be set in a PCell while no CORESETPoolIndex value may be set in a particular SCell. In this case, it may be regarded that NC-JT transmission is configured for the PCell while the NC-JT transmission is not configured for an SCell for which no CORESETPoolIndex value is set.

When the UE is configured by the BS to be able to use the multi-DCI based multi-TRP transmission method, i.e., there may be more than one type of CORESETPoolIndex for each of the plurality of CORESETs included in higher layer signaling PDCCH-Config or each CORESET has a different CORESETPoolIndex, the UE may interpret that, for PDSCHs scheduled from the PDCCH in the respective CORESETs having two different types of CORESETPoolIndex, there are limitations as follows:
1) When PDSCHs indicated from PDCCHs in the respective CORESETs having two different types of CORESETPoolIndex are fully or partially overlapped, the UE may apply TCI states indicated by the respective PDCCHs to different CDM groups. That is, two or more TCI states may not be applied to one CDM group.
2) When PDSCHs indicated from PDCCHs in the respective CORESETs having two different types of CORESETPoolIndex are fully or partially overlapped, the UE may expect that the number of actual front loaded DMRS symbols, the number of actually additional DMRS symbols, an actual position of the DMRS symbol, and a DMRS type are not different for each PDSCH.
3) The UE may expect that BWPs indicated from PDCCHs in respective CORESETs having two different types of CORESETPoolIndex are the same and subcarrier spacings (SCSs) are the same as well.
4) The UE may expect that information about PDSCHs scheduled from PDCCHs in the respective CORESETs having two different types of CORESETPoolIndex are completely included in the respective PDCCHs.

### Single-DCI Based Multi-TRP

The single-DCI based multi-TRP transmission method may include configuring a DL control channel for single-PDCCH based NC-JT transmission.

In the single-DCI based multi-TRP transmission method, PDSCHs transmitted by multiple TRPs may be scheduled in one DCI. In this case, to indicate the number of TRPs that transmit the PDSCHs, the number of TCI states may be used. When the number of TCI states indicated in DCI that schedules the PDSCH is two, it may be regarded as the single-PDCCH based NC-JT transmission, and when the number of TCI states is one, it may be regarded as the single-TRP transmission. TCI states indicated in the DCI may correspond to one or two of TCI states activated in an MAC-CE. When the TCI states of the DCI correspond to two TCI states activated in an MAC-CE, a TCI codepoint indicated in the DCI may have a relation of correspondence with the TCI states activated in the MAC-CE, and there may be two TCI states activated in the MAC-CE corresponding to the TCI codepoint.

Alternatively, when at least one of all codepoints of the TCI state field in the DCI indicates two TCI states, the UE may regard the transmission of the BS as being based on the single-DCI based multi-TRP method. In this case, at least one codepoint indicating two TCI states in the TCI state field may be activated through an enhanced PDSCH TCI state activation/deactivation MAC-CE.

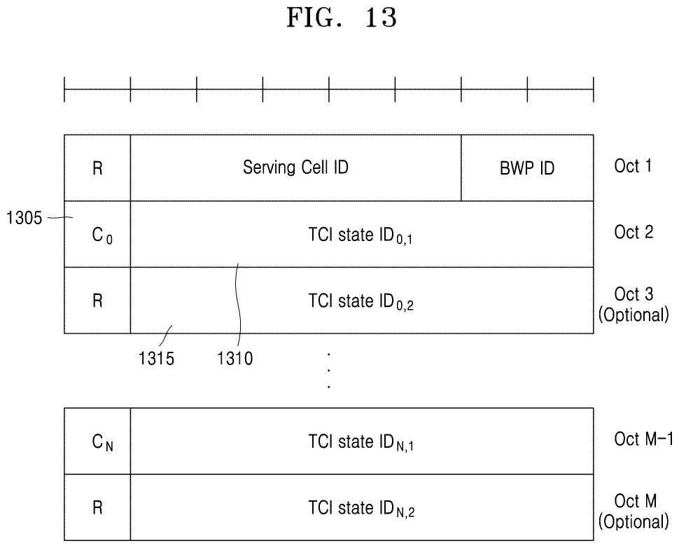

FIG. 13 illustrates an enhanced PDSCH TCI state activation/deactivation MAC-CE structure according to an embodiment. The meaning and configurable values of each field in the MAC-CE are shown in Table 31 below:

TABLE 31
Serving Cell ID: This field indicates the identity of the Serving Cell for which the
MAC CE applies. The length of the field is 5 bits. If the indicated Serving Cell is
configured as part of a simultaneousTCI-UpdateList1 or simultaneousTCI-
UpdateList2 as specified in TS 38.331 [5], this MAC CE applies to all the Serving
Cells configured in the set simultaneousTCI-UpdateList1 or simultaneous TCI-
UpdateList2, respectively;
BWP ID: This field indicates a DL BWP for which the MAC CE applies as the
codepoint of the DCI bandwidth part indicator field as specified in TS 38.212 [9]. The
length of the BWP ID field is 2 bits;
Cᵢ: This field indicates whether the octet containing TCI state ID_{i, 2} is present. If this
field is set to “1”, the octet containing TCI state ID_{i, 2} is present. If this field is set to
“0”, the octet containing TCI state ID_{i, 2} is not present;
TCI state ID_{i, j}: This field indicates the TCI state identified by TCI-StateId as
specified in TS 38.331 [5], where i is the index of the codepoint of the DCI
Transmission configuration indication field as specified in TS 38.212 [9] and TCI
state ID_{i, j} denotes the j-th TCI state indicated for the i-th codepoint in the DCI
Transmission Configuration Indication field. The TCI codepoint to which the TCI
States are mapped is determined by its ordinal position among all the TCI
codepoints with sets of TCI state ID_{i, j} fields, i.e. the first TCI codepoint with TCI state
ID_{0, 1} and TCI state ID_{0, 2} shall be mapped to the codepoint value 0, the second TCI
codepoint with TCI state ID_{1, 1} and TCI state ID_{1, 2} shall be mapped to the codepoint
value 1 and so on. The TCI state ID_{i, 2} is optional based on the indication of the Ci
field. The maximum number of activated TCI codepoint is 8 and the maximum
number of TCI states mapped to a TCI codepoint is 2.
R: Reserved bit, set to “0”.

Referring to FIG. 13, when field Co 1305 has a value of ‘1’, the corresponding MAC-CE may include field TCI state ID_{0,2} 1315 in addition to field TCI state ID_{0,1} 1310. This means that TCI state ID_{0,1} and TCI state ID_{0,2} are activated for the 0-th codepoint in the TCI state field included in DCI, and the UE may be receive an indication of two TCI states when the BS indicates the corresponding codepoint to the UE. When field C₀ 1305 has a value of ‘0’, the corresponding MAC-CE may not include the field TCI state ID_{0,2} 1315, which means that one TCI state corresponding to TCI state ID_{0,1} for the 0-th codepoint of the TCI state field included in the DCI is activated.

The above configuration may be independent for each cell or BWP. For example, there may be up to two activated TCI states corresponding to one TCI codepoint in the PCell while there may be up to one activated TCI state corresponding to one TCI codepoint in a particular SCell. In this case, it may be regarded that NC-JT transmission is configured for the PCell while the NC-JT transmission is not configured for the Scell.

### Distinguishing Single-DCI Based Multi-TRP PDSCH Repetitive Transmission Schemes (TDM/FDM/SDM)

UE may receive, from the BS, indication of different single-DCI based multi-TRP PDSCH repetitive transmission schemes (e.g., TDM, FDM, and SDM) according to a value indicated in the DCI field and a higher layer signaling configuration.

Table 32 below represents a method of distinguishing between single- or multi-TRP based schemes indicated to the UE according to the value of a particular DCI field and the higher layer signaling configuration.

TABLE 32

| | | | repetitionNumber | | Transmission |
|---|---|---|---|---|---|
| | Number | Number | configuration | Relation of | scheme |
| | of TCI | of CDM | and indication | repetitionScheme | indicated |
| combination | states | groups | condition | configuration | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP TDM |
| | | | | | scheme B |

The respective columns of Table 32 will be described as follows:
the number of TCI states (second column): indicates the number of TCI states indicated in the TCI state field in DCI, which may be one or two.
the number of CDM groups (third column): indicates the number of different CDM groups of DMRS ports indicated in an Antenna port field in the DCI. The number of CDM groups may be one, two, or three.
repetitionNumber configuration and indication conditions (fourth column): may have three conditions according to whether repetitionNumber for all time domain resource assignment (TDRA) entries that may be indicated in a time domain resource assignment field in the DCI is configured and whether a TDRA entry actually indicated has the repetitionNumber configuration.

Condition 1: at least one of all the TDRA entries that may be indicated in the time domain resource assignment field includes a configuration of repetitionNumber, and the TDRA entry indicated in the time domain resource assignment field in the DCI includes a configuration of repetitionNumber greater than 1

Condition 2: At least one of all the TDRA entries that may be indicated in the time domain resource assignment field includes a configuration of repetitionNumber, and the TDRA entry indicated in the time domain resource assignment field in the DCI does not include the configuration of repetitionNumber

Condition 3: All the TDRA entries that may be indicated in the time domain resource assignment field do not include a configuration of repetitionNumber

relations of a repetitionScheme configuration (fifth column): indicates whether to configure higher layer signaling repetitionScheme. The higher layer signaling repetitionScheme may be configured with one of ‘tdmSchemeA’, ‘fdmSchemeA’, and ‘fdmSchemeB’.

transmission scheme indicated to the UE (sixth column): indicates single or multiple TRP schemes indicated according to each combination (first column) represented in Table 32.

Single-TRP indicates single-TRP based PDSCH transmission. When the UE is configured with pdsch-AggegationFactor in the higher layer signaling PDSCH-config, the UE may receive scheduling of the single-TRP based PDSCH repetitive transmission as many as the number of times the UE is configured. Otherwise, the UE may receive scheduling of the single-TRP based PDSCH single transmission.

Single-TRP TDM scheme B indicates single-TRP based inter-slot time division based PDSCH transmission. According to Condition 1 related to repetitionNumber, the UE repetitively transmits a PDSCH in the time domain as many as the number of slots as many as repetitionNumber greater than 1 set for a TDRA entry indicated in the Time Domain Resource Assignment field. In this case, for each of the slots as many as repetitionNumber, a start symbol and the symbol length of the PDSCH indicated with the TDRA entry are equally applied, and the same TCI state is applied for each PDSCH repetitive transmission. This scheme is similar to a slot aggregation scheme in that inter-slot PDSCH repetitive transmission is performed in the time resource, but differs from the slot aggregation in that whether to indicate repetitive transmission may be dynamically determined based on the time domain resource assignment field in the DCI.

Multi-TRP SDM indicates a multi-TRP based spatial resource division PDSCH transmission scheme. It is a method of dividing a layer and receiving them from each TRP, which is not a repetitive transmission scheme but may increase reliability of PDSCH transmission in that transmission may be performed with a reduced coding rate by increasing the number of layers. The UE may receive the PDSCH by applying two TCI states indicated through the TCI state field in the DCI to the two CDM groups indicated from the BS, respectively.

Multi-TRP FDM scheme A indicates a multi-TRP based frequency resource division PDSCH transmission scheme, which is not repetitive transmission like multi-TRP SDM because it has one PDSCH transmission occasion, but may transmit with high reliability by increasing an amount of frequency resources and thus reducing the coding rate. Multi-TRP FDM scheme A may apply two TCI states indicated through the TCI state field in the DCI to non-overlapping frequency resources. When a PRB bundling size is determined to be wideband, the UE performs reception by applying the first TCI state to first ceil(N/2) RBs and the second TCI state to the remaining floor(N/2) RBs, where N is the number of RBs indicated in the frequency domain resource allocation field. Herein, ceil(.) and floor(.) are operators indicating rounding up and rounding down to the nearest tenth. When the PRB bundling size is determined to be 2 or 4, reception is performed by applying the first TCI state to PRGs at even places while applying the second TCI state to PRGs at odd places.

Multi-TRP FDM scheme B indicates a multi-TRP based frequency resource division PDSCH repetitive transmission scheme, which has two PDSCH transmission occasions and may repetitively transmit a PDSCH on each occasion. In the same manner as the multi-TRP FDM scheme A, the multi-TRP FDM scheme B may apply two TCI states indicated through the TCI state field in the DCI to non-overlapping frequency resources. When a PRB bundling size is determined to be wideband, the UE performs reception by applying the first TCI state to first ceil(N/2) RBs and the second TCI state to the remaining floor(N/2) RBs, where N is the number of RBs indicated in the frequency domain resource allocation field. Herein, ceil(.) and floor(.) are operators indicating rounding up and rounding down to the nearest tenth. When the PRB bundling size is determined to be 2 or 4, reception is performed by applying the first TCI state to PRGs at even places while applying the second TCI state to PRGs at odd places.

Multi-TRP TDM scheme A indicates a multi-TRP based time resource division intra-slot PDSCH repetitive transmission scheme. The UE has two PDSCH transmission occasions in one slot, and the first reception occasion may be determined based on a start symbol and symbol length of a PDSCH indicated through a time domain resource assignment field in DCI. A start symbol of the second reception occasion of the PDSCH may be a position after a symbol offset as long as higher layer signaling StartingSymbolOffsetK from the last symbol of the first transmission occasion, from which a transmission occasion may be determined to be as long as the symbol length indicated. When the higher layer signaling StartingSymbolOffsetK is not configured, the symbol offset may be assumed to be ‘0’.

Multi-TRP TDM scheme B indicates a multi-TRP based time resource division inter-slot PDSCH repetitive transmission scheme. The UE may have one PDSCH transmission occasion in one slot and may receive repetitive transmissions based on a start symbol and symbol length of the same PDSCH for as many slots as repetitionNumber indicated in the time domain resource assignment field in DCI. When repetitionNumber is two, the UE may receive the PDSCH repetitive transmissions in first and second slots by applying first and second TCI states, respectively. When repetitionNumber is greater than two, the UE may use different TCI state application schemes depending on the configuration of higher layer signaling tciMapping. When tciMapping is configured as cyclicMapping, the first and second TCI states are applied to the first and second PDSCH transmission occasions, respectively, and this TCI state application method is equally applied to the remaining PDSCH transmission occasions. When tciMapping is configured as sequenticalMapping, the first TCI state is applied to the first and second PDSCH transmission occasions and the second TCI state is applied to the third and fourth PDSCH transmission occasions, and this TCI state application method is equally applied to the remaining PDSCH transmission occasions.

The UE may determine whether to apply the cooperative communication in various manners, by e.g., having PDCCH(s) that allocate a PDSCH, to which the cooperative communication is applied, have e a particular format, having PDCCH(s) that allocate a PDSCH, to which the cooperative communication is applied, include a particular indicator to indicate whether the cooperative communication is applied, having PDCCH(s) that allocate a PDSCH, to which the cooperative communication is applied, scrambled by a particular RNTI, or assuming application of the cooperative communication in a particular section or frequency area indicated by a higher layer. For convenience of explanation, receiving the PDSCH to which the cooperative communication is applied based on similar conditions to those as described above will now be referred to as an NC-JT case.

Determining priorities among A and B may refer to selecting one of A and B that has a higher priority according to a preset priority rule and performing a corresponding operation or omitting or dropping an operation for the other one that has a lower priority.

For convenience of explanation, a cell, a transmission point, a panel, a beam or/and a transmission direction, which may be identified by a higher layer/L1 parameter such as a TCI state or spatial relation information, or an indicator such as a cell ID, TRP ID, panel ID, etc., will be referred to as a TRP, beam, or TCI state. Hence, in actual applications, the TRP, beam, or TCI state may be suitably replaced by one of the aforementioned terms.

In the disclosure, the UE may determine whether to apply the cooperative communication in various manners, by e.g., having PDCCH(s) that allocate a PDSCH, to which the cooperative communication is applied, have a particular format, having PDCCH(s) that allocate a PDSCH, to which the cooperative communication is applied, include a particular indicator to indicate whether the cooperative communication is applied, having PDCCH(s) that allocate a PDSCH, to which the cooperative communication is applied, scrambled by a particular RNTI (e.g., CRC of the DCI transmitted on the PDCCH is scrambled by a particular RNTI), or assuming application of the cooperative communication in a particular section indicated by a higher layer. For convenience of explanation, receiving the PDSCH to which the cooperative communication is applied based on similar conditions to those as described above will now be referred to as an NC-JT case.

Herein, higher layer signaling may correspond to at least one or one or more combinations of the following signaling:
MIB
SIB or SIB X (X=1, 2, . . . )
RRC
MAC CE

L1 signaling may correspond to at least one or one or more combinations of the following signaling methods using a physical layer channel or signaling:
PDCCH
DCI
UE-specific DCI
group-common DCI
common DCI
scheduling DCI (e.g., DCI used to schedule DL or UL data)
non-scheduling DCI (e.g., DCI used not for scheduling DL or UL data)
PUCCH
UL control information (UCI)

Determining priorities among A and B may refer to selecting one of A and B that has a higher priority according to a preset priority rule and performing a corresponding operation or omitting or dropping an operation for the other one that has a lower priority.

Hereinafter, the term slot refers to a particular time unit corresponding to a transmit time interval (TTI), and in particular, to a slot used in the 5G NR system, and a slot or subframe used in the 4G LTE system.

### First Embodiment: SRS Resource Configuration and Indication Method

The first embodiment may be combined with some or all configurations of all embodiments of the disclosure and then performed in the BS and the UE. The traditional SRS resource, as described above, supports up to four antenna ports (hereinafter, interchangeably used with ports), and all SRS resource transmission symbol positions determined based on higher layer signaling, the UE may perform SRS transmission through all the ports in each symbol. For example, when the UE is configured with a 4-port SRS resource having four transmission symbols through higher layer signaling from the BS, the UE may perform transmission through 4 ports in each symbol.

It is expected in the future NR advanced release, that enhanced standards may be supported with consideration for up to 8 antenna ports of the UE, and corresponding functions are being discussed in the relevant standard. In the future, it may be possible that more than eight antenna ports may be considered on the UE side. However, on occasion when the SRS is transmitted from all the ports configured for each symbol in which the SRS is transmitted, as currently supported, when the number of the ports increases, transmission power is reduced for each port in the SRS transmission, causing limited BS reception performance when coverage is insufficient as in the UE located on the cell boundary. Hence, the BS and the UE may consider various methods as follows for SRS transmission having N antenna ports, where N is larger than 4, on the UE side. Hereinafter, the SRS resource transmission may be understood as SRS transmission in an SRS resource. SRS antenna port transmission may be understood as SRS transmission having a nature of each antenna port.

### Method 1-1 (Single-SRS Resource Usage Method 1)

The UE may be configured with a single SRS resource from the BS to transmit the SRS having N antenna ports. The BS may configure the UE with a single SRS resource having N antenna ports, in which case, in SRS transmission in one or more symbols of the SRS resource through the N antenna ports, all the N antenna ports may be transmitted in each symbol. For example, when the UE transmits the SRS resource of N antenna ports with the number Nₛ of SRS symbols configured as four, the SRS resource may be transmitted through all the N antenna ports in each symbol.

As all the current standard supports for one, two and four antenna ports are based on a single SRS resource, method 1-1 may use definitions of various time and frequency resource allocation related parameters in Table 21 above, so method 1-1 may be a natural extension for an occasion when the number of antenna ports of the UE increases. However, in method 1-1, the UE transmits all antenna ports in one symbol, so the transmission power for each antenna port in one symbol may be reduced.

### Method 1-2 (Single-SRS Resource Usage Method 2)

The UE may be configured with a single SRS resource from the BS to transmit the SRS having N antenna ports. The BS may configure a single SRS resource having N antenna ports for the UE, and in SRS transmission in one or more symbols configured for the SRS resource, the number of antenna ports used in each symbol transmission may be less than or equal to N, and the number of symbols required to transmit the SRS resource through all the N antenna ports may be greater than or equal to 1.

In method 1-2, the SRS resource is transmitted through some of the N antenna ports in each symbol, so the transmission power of the antenna ports for each symbol may increase as compared to method 1-1 that performs transmission using all the N antenna ports for each symbol. However, transmission through the antenna ports in method 1-2 is different from a definition of the existing standard where the SRS is transmitted in each symbol through all the antenna ports configured for the particular SRS resource, so some of the definitions of various time and frequency resource allocation related parameters in Table 21 need to be modified or newly defined. For example, when method 1-2 is used, a parameter that may specify an SRS resource in which the SRS is transmitted may be signaled to the UE by configuring a value of at least one parameter defined in Table 21 or by newly defining a parameter. Alternatively, MAC-CE, L1 signaling, etc., may be used to specify some of the SRS resources configured according to Table 21.

### Method 1-3 (Multi-SRS Resource Usage)

The UE may be configured with a plurality of SRS resources from the BS to transmit an SRS having N antenna ports. The BS may configure M (where M>1) SRS resources having N or less antenna ports for the UE to support SRS transmission corresponding to N antenna ports from the UE, in which case, in the SRS transmission in one or more symbols of the SRS resource through N or less antenna ports configured for each SRS resource, two SRS resources may be transmitted in each symbol.

For example, when the UE is configured with two SRS resources each having four antenna ports for SRS transmission with eight antenna ports, and Nₛ for the two SRS resources is configured to be 4, the two SRS resources may all be transmitted through four antenna ports in each symbol. In this case, the plurality of SRS resources may be included in the same SRS resource set or each may be included in a different SRS resource set. The plurality of SRS resources configured for SRS transmission with N (N>4) antenna ports may be referred to as an SRS resource group. The number N of antenna ports that may be represented with the plurality of SRS resources may be more than 4, e.g., 6, 8, 12 or 16, which may be represented with SRS resources having one, two or four antenna ports. The UE may expect that SRS resources included in each SRS resource group that may be determined by the aforementioned rules or configured by the BS may all have the same number of antenna ports (e.g., four antenna ports per each SRS resource as in the above example). Furthermore, having a different number of antenna ports may not be excluded. For example, when three SRS resources are configured to represent N=8 antenna ports, the first and second SRS resources may have two antenna ports each, and the third SRS resource may have four antenna ports.

Unlike the method based on one SRS resource supported by the current standard, the method 1-3 enables transmission of a plurality of SRS resources through N antenna ports, so there may be various time and frequency allocation related parameters in Table 21 whose definitions need to be partially changed or which need to be newly defined. For example, a parameter may be defined to indicate antenna port information corresponding to each of the plurality of SRS resources. However, similar to method 1-2, the number of antenna ports used for transmission of each SRS resource in each symbol may be less than or equal to N, which is the number of the entire antenna ports, so the transmission power for each port may increase.

Method 1-4 (Selecting from Among Methods 1-1 to 1-3)

To transmit an SRS with N antenna ports, the UE may be semi-statically or dynamically instructed to use one of methods 1-1 to 1-3 from the BS. For example, the UE may use one of methods 1-1 to 1-3 by being configured by higher layer signaling from the BS, or by being dynamically indicated through L1 signaling. Alternatively, the UE may use one of the two methods, e.g., one of method 1-1 and method 1-2, one of method 1-1 and method 1-3 or method 1-2 and method 1-3, by being configured with the method through higher layer signaling from the BS, or by being dynamically indicated through L1 signaling. When the UE is located within a cell, and thus has enough coverage, the BS may configure SRS transmission with N antenna ports based on the method 1-1 for the UE through higher layer signaling or dynamically indicate the SRS transmission through L1 signaling. The L1 signaling based dynamic indication method may include, for example, indicating through a new field in a DCI format or indicating with a reserved codepoint in an existing DCI field, and for example, using an SRS request field.

The UE may report on whether a combination of at least one of methods 1-1 to 1-4 is supported to the BS in the UE capability. The UE capability may be differently reported for each frequency range (FR), or may be reported for each band, band combination, feature set, feature set per CC, or cell. The UE capabilities may be separate from each other, and multiple components in a single UE capability may define whether to support the respective methods.

When the UE supports a combination of at least one of methods 1-1 to 1-4, the higher layer signaling ‘usage’ of the SRS resource set may be ‘codebook’ and ‘antenna switching’. The ‘usage’ may also be ‘non-codebook’ and ‘beam management’.

According to method 1-3, when the UE is configured with a plurality of SRS resources in the same SRS resource set, the maximum number of SRS resources in the SRS resource set, which may be configured for the UE through higher layer signaling, may be four or more. When the UE is configured with a plurality of SRS resources in different SRS resource sets, the UE may be configured with two or more SRS resource sets, whose ‘usage’ is ‘codebook’, through higher layer signaling.

According to method 1-3, the UE uses the plurality of SRS resources for SRS transmission with N antenna ports, so definitions about codepoints in SRS resource indicators (SRIs) in the DCI formats 0_1 and 0_2 transmitted from the BS for scheduling codebook based PUSCH transmission may need to be changed. Each codepoint of the current SRI indicates a single SRS resource, but when the UE is configured by the BS to use method 1-3, definitions of codepoints of the SRI field may be changed according to the following methods:

### Method 1-3-1 (SRS Resource Group Indication)

The UE may assume that each codepoint of the SRI field in the DCI format 0_1 and 0_2 indicated from the BS indicates an SRS resource group that includes a plurality of SRS resources. For example, when there are two codepoints of the SRI, the first codepoint may indicate SRS resource group 0 and the second codepoint may indicate SRS resource group 1. In this case, the SRS resource group 0 may include SRS resources 0 and 1, and the SRS resource group 1 may include SRS resources 2 and 3. The UE may be configured with such SRS resource groups by higher layer signaling from the BS. Furthermore, when the UE is configured by the BS with the plurality of SRS resources in the same SRS resource set, the UE may determine a certain number of SRS resources from the lowest SRS resource index in the SRS resource set as one group.

A total number of antenna ports represented with the plurality of SRS resources may be set for each SRS resource set. For example, when the number of antenna ports is set to 8, the total number of SRS resources is set to 4 and indexes of the SRS resources are 0 to 3 for the SRS resource set, SRS resources with indexes 0 and 1 may belong to the first SRS resource group and SRS resources with indexes 2 and 3 may belong to the second SRS resource group. In this case, the first codepoint of the SRI field may correspond to the first SRS resource group, and the second codepoint may correspond to the second SRS resource group.

### Method 1-3-2 (Noncodebook, Indication of a Combination of a Plurality of SRS Resources)

The UE may assume that each codepoint of the SRI field in the DCI format 0_1 and 0_2 indicated from the BS indicates a single SRS resource or a combination of a plurality of SRS resources. This may be similar to the SRI field in the DCI formats 0_1 and 0_2 for scheduling noncodebook based PUSCH transmission. When there are four SRS resources configured in the SRS resource set whose ‘usage’ is set to ‘noncodebook’, a total of 2⁴−1=15 codepoints may be required to represent all the methods by which each codepoint of the SRI field in the DCI format 0_1 and 0_2 for scheduling noncodebook based PUSCH transmission selects one to four of the four SRS resources. Similar to the noncodebook scheme that considers all the methods of selecting subsets from all the configured SRS resources, method 1-3-2 may use a method of selecting all or part of the subsets.

For example, assuming that the number of all the configured SRS resources is M and that M SRS resources each have the same number of antenna ports, only a combination of a certain number of SRS resources among the M SRS resources may be considered. For example, only a method of selecting two of M may be considered. In this case, an SRI field may have as many codepoints as the number of methods of selecting two of M. Assuming that M SRS resources may each have a different number of antenna ports, occasions when the total number of antenna ports for each combination of SRS resources is identical may be created by considering combinations of as many SRS resources as a certain number or another certain number of M. The SRI field may have a codepoint that may indicate an occasion of each combination of SRS resources. For example, when, for an SRS resource set, four SRS resources having two antenna ports and two SRS resources having four antenna ports are configured, and a total of eight antenna ports are to be represented using a plurality of SRS resources, combinations of the two SRS resources having four antenna ports may be used, or combinations of one SRS resource having four antenna ports and two SRS resources having two antenna ports may be used.

### Method 1-3-3 (Indication of One SRS Resource and Automatic Indication of Other SRS Resources Connected to the Indicated SRS Resource)

The UE may assume that each codepoint of the SRI field in the DCI format 0_1 and 0_2 indicated from the BS indicates a single SRS resource, and the single SRS resource indicated by each codepoint may be connected to other multiple SRS resources. A sum of all the numbers of SRS ports configured for the other multiple SRS resources connected to the single SRS resource may be N. The connection may be configured through higher layer signaling. The BS and the UE do not change the definition of each codepoint of the SRI field, and the BS may indicate one SRS resource and simultaneously, a plurality of SRS resources connected thereto to the UE through high layer signaling.

The UE may report on whether a combination of at least one of methods 1-3-1 to 1-3-3 is supported to the BS in the UE capability. The UE capability may be differently reported depending on the frequency range, or may be reported for each band, band combination, feature set, feature set per CC, or cell. The UE capabilities may be separate from each other, and multiple components in a single UE capability may define whether to support the respective methods.

For method 1-3, when the UE receives higher layer signaling from the BS for a plurality of SRS resources to use the methods 1-3-1 to 1-3-3, the UE may distinguish, among various pieces of higher layer signaling configuration information in the SRS resources mentioned in Table 21 from the BS, pieces of high layer signaling configuration information that need to be configured to be identical for multiple SRS resources required to transmit an SRS having N antenna ports from information that may be the same or different between the SRS resources.

The UE may expect that among parameters in Table 21, parameters such as groupOrSequenceHopping and sequenceId, which are related to an SRS transmission sequence, and a parameter such as resourceType referring to periodic, quasi-static or non-periodic transmission of the SRS resource are configured equally for the plurality of SRS resources required for SRS transmission having N antenna ports.

The UE may expect that among parameters in Table 21, SRS time resource allocation related information resourceMapping, resourceMapping-r16 or resourceMapping-17 and SRS frequency resource allocation related information freqDomainPosition, freqDomainShift or freqHopping are configured equally or differently for the plurality of SRS resources required for SRS transmission having N antenna ports. The UE may also expect that transmissionComb or transmissionComb-n8-r17 that determines frequency and positions of SRS transmission REs has the same Comb value for a plurality of SRS resources, and that Comb offsets are configured equally or differently. The UE may also expect that a partial factor configured for RB level partial frequency sounding operation of the SRS has the same value for the plurality of SRS resources as well.

The UE may expect that pieces of information for determining SRS transmission beams such as spatialrelationinfo and srs-TCIState-r17 among the parameters in Table 21 are configured equally or differently for the plurality of SRS resources. When the plurality of SRS resources is configured in different SRS resource sets, the UE may expect that the two parameters related to determining a transmission beam are configured differently for the plurality of SRS resources.

### Second Embodiment: UL Codebook Related UE Capability Reporting Scheme Depending on SRS Transmission Scheme

The second embodiment may be considered in the BS and the UE in combination with all the embodiments of the disclosure.

As for method 1-1 and method 1-2, the UE that supports 8-port SRS resources may be configured with nrofSRS-Ports-n8 in higher layer signaling SRS-Resource from the BS. nrofSRS-Ports-n8 may be set to one value of “ports8” or “ports8tdm”.

When the UE is configured with nrofSRS-Ports-n8 as “ports8”, the UE is configured with 8 antenna ports. The UE may transmit all the N antenna ports in each symbol as in method 1-1, where N=8. The UE may determine SRS transmission power, equally divide the SRS transmission power by the number of antenna ports for each symbol, i.e., 8, and determine transmission power for each antenna port in each symbol. The SRS transmitted in this manner may be referred to as an 8-port SRS of non-TDM scheme.

When the UE is configured with nrofSRS-Ports-n8 as “ports8tdm”, the number of antenna ports transmitted for each symbol may be less than N when the UE transmits N antenna ports as in method 1-2. ports8tdm indicates that the UE is configured with 8 antenna ports which are partitioned into 2 subsets with each subset having 4 antenna ports. When N is 8, the UE may transmit SRSs corresponding to eight antenna ports in two successive symbols: an SRS corresponding to four antenna ports may be transmitted in the first symbol, where the four antenna ports may be 1000, 1001, 1004 and 1005, and an SRS corresponding to four antenna ports may be transmitted in the second symbol, where the four antenna ports may be 1002, 1003, 1007 and 1008. The UE may determine SRS transmission power, equally divide the SRS transmission power by the number of antenna ports for each symbol, i.e., 4 and determine transmission power for each antenna port in each symbol. The SRS transmitted in this manner may be referred to as an 8-port SRS of TDM scheme.

The UE may be configured by the BS for the 8-port SRS resource to be included in an SRS resource set whose higher layer signaling ‘usage’ is set to codebook or antenna switching.

The UE may report, to the BS, a UE capability indicating that codebook-based PUSCH transmission is possible with eight transmission antennas.

The UE capability may be referred to as feature group (FG) 40-7-1.

FG 40-7-1 may include one of natural numbers 1 to 8 as the maximum number of PUSCH MIMO layers that may be supported by the UE, which may be reported to the BS from the UE.

FG 40-7-1 may include information about a maximum number of 8-port SRS resources that may be included in an SRS resource set for codebook use to have a value of one or two, which may be reported to the BS from the UE.

FG 40-7-1 may include information about whether to support only the non-TDM scheme or both non-TDM and TDM schemes for 8-port SRS resources that may be included in an SRS resource set for codebook use, which may be reported to the BS from the UE. When the UE supports only the non-TDM scheme, the UE may report, to the BS, “noTDM” value in FG 40-7-1, and when the UE supports both the non-TDM and TDM schemes, the UE may report, to the BS, a value of “TDM and noTDM” in FG 40-7-1.

The UE may report FG 40-7-1 to the BS for each feature set per component carrier (FSPC). The FSPC may refer to a unit of information per component carrier (CC) in a band in a certain band combination.

The UE may report, to the BS, a UE capability indicating a type of a codebook to be used in codebook-based PUSCH transmission using eight transmission antennas. In this case, the codebook type may be determined according to coherency between UE antennas, and there may be a total of four types. When the UE reports FG 40-7-1, the UE may need to report at least one of UE capabilities (FG 40-7-1a, FG 40-7-1b, FG 40-7-1c, or FG 40-7-1d) corresponding to the following four types of codebooks, respectively.

The UE may use eight transmission antennas through FG 40-7-1a to report the BS of a fact that it is possible to support a full-coherent codebook that means all the eight antennas have coherency in codebook-based PUSCH transmission. In this case, the codebook may be referred to as codebook1 (i.e., the UE reporting FG 40-7-1a to the BS may mean that the UE supports codebook1). The UE may add a combination of N1 and N2 values that may be supported by the UE to FG 40-7-1a and report it to the BS, and there may be three candidate values (N1, N2)=(4,1), (2,2) or (4,1) and (2,2) allowed to be reported.

The UE may use eight transmission antennas through FG 40-7-1b to report the BS of a fact that it is possible to support a partial-coherent codebook meaning that four of the eight antennas are coherent in codebook-based PUSCH transmission. The UE may support the codebook based on four PUSCH or SRS antenna ports 1000, 1001, 1004 and 1005 being coherent and four antenna ports 1002, 1003, 1006 and 1007 are coherent. In this case, the codebook may be referred to as codebook2 (i.e., the UE reporting FG 40-7-1b to the BS may mean that the UE supports codebook2).

The UE may use eight transmission antennas through FG 40-7-1c to report the BS that it is possible to support a partial-coherent codebook indicating that two of the eight antennas have coherency in codebook-based PUSCH transmission. The UE may support the codebook based on two PUSCH or SRS antenna ports 1000 and 1004 being coherent, antenna ports 1001 and 1005 being coherent, antenna ports 1002 and 1006 being coherent and antenna ports 1003 and 1007 being coherent. In this case, the codebook may be referred to as codebook3 (i.e., the UE reporting FG 40-7-1c to the BS may mean that the UE supports codebook3).

The UE may use eight transmission antennas through FG 40-7-1d to report the BS that it is possible to support a non-coherent codebook that indicates all of the eight antennas are not coherent in codebook-based PUSCH transmission. In this case, the codebook may be referred to as codebook4 (i.e., the UE reporting FG 40-7-1d to the BS may indicate that the UE supports codebook4).

The UE may report FG 40-7-1a, FG 40-7-1b, FG 40-7-1c and FG 40-7-1d to the BS for each FSPC. The FSPC may refer to a unit of information per component carrier (CC) in a band in a certain band combination.

The UE may report at least one UE capability among FG 40-7-1a, FG 40-7-1b, FG 40-7-1c and FG 40-7-1d to the BS, and the BS may select one codebook type from the received at least one UE capability and configure a parameter codebookType-UL in higher layer signaling PUSCH-config. The parameter may be configured for the UE as one of codebook1-r18, codebook2-r18, codebook3-r18 and codebook4-r18, and when the UE is configured with the parameter as codebook1-r18, the UE may be configured with one of ng1n4n1 or ng1n2n2, and ng1n4n1 and ng1n2n2 may correspond to (4,1) and (2,2), respectively, of combinations of N1 and N2 allowed to be reported in the UE capability FG 40-7-1a.

When certain SRS transmission overlaps another UL channel and signal transmission in the time domain, the UE may not transmit but drop the certain UL transmission for each symbol according to the priority. In this case, when overlapping occurs between SRS transmission and another UL channel and signal transmission or DL channel and signal reception, the UE may follow priority rules as follows:

When the non-periodic SRS and the periodic/semi-persistent SRS overlap in the same symbol position, the non-periodic SRS is transmitted while the periodic/semi-persistent SRS is not transmitted.

For an SRS and a PUCCH scheduled on the same carrier, when the UE is configured with semi-persistent SRS and periodic SRS transmission in the same symbol position as a position of PUCCH transmission including only a CSI report, only an L1-RSRP report or only an L1-SINR report, the UE may not transmit the SRS.

When the UE is configured with semi-persistent SRS or periodic SRS transmission in the same symbol position as a position of PUCCH transmission including an HARQ-ACK link restoration request and/or SR, or when the UE receives an indication of non-periodic SRS trigger, the UE may not transmit the SRS.

When the SRS transmission and the PUCCH transmission of the UE overlap each other, only SRS symbols that overlap the PUCCH among the entire SRS transmission symbols may be dropped and not be transmitted.

When the UE is triggered to transmit the non-periodic SRS in the same symbol as the position of PUCCH transmission including only a semi-persistent/periodic CSI report, only a semi-persistent/periodic L1-RSRP report or only an L1-SINR report, the UE may not transmit the PUCCH.

As for a band or a band combination in which simultaneous transmission of the SRS and the PUCCH/PUSCH is not allowed for intra-band CA or inter-band CA, the UE does not expect that PUSCH/UL DM-RS/UL PT-RS/PUCCH formats are not configured on a different carrier from a carrier on which the SRS is configured in the same symbol.

As for a band or a band combination in which simultaneous transmission of the SRS and the PRACH is not allowed for intra-band CA or inter-band CA, the SRS on one carrier and the PRACH on another carrier are not simultaneously transmitted.

When the UE receives trigger for non-periodic SRS transmission and a position of the triggered non-periodic SRS transmission overlaps an OFDM symbol position set for periodic and semi-persistent SRS transmission, the UE may transmit the non-periodic SRS in the overlapping symbol position, drop periodic and semi-persistent SRS transmission that overlaps the non-periodic SRS, and transmit the non-overlapping periodic and semi-persistent SRS.

When the UE receives activation for semi-persistent SRS transmission and a position of the activated semi-persistent SRS transmission overlaps an OFDM symbol position set for periodic SRS transmission, the UE may transmit the semi-persistent SRS in the overlapping symbol position, drop periodic SRS transmission that overlaps the semi-persistent SRS, and transmit the non-overlapping periodic SRS.

When the UE transmits a plurality of SRS resources in an SRS resource set with the higher layer signaling ‘usage’ set to ‘antennaSwitching’ in SRS-ResourceSet, the UE may define Y OFDM symbols between two SRS resources as a guard period, and whether the guard period is dropped or not dropped may follow the same priority rule as for the SRS resources before and after the guard period.

In overlapping, the operation of stopping and dropping certain UL transmission for each symbol according to priority may be equally applied to the 8-port SRS resource transmission regardless of the TDM and non-TDM schemes. Accordingly, when the UE transmits the 8-port SRS in the TDM scheme, transmitting SRS antenna ports 1000, 1001, 1004 and 1005 in the first symbol and transmitting SRS antenna ports 1002, 1003, 1006 and 1007 in the second symbol, when the first symbol overlaps another UL transmission and is thus, dropped, but the other UL transmission does not overlap the SRS transmission in the second symbol, the UE may not perform but drop the SRS transmission in the first symbol but may perform the SRS transmission in the second symbol as is. Hence, in 8-port SRS transmission in the TDM scheme, the UE may expect that some or all of the eight antenna ports are not transmitted because of overlapping of certain symbol position. In such a case where some antenna ports are not transmitted, when the UE reports the FG 40-7-1a and the BS configures the corresponding higher layer signaling for the UE, and the UE may use a codebook with the eight antennas being full-coherent, i.e., codebook1, but when some symbols are dropped for an SRS transmitted in the TDM scheme so that only some of the eight antenna ports are transmitted in some remaining symbols, the BS may fail to estimate a channel in SRS based channel estimation by considering coherency of the entire eight antennas because only some of the antenna ports have been transmitted, and accordingly, there may be a problem selecting a codebook. Furthermore, when the UE supports CA, when UL transmission of the UE overlaps in the time domain with consideration for multiple carriers, and power of the overlapped UL transmission exceeds a certain reference value, the UE may perform power scaling for the overlapped UL transmission according to the priority, and this may also be performed for each symbol. In other words, when the UE transmits the 8-port SRS in the TDM scheme, there is no overlap with other UL transmission in the first symbol and there is an overlap with other UL transmission in the second symbol with consideration for the multiple carriers. Hence, in performing power scaling, transmission power for each antenna port in the first symbol may be different from transmission power for each antenna port in the second symbol. Hence, although the UE has coherency between all the eight antenna ports, transmission power between antenna ports may be different when there is an overlap between UL transmissions in a certain symbol with consideration for multiple carriers and there is no overlap in the remaining symbols, and this may invalidate the coherency between the antennas.

Considering the certain overlapping situations in the time domain, the UE may drop transmission of certain antenna ports or perform power scaling depending on the overlapping situation for the 8-port SRS transmitted in the time division multiplexing (TDM) scheme, so the 8-port SRS transmitted in the TDM scheme may need to consider antenna coherency equal to or lower than those of an 8-port SRS transmitted in the non-TDM scheme. For this, using at least one combined method of the following methods, the UE may send the BS information relating to a supportable codebook to be applied to a UL channel estimated based on an 8-port SRS transmitted in the TDM scheme and a supportable codebook to be applied to a UL channel estimated based on an 8-port SRS transmitted in the non-TDM scheme.

### Method 2-1

The UE may report a combination of at least one of the FG 40-7-1a, FG 40-7-1b, FG 40-7-1c, or FG 40-7-1d as a codebook type to be applied to the UL channel estimated through the 8-port SRS for codebook usage transmitted in the TDM or non-TDM scheme, and commonly apply it to either the TDM or non-TDM scheme. For example, when the UE reported that it supports both TDM and non-TDM based SRSs through the FG 40-7-1, the BS set the nrofSRS-Ports-n8 to “ports8tdm” for the first SRS resource (i.e., TDM based SRS transmission) and set the nrofSRS-Ports-n8 to “ports8” for the second SRS resource (i.e., non-TDM based SRS transmission), the UE reported FG 40-7-1a as (N1,N2)=(4,1) and the BS set codebookType-UL in the corresponding higher layer signaling PUSCH-config to codebook1-r18, and the corresponding parameter value is ng1n4n1, the UE may expect that the codebook1-r18 is applied to both the first SRS resource transmitted in the TDM scheme and the second SRS resource transmitted in the non-TDM scheme. Furthermore, when the UE reported from a stage of reporting the UE capability that the UE supports both the TDM and non-TDM based SRSs through the FG 40-7-1, the UE may expect that a codebook type that has been reported is commonly applied to both TDM and non-TDM when reporting the combination of at least one of the FG 40-7-1a, FG 40-7-1b, FG 40-7-1c, or FG 40-7-1d. Hence, when the UE sends a report of whether TDM and/or non-TDM based SRS transmission is supported and a supportable codebook type in the aforementioned manner, the UE may report a codebook type attributed to antenna coherency lower than actual antenna coherency supported by the UE when reporting a codebook type that may be supported with consideration for a situation where antenna coherency deteriorates for the TDM scheme. In other words, when the UE supports method 2-1, the UE may perform UE capability reporting that is more deteriorated than the actual UE capability when reporting a codebook type that is supported.

### Method 2-2

When the UE reports a UE capability that supports the 8-port SRS with codebook usage by adding information indicating that it supports only the non-TDM scheme to the report, the UE may report a combination of at least one of the FG 40-7-1a, FG 40-7-1b, FG 40-7-1c, or FG 40-7-1d as a supportable codebook type corresponding to the 8-port SRS transmitted in the non-TDM scheme, the BS may configure the UE with one of at least one codebook type that has been reported from the UE through the higher layer signaling codebookType-UL, and the codebook may be applied to a channel estimated through the non-TDM transmission scheme based SRS.

When the UE reports a UE capability that supports the 8-port SRS with codebook usage by adding information indicating that it supports both the TDM and non-TDM schemes, the UE may report a combination of at least one of the FG 40-7-1a, FG 40-7-1b, FG 40-7-1c, or FG 40-7-1d as a supportable codebook type corresponding to the 8-port SRS transmitted in the non-TDM scheme, and the UE may further report a combination of at least one of UE capabilities having the same structure as the FG 40-7-1a, FG 40-7-1b, FG 40-7-1c, or FG 40-7-1d as a supportable codebook type corresponding to the 8-port SRS transmitted in the TDM scheme. The UE may consider each of FG 40-7-1a-1, FG 40-7-1b-1, FG 40-7-1c-1, and FG 40-7-1d-1 for the UE capabilities having the same structure as FG 40-7-1a, FG 40-7-1b, FG 40-7-1c, and FG 40-7-1d. For example, the UE may report FG 40-7-1a as a supportable codebook type corresponding to an SRS transmitted in the non-TDM scheme (i.e., full-coherent codebook, codebook1) and may report FG 40-7-1b-1 as a supportable codebook type corresponding to an SRS transmitted in the TDM scheme (i.e., partial-coherent codebook, codebook 2). The UE capabilities FG 40-7-1a-1, FG 40-7-1b-1, FG 40-7-1c-1, and FG 40-7-1d-1 corresponding to the FG 40-7-1a, FG 40-7-1b, FG 40-7-1c, and FG 40-7-1d, respectively, may be reported by the UE only when the UE reports the UE capability that supports the 8-port SRS for codebook use by adding information indicating that it supports both the TDM and non-TDM schemes to the report.

The UE capabilities FG 40-7-1a-1, FG 40-7-1b-1, FG 40-7-1c-1, and FG 40-7-1d-1 corresponding to the FG 40-7-1a, FG 40-7-1b, FG 40-7-1c, and FG 40-7-1d, respectively, may be reported by being defined as individual UE capabilities as described above or by being defined as one UE capability that may include information indicating that at least one of four codebooks is supported. For example, the one UE capability that may be defined may be FG 40-7-1e, and in the UE capability, the information indicating that at least one of codebook1, codebook2, codebook3 and/or codebook4 is supported may be represented in a 4-bit bitmap. When the UE reports information indicating that codebook1 is supported to the BS through a new UE capability (e.g., FG 40-7-1e), the UE adds one of three pieces of information indicating that ng1n4n1, ng1n2n2, or ng1n4n1 and ng1n2n2 are supported to the UE capability.

### Method 2-3

When the UE reports a UE capability that supports the 8-port SRS for codebook use by adding information indicating that it supports both the TDM and non-TDM schemes to the report, the UE may report a combination of at least one of the FG 40-7-1a, FG 40-7-1b, FG 40-7-1c, or FG 40-7-1d as a supportable codebook type corresponding to the 8-port SRS transmitted in the non-TDM scheme, and the UE may report additional information indicating whether each UE capability is applied only to the non-TDM, or applied to both the TDM and non-TDM in each of the FG 40-7-1a, FG 40-7-1b, FG 40-7-1c, and FG 40-7-1d. When the UE reports the UE capability that supports the 8-port SRS for codebook use by adding information indicating that it supports both the TDM and non-TDM schemes to the report, the UE may report, for example, FG40-7-1a and FG40-7-1b, in which case information indicating that it is applied only to non-TDM may be included in FG 40-7-1a and information indicating that it is applied to both TDM and non-TDM may be included in FG 40-7-1b. Additional information indicating whether the UE capability is applied to both TDM and non-TDM in the respective FG 40-7-1a, FG 40-7-1b, FG 40-7-1c, and FG 40-7-1d may be reported by the UE only when the UE reports the UE capability that supports the 8-port SRS for codebook use by adding information indicating that it supports both the TDM and non-TDM schemes to the report. Alternatively, regarding a case that the UE reports the UE capability that supports the 8-port SRS for codebook use by adding information indicating that only the non-TDM scheme is supported to the report, the UE may report the capability with the exclusion of the additional information about whether the UE capability is applied only to the non-TDM scheme or applied to both TDM and non-TDM in each of FG 40-7-1a, FG 40-7-1b, FG 40-7-1c, and FG 40-7-1d, or report the capability with information indicating that it is applied only to the non-TDM scheme.

### Method 2-4

When the UE reports a UE capability that supports the 8-port SRS for codebook use by adding information indicating that it supports both the TDM and non-TDM schemes to the report, the UE may report a combination of at least one of the FG 40-7-1a, FG 40-7-1b, FG 40-7-1c, or FG 40-7-1d as a supportable codebook type corresponding to the 8-port SRS transmitted in the non-TDM scheme, and the UE may define an additional UE capability (e.g., FG 40-7-1f) and report a supportable codebook type corresponding to the SRS transmitted in the TDM scheme in the additional UE capability. The FG 40-7-1f that may be newly defined may be used to report the supportable codebook type corresponding to the SRS transmitted in the TDM scheme, and may support a codebook attributed to an antenna coherency equal to or lower than an antenna coherency supported by a combination of at least one codebook corresponding to the 8-port SRS transmitted in the non-TDM scheme reported by the UE.

For example, when the UE reports information for supporting both the TDM and non-TDM schemes to the BS through the FG 40-7-1 and reports the FG 40-7-1a, the UE may consider codebook1 as a supportable codebook type corresponding to the 8-port SRS transmitted in the non-TDM scheme, report at least one of codebooks codebook1, codebook2, codebook3 and codebook4 that may have antenna coherency equal to or lower than a codebook supported by the FG 40-7-1a through the newly definable FG 40-7-1f, and a combination of the reported one or more codebook types may be the supportable codebook corresponding to the 8-port SRS transmitted in the TDM scheme. As such, in the case that the newly definable FG 40-7-1f is supportable to report codebook1, the UE may send the report to the BS by adding one of three pieces of information indicating that parameters required in supporting codebook 1, ng1n4n1, ng1n2n2, or both the ng1n4n1 and the ng1n2n2 are supported to the report.

Alternatively, when the UE reports information for supporting both the TDM and non-TDM schemes to the BS through the FG 40-7-1 and reports the FG 40-7-1b, the UE may consider codebook2 as a supportable codebook type corresponding to the 8-port SRS transmitted in the non-TDM scheme, report at least one of codebooks codebook2, codebook3, and codebook4 that may have antenna coherency equal to or lower than a codebook supported by the FG 40-7-1b through the newly definable FG 40-7-1f, and a combination of the reported one or more codebook types may be the supportable codebook corresponding to the 8-port SRS transmitted in the TDM scheme.

Alternatively, when the UE reports information that supports both the TDM and non-TDM schemes to the BS through FG 40-7-1 and reports FG 40-7-1a and FG 40-7-1c, the UE may consider codebook1 and codebook3 as a supportable codebook type corresponding to the 8-port SRS transmitted in the non-TDM scheme, add, to the report, at least one of codebooks codebook1, codebook2, codebook3 or codebook4 that may have antenna coherency equal to or lower than codebook 1 having a high antenna coherency of the FG 40-7-1a and FG 40-7-1c through the newly definable FG 40-7-1f, or add, to the report, at least one of codebooks codebook3 and codebook4 that may have antenna coherency equal to or lower than codebook3 having low antenna coherency of the FG 40-7-1a and FG 40-7-1c, and a combination of the reported one or more codebook types may be a supportable codebook corresponding to the 8-port SRS transmitted in the TDM scheme.

When the UE reports that only the 8-port SRS transmission in the non-TDM scheme is available to the BS through the FG 40-7-1, the UE may not report the newly definable FG 40-7-1f to the BS.

### Method 2-5

The UE may transmit four SRS ports in one symbol for a TDM based 8-port SRS. A difference between when the UE transmits the 8-port SRS through TDM and when the UE transmits the 8-port SRS through non-TDM may occur when one of two symbols that each transmit four SRS ports in the TDM based SRS transmission, does not perform the transmission as it overlaps another UL channel or signal, or when transmission power is adjusted for one of the two symbols with consideration for carrier combination as the symbol overlaps with a UL channel or signal on another carrier. As such, the occasion when some of the eight ports are not transmitted or transmission power of some ports is adjusted does not occur for the non-TDM transmission scheme.

Specifically, when among two symbols in each of which the UE may transmit four SRS ports in the TDM based SRS transmission, four SRS ports in one symbol are not transmitted or transmission power is adjusted, the UE may report on whether antenna coherency is satisfied or not satisfied between four SRS ports that are not transmitted or transmitted with adjusted transmission power in the symbol and another four SRS ports transmitted (rather than not being transmitted, or without adjustment of the transmission power) in the other symbol of the two symbols in the UE capability.

In this case, as a method of indicating whether the antenna coherency is satisfied or not satisfied, the UE may define an additional component in the FG 40-7-1a and report non-TDM as an SRS transmission scheme to support the codebook 1 or report that both TDM and non-TDM are supported through the component. In this case, that the UE supports the codebook1 may mean that the UE is allowed for UL transmission by using a full-coherent 8TX codebook. Hence, FG 40-7-1a may be a UE capability for Codebook-based 8Tx PUSCH—codebook1. The UE may represent that codebook1 is supported in 8TX PUSCH transmission through the first component of the FG 40-7-1a, report a combination of N1 and N2 that may be supported by the UE through the second component (e.g., report one of three cases that (N1,N2) supports (4,1), (2, 2) and both (4,1) and (2,2)), and report one of two SRS transmission schemes ‘non-TDM’ or ‘both TDM and non-TDM’ that may support the codebook1 to the BS through the third component.

In another method, the UE may define an individual UE capability similar to the FG 40-7-1a, for example, FG 40-7-1a-1. The UE may report the FG 40-7-1a to indicate to the BS that the codebook1 is supported when the UE transmits the 8-port SRS in the non-TDM scheme. The UE may report the FG 40-7-1a-1 to indicate to the BS that the codebook1 is supported when the UE transmits the 8-port SRS in the TDM scheme. Similar to FG 40-7-1a, the UE may report a combination of N1 and N2 that may be supported by the UE through the FG 40-7-1a-1 (e.g., report one of three cases that (N1,N2) supports (4,1), (2,2) and both (4,1) and (2,2)). Hence, FG 40-7-1a-1 may be a UE capability for Codebook-based 8Tx PUSCH—codebook1. The UE may represent that codebook1 is supported in 8TX PUSCH transmission through the first component of the FG 40-7-1a when the TDM scheme is supported in transmission of the 8-port SRS, and report a combination of N1 and N2 that may be supported by the UE through the second component (e.g., report one of three cases that (N1,N2) supports (4,1), (2, 2) and both (4,1) and (2,2)). Alternatively, the FG 40-7-1a-1 may be a UE capability for Codebook-based 8Tx PUSCH—codebook1, and when the UE may represent that codebook1 is supported in 8TX PUSCH transmission through the first component when both the TDM and non-TDM schemes are supported in transmission of the 8-port SRS, and report a combination of N1 and N2 that may be supported by the UE through the second component (e.g., report one of three cases that (N1,N2) supports (4,1), (2, 2) and both (4,1) and (2,2)).

With this, the UE may report to the BS on whether antenna coherency is secured or not secured when the eight SRS ports are all transmitted in TDM or non-TDM. Whether the antenna coherency is secured may be required only for full-coherent transmission. It is because an occasion when the UE does not perform transmission with less than four of the eight SRS ports or the transmission power for the less than four antenna ports is adjusted does not exist and thus, the UE may not need to separately report that it supports codebook2, codebook3 and codebook4 for the TDM or non-TDM transmission scheme for the 8-port SRS. The information about whether to support only the non-TDM scheme or both non-TDM and TDM schemes for 8-port SRS resources included in an SRS resource set for codebook use indicated by FG 40-7-1 may be applied to codebook2, codebook3 and codebook4. Specifically, when the UE reports to the BS that the UE may support a combination of at least one of codebook2, codebook3 or codebook4, this indicates that the UE may support a combination of the reported 8TX codebooks regardless of the TDM or non-TDM transmission method for the 8-port SRS.

The UE may be notified of a combination of at least one of methods 2-1 to 2-4 from the BS through a combination of at least one of higher layer signaling, MAC-CE signaling or L1 signaling, or may expect that the combination of the at least one of methods 2-1 to 2-4 is fixedly defined in a standard. Additionally, when the UE is notified of a combination of one or more certain methods from the BS through the combination of at least one of higher layer signaling, MAC-CE signaling or L1 signaling, this indicates that the UE is unable to support the other combinations of methods. For example, the UE may expect that method 2-2 is fixedly defined in a standard for a method and procedure for reporting CSI, which is started from the UE. Alternatively, the UE may be notified of method 2-4 from the BS through a combination of at least one of higher layer signaling, MAC-CE signaling or L1 signaling, in which case it may be regarded that the UE is notified from the BS that method 2-1 is not supported.

The UE may report on whether a combination of at least one of methods 2-1 to 2-4 is supported to the BS in a UE capability. In this case, when the UE reports to the BS that the UE may support a particular combination of one or more methods in the UE capability, it may be regarded that the UE also reports that the UE is unable to support the other combinations. For example, the UE may report to the BS on whether the UE is able to support method 2-1 or method 2-2. Alternatively, the UE may report to the BS that the UE is able to support method 2-3, and this UE capability report may mean that the UE is unable to support method 2-1.

The UE may be notified of a combination of at least one of methods 2-1 to 2-5 from the BS through a combination of at least one of higher layer signaling, MAC-CE signaling or L1 signaling, or may expect that the combination of the at least one of methods 2-1 to 2-5 is fixedly defined in a standard. Additionally, when the UE is notified of a combination of one or more certain methods from the BS through the combination of at least one of higher layer signaling, MAC-CE signaling or L1 signaling, this indicates that the UE is unable to support the other combinations of methods. For example, the UE may expect that method 2-5 is fixedly defined in the standard for a method of separately reporting a codebook that is applicable in 8TX PUSCH transmission for TDM or non-TDM which is an 8-port SRS transmission scheme. Alternatively, the UE may be notified of method 2-5 from the BS through a combination of at least one of higher layer signaling, MAC-CE signaling or L1 signaling, in which case it may be regarded that the UE has been notified from the BS that method 2-1 is not supported. Alternatively, when the UE is notified that method 2-5 is not supported through a combination of at least one of higher layer signaling, MAC-CE signaling or L1 signaling, the UE may regard itself as being notified that method 2-1 is supported.

The UE may report on whether a combination of at least one of methods 2-1 to 2-5 is supported to the BS in the UE capability. In this case, when the UE reports to the BS that the UE is able to support a particular combination of one or more methods in the UE capability, it may be regarded that the UE also reports that the UE is unable to support the other combinations. For example, the UE may report to the BS on whether the method 2-5 is supported. Alternatively, the UE may report to the BS that the UE is able to support method 2-5, and this UE capability report may indicate that the UE is unable to support method 2-1.

The UE capability report may be sent to the BS according to a report unit, which is one of per FSPC, per FS, per band, per cell or per UE.

The UE capability report may be additionally sent to the BS only by the UE that has reported the FG 40-7-1.

### Third Embodiment: Higher Layer Signaling Configuration Scheme Depending on the SRS Transmission Scheme

Described is a higher layer signaling configuration scheme depending on the SRS transmission scheme of the UE. The embodiment may be considered in the BS and the UE in combination with all the embodiments of the disclosure.

The UE may be configured with an indication of whether TDM based transmission or non-TDM based transmission is performed for each 8-port SRS resource through higher layer signaling nrofSRS-Ports-n8. When the UE is configured by the BS with “ports8tdm” for higher layer signaling nrofSRS-Ports-n8 for a certain SRS resource, the UE may recognize that the SRS resource is an 8-port SRS resource transmitted based on TDM. When the UE is configured by the BS with “ports8” for higher layer signaling nrofSRS-Ports-n8 for a certain SRS resource, the UE may recognize that the SRS resource is an 8-port SRS resource transmitted based on non-TDM.

The UE may be configured with up to two 8-port SRS resources in an SRS resource set for codebook use. As described above, as for an SRS transmitted in the TDM or non-TDM scheme, when an antenna port to be transmitted in a certain symbol is dropped or the power scaling is applied due to overlap with a TDM schemed SRS, antenna coherency may be reduced as compared to the non-TDM scheme, so codebooks supported by the UE to correspond to the TDM and non-TDM schemed 8-port SRSs may be different. In this regard, for a method of reporting UE capability for a separately supportable codebook combination corresponding to the TDM and non-TDM schemed 8-port SRSs, the UE and the BS may support a combination of at least one of methods 2-1 to 2-4. Upon receiving the UE capability, the BS may recognize that different codebooks may be applied to channels estimated based on the TDM and non-TDM based 8-port SRSs. For the UE that has reported the UE capability, the BS may configure higher layer signaling by considering a combination of at least one of the following methods:

### Method 3-1

The UE may expect to be configured by the BS with “ports8tdm” or “ports8” for all the values of higher layer signaling nrofSRS-Ports-n8 for all SRS resources in the SRS resource set with higher layer signaling ‘usage’ set to ‘codebook’ (the condition of the higher layer signaling may be similarly applied to all SRS resources in the SRS resource set with higher layer signaling ‘usage’ set to ‘antenna switching’). Specifically, the UE may not expect that some of the SRS resources for use of multiple codebooks are transmitted in the TDM scheme and some of the remaining SRS resources are transmitted in the non-TDM scheme, but may expect that the SRS resource for codebook use is transmitted by using only one of the TDM or non-TDM scheme. Hence, the UE may be configured with one codebookTypeUL-r18 in higher layer signaling PUSCH-config from the BS. The parameter may be configured for the UE as one of codebook1-r18, codebook2-r18, codebook3-r18 and codebook4-r18. When the UE is configured with the parameter as codebook1-r18, the UE may be configured with one of ng1n4n1 or ng1n2n2, and ng1n4n1 and ng1n2n2 may correspond to (4,1) and (2,2), respectively, of combinations of N1 and N2 allowed to be reported in the UE capability FG 40-7-1a.

For example, it may be assumed that the UE has reported that both TDM and non-TDM are available through the FG 40-7-1, reported codebook1 as a supportable codebook type corresponding to non-TDM based SRS transmission through a UE capability, additionally reported that (4,10) of combinations of N1 and N2 is supportable, and reported codebook2 as a supportable codebook type corresponding to TDM based SRS transmission through a UE capability.

In this case, when the UE is configured by the BS with “ports8” for all the values of higher layer signaling nrofSRS-Ports-n8 for all 8-port SRS resources (i.e., when non-TDM based SRSs are to be transmitted), the UE may be configured with codebookTypeUL-r18 in higher layer signaling PUSCH-config as codebook1 and further configured with ng1n4n1. In this case, the UE may transmit an 8-port SRS resource for codebook in the non-TDM scheme, and on receiving this, the BS estimates an UL channel and may select TPMI based on the corresponding codebook1 and add an indication of the TPMI to DCI that includes codebook based PUSCH transmission scheduling information to the UE.

Alternatively, when the UE is configured by the BS with “ports8tdm” for all the values of higher layer signaling nrofSRS-Ports-n8 for all 8-port SRS resources (i.e., when non-TDM based SRSs are to be transmitted), the UE may be configured with codebookTypeUL-r18 in higher layer signaling PUSCH-config as codebook2. In this case, the UE may transmit the 8-port SRS resource for codebook in the non-TDM scheme. When receiving this resource, the BS estimates a UL channel and may select a TPMI based on the corresponding codebook2 and add an indication of the TPMI to the DCI that includes codebook based PUSCH transmission scheduling information to the UE.

### Method 3-2

The UE may expect to be configured by the BS with one of “ports8tdm” or “ports8” as a value of higher layer signaling nrofSRS-Ports-n8 for the SRS resource for use of an arbitrary codebook. Specifically, the UE may receive higher layer signaling from the BS to transmit some of a plurality of SRS resources for use of multiple codebooks in the TDM scheme while transmitting some of the rest in the non-TDM scheme, and may consider that 8-port SRS resources for use of all codebooks are not limited to using only one of TDM or non-TDM (such a higher layer signaling condition may be similarly applied even to all SRS resources in the SRS resource set with higher layer signaling ‘usage’ set to ‘antenna switching’).

When the UE is configured with one SRS resource set for codebook use (i.e., when codebook based PUSCH transmission corresponding to a single TRP is configured), the UE may expect that the SRS resource set includes up to two SRS resources. When two SRS resources are included, one of TDM or non-TDM may be set for all the two SRS resources, and each SRS resource may be configured to have a different transmission method (e.g., the first SRS resource may be transmitted in non-TDM and the second SRS resource may be transmitted in the TDM scheme). When each SRS resource is configured to have a different transmission method as described above (e.g., the first SRS resource may be transmitted in non-TDM and the second SRS resource may be transmitted in TDM), the UE may be configured with two higher layer signaling that refers to codebook types to be used in PUSCH transmission for codebook use transmitted through eight antenna ports in higher layer singling PUSCH-config from the BS, and each may be a codebook corresponding to an SRS transmitted on a TDM or non-TDM basis (for example, higher layer signaling codebookType-UL may be a codebook corresponding to an SRS transmitted on a non-TDM basis, and higher layer signaling codebookType-UL2 may be a codebook corresponding to an SRS transmitted on TDM basis). When the UE considers different two types of codebooks for PUSCH transmission for use of codebook transmitted through eight antenna ports as described above, the UE may expect that the size of a TPMI field indicated through DCI is defined to correspond to a larger value of the numbers of bits required by the different two codebooks. The UE may receive an indication of a certain SRS resource through an SRS resource indicator (SRI) field in DCI that includes PUSCH scheduling information. Depending on which transmission scheme is used for the SRS resource, the UE may differently interpret the TPMI field based on the codebook corresponding to the SRS resource. The aforementioned names of the higher layer signaling parameters are merely an example and the disclosure is not limited thereto.

When the UE is configured with two SRS resource sets for codebook use (i.e., when codebook based PUSCH transmission corresponding to multiple TRPs is configured), the UE may expect that all the SRS resources in a certain SRS resource set are set to only one scheme of TDM or non-TDM.

For example, the UE may expect that two SRS resources in the first SRS resource set are set to the TDM scheme and two SRS resources in the second SRS resource set are set to the non-TDM scheme. In this case, the UE may be configured with two higher layer signaling that refers to codebook types to be used in PUSCH transmission for use of codebook transmitted through eight antenna ports in higher layer signaling PUSCH-config, and each of the two may be a codebook corresponding to an SRS transmitted based on TDM or non-TDM (e.g., higher layer signaling codebookType-UL may be a codebook corresponding to the SRS transmitted on a non-TDM basis (i.e., all SRS resources in the second SRS resource set), and higher layer signaling codebookType-UL2 may be a codebook corresponding to the SRS transmitted on a TDM basis (i.e., all SRS resources in the first SRS resource set)). In this case, the UE may expect that there are two TPMI fields in DCI with consideration for multiple TRP PUSCH transmission, expect that the first TPMI field has a bit length to indicate a codebook corresponding to one scheme of TDM or non-TDM set for all the SRS resources in the first SRS resource set, and expect that the second TPMI field has the same rank information indicated through the first TPMI field (i.e., on the assumption that the second TPMI field has the same value as a rank value of a TPMI indicated in the first TPMI field) and has a bit length to indicate a codebook corresponding to one scheme of TDM or non-TDM set to all the SRS resources in the second SRS resource set.

Alternatively, the UE may expect that all SRS resources in the first SRS resource set and second SRS resource set are set to one scheme of TDM or non-TDM. In this case, the UE may be configured with one higher layer signaling (e.g., higher layer signaling codebookType-UL) that refers to a codebook type to be used in PUSCH transmission for codebook use transmitted through eight antenna ports in higher layer signaling PUSCH-config, and the parameter may all be applied to the two SRS resource sets.

Alternatively, the UE may assume that there is no limitation in setting a TDM or non-TDM scheme for one or more SRS resources included in the first SRS resource set and second SRS resource set. For example, the UE may be configured to transmit some of the SRS resources in the first or second SRS resource set in the TDM scheme, and some of the rest in the non-TDM scheme.

Hence, when the UE is configured to transmit some of all SRS resources in the first and second SRS resource sets in the TDM scheme and transmit some of the remaining SRS resources in the non-TDM scheme, two higher layer signaling that refers to codebook types to be used in PUSCH transmission for codebook use transmitted through eight antenna ports may be configured for the UE. In this case, the UE may expect that there are two TPMI fields in DCI in consideration for multiple TRP PUSCH transmission, expect that, when all of the one or more SRS resources in the first SRS resource set are set to one method of TDM or non-TDM, the first TPMI field has a bit length to indicate a codebook corresponding to the method, and expect that, when some of the one or more SRS resources are configured to be transmitted in the TDM scheme and some of the remaining SRS resources are configured to be transmitted in the non-TDM scheme, the first TPMI field has a bit length to correspond to a larger bit length to indicate the respective codebooks corresponding to TDM and non-TDM schemes. The UE may expect that, when all of the one or more SRS resources in the second SRS resource set are set to one method of TDM or non-TDM while the second TPMI field has the same rank information indicated through the first TPMI field (i.e., on the assumption that the second TPMI field has the same value as a rank value of a TPMI indicated in the first TPMI field), the second TPMI field has a bit length to indicate a codebook corresponding to the method, and expect that, when some of the one or more SRS resources are configured to be transmitted in the TDM scheme and some of the remaining SRS resources are configured to be transmitted in the non-TDM scheme, the second TPMI field has a bit length to correspond to a larger one of bit lengths to indicate the respective codebooks corresponding to TDM and non-TDM schemes.

When the UE is configured to transmit all SRS resources in the first and second SRS resource sets in the TDM scheme or in the non-TDM scheme, the UE may be configured with one higher layer signaling that refers to a codebook type to be used in PUSCH transmission for codebook use transmitted through eight antenna ports, and the higher layer signaling may be applied to all the SRS resources in the first and second SRS resource sets.

The aforementioned names of the higher layer signaling parameters are merely an example and may not be limited thereto.

The UE may receive an indication of a certain SRS resource through an SRS resource indicator (SRI) field in DCI that includes PUSCH scheduling information, and depending on which transmission scheme of TDM or non-TDM is used for the SRS resource, the UE may differently interpret the TPMI field based on the codebook corresponding to the SRS resource.

The UE may be notified of a combination of at least one of methods 3-1 and 3-2 from the BS through a combination of at least one of higher layer signaling, MAC-CE signaling or L1 signaling, or may expect that the combination of the at least one of methods 3-1 and 3-2 is fixedly defined in a standard. Additionally, when the UE is notified of the combination of at least one of methods 2-1 to 2-4 from the BS through the combination of at least one of higher layer signaling, MAC-CE signaling or L1 signaling, this indicates that the UE is unable to support the other combinations of methods. For example, the UE may expect that method 3-1 is fixedly defined in the relevant standard for a method and procedure for reporting CSI, which is started from the UE. Alternatively, the UE may be notified of method 3-2 from the BS through a combination of at least one of higher layer signaling, MAC-CE signaling or L1 signaling, in which case it may be regarded that the UE has been notified from the BS that method 3-1 is not supported.

The UE may report on whether a combination of at least one of methods 3-1 and 3-2 is supported to the BS in the UE capability. In this case, when the UE reports to the BS that the UE may support a particular combination of one or more methods in the UE capability, it may be regarded that the UE also reports that the UE is unable to support the other combinations. For example, the UE may report to the BS on whether the UE is able to support method 3-1 or 3-2. Alternatively, the UE may report to the BS that the UE is able to support method 3-1, and this UE capability report may mean that the UE is unable to support method 3-2.

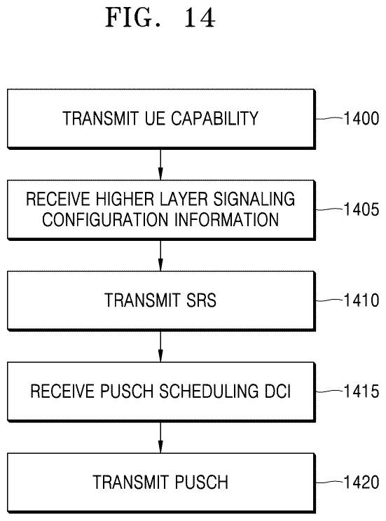

FIG. 14 illustrates operations of a UE in a wireless communication system, according to an embodiment.

Referring to FIG. 14, In step 1400, the UE may transmit a UE capability to the BS. In this case, UE capability signaling that may be reported may be of an 8-port SRS resource transmission scheme (TDM or non-TDM), whether 8-port codebook based PUSCH transmission is available, a UE capability about a supportable codebook type in 8-port codebook based PUSCH transmission, or a UE capability that may be reported in performing a combination of at least one of methods 1-1 to 1-4, methods 1-3-1 and 1-3-3, methods 2-1 to 2-4, or methods 3-1 and 3-2. Step 1400 may be skipped as well. The UE may transmit the UE capability to the BS at the request of the BS.

In step 1405, the UE may receive configuration information through higher layer signaling from the BS in response to the reported UE capability. In this case, the UE may receive an 8-port SRS resource transmission scheme, a codebook type to be used in 8-port codebook based PUSCH transmission, or configuration information required to perform a combination of at least one of methods 1-1 to 1-4, 1-3-1 and 1-3-3, 2-1 to 2-4, or 3-1 and 3-2 from the BS through higher layer signaling. The UE may receive configuration information required to perform a combination of at least one of methods 1-1 to 1-4, 1-3-1 and 1-3-3, 2-1 to 2-4, or 3-1 and 3-2 from the BS through a combination of higher layer signaling and L1 signaling.

In step 1410, the UE may transmit an SRS to the BS. The SRS may be one transmitted in a TDM or non-TDM scheme according to the UE capability report and the corresponding higher layer signaling based configuration information.

In step 1415, the UE may receive DCI that includes codebook based PUSCH scheduling information from the BS. The BS may estimate a UL channel based on the SRS transmitted by the UE, figure out and indicate a corresponding optimal TPMI to the UE through DCI. A bit length of the TPMI may be determined according to the codebook type configured for the UE.

In step 1420, the UE may transmit a codebook based PUSCH to the BS based on the received scheduling information.

The above flowchart illustrates an example method that can be implemented in accordance with the principles of the disclosure and various changes could be made to method illustrated in the flowchart herein. For example, while shown as a series of operations, various operations in each figure could overlap, occur in parallel, occur in a different order, or occur multiple times. Alternatively, an operation may be omitted or replaced by another operation.

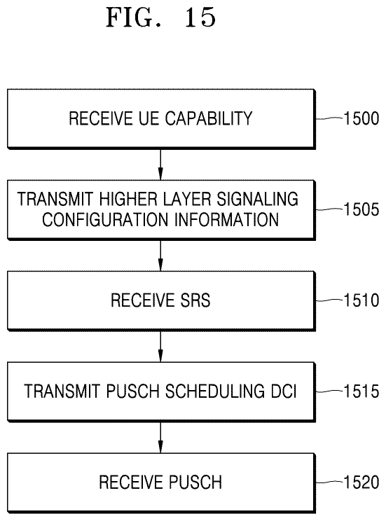

FIG. 15 illustrates operations of a BS in a wireless communication system, according to an embodiment.

Referring to FIG. 15, in step 1500, the BS may receive a UE capability from the UE. In this case, UE capability signaling that may be reported may be of an 8-port SRS resource transmission scheme (TDM or non-TDM), whether 8-port codebook based PUSCH transmission is available, a UE capability about a supportable codebook type in 8-port codebook based PUSCH transmission, or a UE capability that may be reported in performing a combination of at least one of methods 1-1 to 1-4, 1-3-1 and 1-3-3, 2-1 to 2-4, or 3-1 and 3-2. Operation 15-00 may be skipped as well. The UE may transmit the UE capability to the BS at the request of the BS.

In step 1505, the BS may transmit higher layer signaling to the UE according to the UE capability reported by the UE. In this case, the BS may configure the UE with an 8-port SRS resource transmission scheme, a codebook type to be used in 8-port codebook based PUSCH transmission, or configuration information required to perform a combination of at least one of methods 1-1 to 1-4, 1-3-1 and 1-3-3, 2-1 to 2-4, or 3-1 and 3-2 through higher layer signaling. The BS may transmit, to the UE, configuration information required to perform a combination of at least one of methods 1-1 to 1-4, -3-1 and 1-3-3, 2-1 to 2-4, or 3-1 and 3-2 through a combination of higher layer signaling and L1 signaling.

In step 1510, the BS may receive an SRS from the UE. The SRS may be one transmitted in a TDM or non-TDM scheme according to the UE capability report and the corresponding higher layer signaling.

In step 1515, the BS may transmit DCI that includes codebook based PUSCH scheduling information to the UE. The BS may estimate a UL channel based on the SRS transmitted by the UE, figure out and indicate a corresponding optimal TPMI to the UE through DCI. A bit length of the TPMI may be determined according to the codebook type configured for the UE.

In step 1520, the BS may expect for the UE to transmit a codebook based PUSCH based on scheduling information received by the UE.

The above flowchart illustrates an example method that can be implemented in accordance with the principles of the disclosure and various changes could be made to method illustrated in the flowchart herein. For example, while shown as a series of operations, various operations in each figure could overlap, occur in parallel, occur in a different order, or occur multiple times. Alternatively, an operation may be omitted or replaced by another operation.

### UE/BS

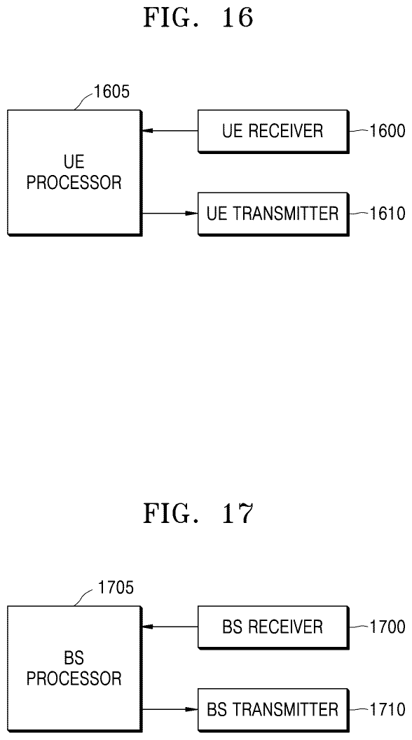

FIG. 16 is a block diagram of a UE in a wireless communication system, according to an embodiment.

Referring to FIG. 16, the UE may include a transceiver including a UE receiver 1600 and a UE transmitter 1610, a memory, and a UE processor 1605 (or referred to as a UE controller or a processor). The transceiver 1600 and 1610, the memory and the UE processor 1605 of the UE may operate according to the aforementioned communication method of the UE. Components of the UE are not, however, limited thereto. For example, the UE may include more or fewer elements than described above. In addition, the transceiver, the memory and the UE processor may be incorporated in a single chip.

The transceiver may transmit or receive signals to or from a BS. The signals may include control information and data. For this, the transceiver may include an RF transmitter for up-converting the frequency of a signal to be transmitted and amplifying the signal and an RF receiver for low-noise amplifying a received signal and down-converting the frequency of the received signal. It is, however, merely an example of the transceiver, and the elements of the transceiver are not limited to the RF transmitter and RF receiver.

In addition, the transceiver may receive a signal on a wireless channel and output the signal to the processor, or transmit a signal output from the processor on a wireless channel.

The memory may store a program and data required for operation of the UE. The memory may store control information or data included in a signal transmitted or received by the UE. The memory may include a storage medium such as a read only memory (ROM), a random access memory (RAM), a hard disk, a compact disk (CD) ROM (CD-ROM), and a digital versatile disk (DVD), or a combination of storage mediums. Moreover, the memory may be in the plural.

The processor may control a series of processes for the UE to be operated according to the embodiments of the disclosure. For example, the processor may control the components of the UE so that the UE receives DCI including two layers to receive multiple PDSCHs at the same time. The processor may be in the plural and may perform operations to control components of the UE by executing the program stored in the memory.

FIG. 17 is a block diagram of a UE in a wireless communication system, according to an embodiment.

Referring to FIG. 17, the BS may include a transceiver including a BS receiver 1700 and a BS transmitter 1710, a memory, and a BS processor 1705 (or referred to as a BS controller or a processor). The transceiver 1700 and 1710, the memory and the BS processor 1705 of the BS may operate according to the aforementioned communication method of the BS. Components of the BS are not, however, limited thereto. For example, the BS may include more or fewer components than described above. In addition, the transceiver, the memory and the processor may be incorporated in a single chip.

The transceiver may transmit or receive signals to or from a UE. The signals may include control information and data. For this, the transceiver may include an RF transmitter for up-converting the frequency of a signal to be transmitted and amplifying the signal and an RF receiver for low-noise amplifying a received signal and down-converting the frequency of the received signal. It is, however, merely an example of the transceiver, and the elements of the transceiver are not limited to the RF transmitter and RF receiver.

In addition, the transceiver may receive a signal on a wireless channel and output the signal to the processor, or transmit a signal output from the processor on a wireless channel.

The memory may store a program and data required for operation of the BS. The memory may store control information or data included in a signal transmitted or received by the BS. The memory may include a storage medium such as a read only memory (ROM), a random access memory (RAM), a hard disk, a compact disk (CD) ROM (CD-ROM), and a digital versatile disk (DVD), or a combination of storage mediums. Moreover, the memory may be in the plural.

The processor may control a series of processes for the BS to be operated according to the embodiments of the disclosure. For example, the processor may control the components of the BS to configure and transmit pieces of DCI of two layers, which include allocation information for multiple PDSCHs. The processor may be in the plural and may perform operations to control components of the BS by executing the program stored in the memory.

Methods in embodiments of the disclosure described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a RAM, a non-volatile memory including a flash memory, a ROM, an EEPROM, a magnetic disc storage device, a CD-ROM, a DVD or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

Each block and combination of the blocks of a flowchart may be performed by computer program instructions which may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the “module” is not limited to software or hardware. The “module” may be configured to be stored in an addressable storage medium, or to execute one or more processors. For example, the “modules” may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and “modules” may be combined into a small number of components and “modules”, or further divided into a larger number of components and “modules”. Moreover, the components and the “modules” may be implemented to execute one or more central processing units (CPUs) in a device or security multimedia card. In embodiments, the “module” may include one or more processors.

Although the embodiments of the disclosure are provided with respect to an FDD LTE system, modifications of the embodiments of the disclosure based on the technical idea of the above embodiments of the disclosure may also be employed by other systems such as a TDD LTE system, a 5G or NR system, etc.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a wireless communication system, the method comprising:
transmitting, to a base station (BS), capability information regarding a codebook-based 8Tx physical uplink shared channel (PUSCH);
receiving, from the BS, sounding reference signal (SRS) configuration information including information of an SRS resource set;
in case that a usage of the SRS resource set is identified as a codebook, based on the information of the SRS resource set, identifying that a value of nrofSRS-Ports-n8 is applied to all of a plurality of SRS resources in the SRS resource set; and
transmitting at least one SRS based on the value of nrofSRS-Ports-n8,
wherein the value of nrofSRS-Ports-n8 is set as:
ports8 indicating that the UE is configured with 8 antenna ports, or
ports8tdm indicating that the UE is configured with 8 antenna ports which are partitioned into 2 subsets with each subset having 4 antenna ports.

2. The method of claim 1, wherein in case that the UE supports codebook1, the capability information includes:
a first component indicating a combination of N1 and N2 supported at the UE, and
a second component indicating no time division multiplexing (TDM) or both of TDM or no TDM, and
wherein N1 is a number of antenna ports in first dimension and N2 is a number of antenna ports in second dimension.

3. The method of claim 2, wherein the combination of N1 and N2 is at least one of (4, 1), (2, 2) or both of (4, 1) and (2, 2).

4. The method of claim 1, wherein the capability information includes a value of SRS-8TxPorts and the value indicating no time division multiplexing (TDM) or both of TDM or no TDM is applied, in case that the UE supports at least one of codebook2, codebook3 or codebook4.

5. A method performed by a base station (BS) in a wireless communication system, the method comprising:
receiving, from a user equipment (UE), capability information regarding a codebook-based 8Tx physical uplink shared channel (PUSCH);
transmitting, to the UE, sounding reference signal (SRS) configuration information including information of an SRS resource set, wherein in case that a usage in the information of the SRS resource set is set as a codebook, a value of nrofSRS-Ports-n8 is applied to all of a plurality of SRS resources in the SRS resource set; and
receiving, from the UE, at least one SRS based on the value of nrofSRS-Ports-n8,
wherein the value of nrofSRS-Ports-n8 is set as:
ports8 indicating that the UE is configured with 8 antenna ports, or
ports8tdm indicating that the UE is configured with 8 antenna ports which are partitioned into 2 subsets with each subset having 4 antenna ports.

6. The method of claim 5, wherein in case that the UE supports codebook1, the capability information includes:
a first component indicating a combination of N1 and N2 supported at the UE, and
a second component indicating no time division multiplexing (TDM) or both of TDM or no TDM, and
wherein N1 is a number of antenna ports in first dimension and N2 is a number of antenna ports in second dimension.

7. The method of claim 6, wherein the combination of N1 and N2 is at least one of (4, 1), (2, 2) or both of (4, 1) and (2, 2).

8. The method of claim 5, wherein the capability information includes a value of SRS-8TxPorts and the value indicating no time division multiplexing (TDM) or both of TDM or no TDM is applied, in case that the UE supports at least one of codebook2, codebook3 or codebook4.

9. A user equipment (UE) in a wireless communication system, the UE comprising:
a transceiver; and
at least one processor coupled with the transceiver and configured to:
transmit, to a base station (BS), capability information regarding a codebook-based 8Tx physical uplink shared channel (PUSCH),
receive, from the BS, sounding reference signal (SRS) configuration information including information of an SRS resource set,
in case that a usage of the SRS resource set is identified as a codebook, based on the information of the SRS resource set, identify that a value of nrofSRS-Ports-n8 is applied to all of a plurality of SRS resources in the SRS resource set, and
transmit at least one SRS based on the value of nrofSRS-Ports-n8, wherein the value of nrofSRS-Ports-n8 is set as:
ports8 indicating that the UE is configured with 8 antenna ports or
ports8tdm indicating that the UE is configured with 8 antenna ports which are partitioned into 2 subsets with each subset having 4 antenna ports.

10. The UE of claim 9, wherein in case that the UE supports codebook1, the capability information includes:
a first component indicating a combination of N1 and N2 supported at the UE, and
a second component indicating no time division multiplexing (TDM) or both of TDM or no TDM, and
wherein N1 is a number of antenna ports in first dimension and N2 is a number of antenna ports in second dimension.

11. The UE of claim 10, wherein the combination of N1 and N2 is at least one of (4, 1), (2, 2) or both of (4, 1) and (2, 2).

12. The UE of claim 9, wherein the capability information includes a value of SRS-8TxPorts and the value indicating no time division multiplexing (TDM) or both of TDM or no TDM is applied, in case that the UE supports at least one of codebook2, codebook3 or codebook4.

13. A base station (BS) in a wireless communication system, the BS comprising:
a transceiver; and
at least one processor coupled with the transceiver and configured to:
receive, from a user equipment (UE), capability information regarding a codebook-based 8Tx physical uplink shared channel (PUSCH),
transmit, to the UE, sounding reference signal (SRS) configuration information including information of an SRS resource set, wherein in case that a usage in the information of the SRS resource set is set as a codebook, a value of nrofSRS-Ports-n8 is applied to all of a plurality of SRS resources in the SRS resource set, and
receive, from the UE, at least one SRS based on the value of nrofSRS-Ports-n8,
wherein the value of nrofSRS-Ports-n8 is set as:
ports8 indicating that the UE is configured with 8 antenna ports or
ports8tdm indicating that the UE is configured with 8 antenna ports which are partitioned into 2 subsets with each subset having 4 antenna ports.

14. The BS of claim 13, wherein in case that the UE supports codebook1, the capability information includes:
a first component indicating a combination of N1 and N2 supported at the UE, and
a second component indicating no time division multiplexing (TDM) or both of TDM or no TDM, and
wherein N1 is a number of antenna ports in first dimension and N2 is a number of antenna ports in second dimension.

15. The BS of claim 14, wherein the combination of N1 and N2 is at least one of (4, 1), (2, 2) or both of (4, 1) and (2, 2).

16. The BS of claim 13, wherein the capability information includes a value of SRS-8TxPorts and the value indicating no time division multiplexing (TDM) or both of TDM or no TDM is applied, in case that the UE supports at least one of codebook2, codebook3 or codebook4.
